(19) United States
(12) Patent Application Publication
(10) Pub. No.: US 2006/0222675 A1
(43) Pub. Date: Oct. 5, 2006

(54) Personal care compositions with color changing indicator

(76) Inventors: Ram W. Sabnis, Eagan, MN (US); Timothy D. Kehoe, St. Paul, MN (US); Robert James Balchunis, St. Paul, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/391,725

(22) Filed: Mar. 28, 2006

Related U.S. Application Data
(60) Provisional application No. 60/696,872, filed on Jul. 6, 2005.
(60) Provisional application No. 60/711,183, filed on Aug. 25, 2005.
(60) Provisional application No. 60/734,338, filed on Nov. 7, 2005.
(60) Provisional application No. 60/734,230, filed on Nov. 7, 2005.
(60) Provisional application No. 60/734,144, filed on Nov. 7, 2005.
(60) Provisional application No. 60/734,186, filed on Nov. 7, 2005.
(60) Provisional application No. 60/734,077, filed on Nov. 7, 2005.
(60) Provisional application No. 60/666,028, filed on Mar. 29, 2005.

(51) Int. Cl. A01N 25/00

(52) U.S. Cl. 424/405

(57) ABSTRACT

The invention describes a composition for use in disinfecting a surface for personal use, such as a public restroom facility or telephone. The composition and delivery of the composition provides for the placement of a thin layer of disinfectant which includes a acid-base indicator. The acid-base indicator disappears as the thin layer effects the germicidal activity of the disinfectant. The composition is also rapidly drying, so that the acid-base indicator disappears as well as the disinfecting composition leaving the surface dry. The invention also relates to use of the compositions in a lotion, such as a sunscreen. Use of the acid-base indicator provides a method to visualize where the lotion is applied by color, with the color then later dissipating.

### CROSS REFERENCE TO RELATED APPLICATIONS

This application claims benefit under 35 U.S.C. § 119(e) to U.S. Ser. Nos. 60/696,872, filed Jul. 6, 2005 (Attorney docket number 186573/US), entitled “Color Changing Compositions and Articles” and 60/711,183, filed Aug. 25, 2005 (Attorney docket number 186978/US), entitled “Substituted Phenol-Based Aqueous Indicators”.

This application also claims benefit under 35 U.S.C. § 119(e) to U.S. Ser. Nos. 60/734,338, filed Nov. 7, 2005 (Attorney docket number 187219/US), entitled “Germicide and Dye Composition”, 60/734,230, filed Nov. 7, 2005 (Attorney docket number 187221/US), entitled “Lotion Which is Temporarily Colored Upon Application”, 60/734,144, filed Nov. 7, 2005 (Attorney docket number 187223/US), entitled “Disposable Surface Wipe Article Having a Waste Contamination Dye”, 60/734,186, filed Nov. 7, 2005 (Attorney docket number 187224/US), entitled “Waste Contamination Dye Implement Containing Cleaning Composition and Disappearing Dye” and 60/734,077, filed Nov. 7, 2005 (Attorney docket number 187225/US), entitled “Method of Making Early Indicator Color Changing Diaper or Plastic Color Changing Training Pants”, the contents of which are incorporated herein by reference in their entirety.

### FIELD OF THE INVENTION

The invention relates generally use of acid-base indicators to indicate when and where a surface has been disinfected or an area to which a lotion has been applied.

### BACKGROUND OF THE INVENTION

In an effort to protect the public from unsanitary surfaces in public restrooms, telephones and other surfaces which are contacted by the public a number of methods have been developed. Many people have an aversion to using public restroom facilities or other objects for personal use which have been used previously by others. With the increased concerns of Herpes simplex virus type 2 which is a persistent viral infection once contracted, the community has become increasingly cautious about exposure.

One of the more commonly available methods for protection is a disposable paper cover for the toilet facility. The paper covers do not contain a germicide and are not always available.

There are a number of commercially available germicides that are sprayed onto surfaces but none provide a way to determine when the surface has been adequately treated.

Today, disposable surface wipe articles, such as disposable hand wipes, baby wipes, paper towels, facial tissues, toilet tissues and other cleaning articles, are widely used in personal (animate surface) and environmental (inanimate surface) hygiene, such as in the care of infants and incontinent individuals as a means of cleaning (removing) bodily wastes and other contaminants. These articles have generally replaced reusable, washable cloth articles as the preferred means for these applications because of their convenience and reliability.

Conventional disposable surface wipes, such as the cleaning articles listed above, do not provide any indication of the presence of, or the efficacy of removal of, bodily waste contamination which is undetectable by unaided human vision. This is an important limitation due to the potential for skin irritation (in the case, for example, of feces) if waste residue is left on the skin and/or the potential for further spreading waste to other contacted surfaces thereby spreading potentially harmful organisms or other waste components to such surfaces.

In conjunction with surface wipes, diapers are worn mostly by small children and the elderly. Many times when the person wearing the diaper contaminates it with urine, they are unable to alert the person responsible of changing the diaper that it is dirty. This is because small children lack the vocabulary and the elderly suffer from dementia, Alzheimer's, and other elderly diseases. The time-lapse between the wetting of the diaper and the discovery by the changer that is wet is a cause of diaper rash and sores for the wearer.

Not only is cleansing of surfaces, including the skin, important but protection of surfaces is also important. Skin is one of the surfaces that requires protection from the elements, including the sun.

Darker skin pigmentation is considered desirable by many persons, socially and aesthetically. At present, the most common method for darkening the skin is through sun tanning, using either natural sunlight or specially designed ultraviolet (UV) light sources, e.g., tanning lamps.

However, extended exposure of human skin to ultraviolet light is known to have adverse consequences, both in the short term and in the long term. Specifically, in the short term, individuals exposed to UV risk a painful sunburn and keratitis. In the long term, extended exposure to ultraviolet radiation can result in photo-aging and “leathery” skin, and can further result in various forms of skin cancer and ultimately death.

Fair-skinned individuals are particularly susceptible to sun-induced skin disorders and cancers. For example, they face a higher risk of melanoma (skin cancer), and often incur photo-aging or dermatoheliosis, a condition characterized by wrinkling, irregular pigmentation, and surface roughness. However, even darker skinned individuals exposed to prolonged sunlight incur a high risk of skin cancer and exacerbated aging.

These risks, together with the continued desirability of the suntan look, have resulted in a wide range of UV protection suncreen agents. Such sunscreen agents are typically suspended in a cream, lotion, gel, mousses, waxed based sticks, aerosols, and alcohol sticks for topical application to the skin. For example, the Coppertone™. Company makes a large assortment of popular sunscreen lotions with varying degrees of sun block which extend the body's normal resistance to UV radiation.

One important step in the proper application of an UV protective suncreen lotion on the body is the even and complete coverage of all bodily areas which are exposed to the sun. Typical sunscreen lotions and the like are applied as clear or white creams that are difficult to see upon application. It is thus difficult for a user of these typical sunscreen lotions to assure even and complete coverage on the body. Consequently, it is common to miss spots, resulting in an uneven tan or burn, and the increased susceptibility to the several risks discussed above.

Therefore, a need exists for new compositions and articles that address one or more of the noted weaknesses with available technology.

### BRIEF SUMMARY OF THE INVENTION

The invention provides a germicidal composition with a disappearing acid-base indicator described vide infra which can be sprayed or otherwise spread on a surface with the acid-base indicator indicating the delivery of the germicide. Although the acid-base indicator is added for color, it is thoroughly mixed and completely dispersed in the system so that a coating or fine layer of spray imparts the visual colored composition will also indicate an active germicidal coating or layer. The germicide is effective against Herpes simplex virus type 2 (HSV2) as well as bacteria such as Staphylococcus aureus, Neisseria gonorrhoeae, enteric bacteria Escherichia coli 011K58 (Pathogenic), Shigella sonnei and Salmonella typhimurium, and the yeast Candida albicans. The acid-base indicator will be quite noticeable on lighter colored surface and therefore give a visual check as to the area disinfected. It is believed a novel spray with a acid-base indicator included will enhance usage by the consumer.

Another aspect of the germicide is to provide one or more detergents as germicides. The detergents are surface active and attack the target pathogen but also, through the surface active qualities, causes the composition in spray form or otherwise to spread effectively on the surface to be disinfected. The spreading aspect is helpful because the individual droplets dispensed from any type of spray device will spread to provide a more even layer before drying.

In addition to the delivery of an effective germicide for a broad range of organisms with a acid-base indicator, the composition is also quick drying. The composition can be used in a spray form or applied with an absorbent wipe in a layer which will dry rapidly or can be wiped off the surface with toilet tissue.

The composition can be packaged in any type of airtight container such as an aerosol spray and can be made in a convenient size which can be carried in a purse or pocket. The composition can also be packaged in a larger size spray dispenser for multiple applications for home or commercial use.

The present invention also provides a composition and method that indicate when the bacteria are destroyed by visualizing a color change of the solution that is applied to the surface of an object. Once the individual has applied a composition of the invention to a surface, the surface can be rubbed with the solution, or the solution can be left as a thin film or coating. The color of the film on the surface will change for clear to colorless, colorless to colored or from one color to another color, depending upon the choice of acid-base indicator. The time that it takes for the color to change is a sufficient period of time to kill the organism. Generally, this time period is from a few seconds to a few minutes. An advantage of the compositions of the invention is that the person can visualize the surface area treated; those areas that are not treated will not undergo a color change and the person can apply the composition to that untreated surface area.

The present invention is also directed to a disposable surface wipe having an acid-base indicator described vide infra which detects bodily waste contamination on a surface contacted by the article and which provides a color change indicating the presence of such contamination, preferably by detecting a component of the waste normally present in waste excreted by healthy individuals and not a component infrequently present in the waste due to special circumstances related to the health or other transient condition of the excreter.

In one embodiment, the color change provided by the acid-base indicator is visible to a user of the article. In another embodiment, the article includes a substrate which incorporates the acid-base indicator. In yet another embodiment, the article is a cleaning article that includes a substrate which incorporates the acid-base indicator and which is useful for cleaning waste contamination from a surface.

In another aspect, the invention is generally based on a chemical method where an effected area of the diaper changes color when it becomes wet from the urine. The absorbent article, a diaper for example, is treated with an acid-base indicator that will react with a change in the environment, i.e., the pH of the environment. Thus, when urine or fecal matter is present, the acid-base indicator will change from clear to colored, from colored to clear or from one color to another, depending upon the choice of acid-base indicator (vide infra). In any event, the change in appearance of the acid-base indicator associate with the article will alert the care giver that the article should be changed.

In certain embodiments, the article includes the acid-base indicator in a “printed format” such that when the article is soiled, words such as “change me” or “time to change” will appear due to the change in the acid-base indicator.

In other embodiments, the article can include permanent print that is unaffected by the change of the environment but the underlying acid-base indicator would still change due to the change in the environment. Again, either a soiled area would simply change in color/appearance, or prewritten words may appear upon action from the external environment (urine, fecal matter for example).

The present invention also includes a method for applying and distributing sunscreens and lotions evenly. In one aspect of the invention, a color indicator (an acid-base indicator described infra) is added to such sunscreens or lotions for visual detection by a user of the sunscreen or lotion. The acid-base indicator in the sunscreen or lotion composition initially has a visible color upon application to the skin, and changes or becomes clear (colorless) after a short time period (i.e., between about 0.5 and 10 minutes), thereby permitting the normal or unimpeded use of the product for its intended function (i.e., after the short time period, the user is not colored by the acid-base indicator but rather has a skin color appearance that normally results from application of an uncolored lotion or sunscreen). The presence of the visible color on the epidermis is indicative of the location and amount of composition thereon, thereby enabling total coverage with, and even distribution of, the composition. In one aspect of the invention, such an even distribution of sunscreen ointment results in uniform protection from exposure to UV radiation.

The present invention also includes the use of the acid-base indicators useful in hair removal cream, hair removal wax and heat activated styling spray compositions.

### DETAILED DESCRIPTION

The compositions of the present invention can be used in, but not limited to, a wide variety of fields such as car tire tread marks, infant/baby (spoons, straws), food (alcohol, bubble gum, cakes/pastries, candy, dairy food, decorative ice cubes, food colors, mints, soda/juices, spices/curry), pharmaceuticals (assays for measuring cell proliferation, dental materials/fillings, diagnosis of bacterial infection, diagnosis of tumors, diagnostic reagents, endotracheal intubation device, enzyme assays, laxative, medical equipment, operation theaters, pills, pregnancy test, syrup, treatment of herpes infection), health/beauty (contact lens cleaner, diapers, facial masks, spray on tan, sunscreen), agrochemicals (fertilizers, insecticides, pesticides, plant hormones, weed killer), cleaners (car wash/wax, dusting, floor polish/was, general surface cleaner, glass cleaning), materials (bricks, ceramics, concrete, glass, leather, metals, stones, wood), home/garden (fountain colorant, swimming pool colorant), Security (billing system, safety glasses/goggles, safety masks, scanning machines at the air ports/railway stations/bus station/cargo, security alarm, shipping industry, tag scan, tamper proof labels), semiconductor (antireflective coatings (ARC) for semiconductor processes, dielectric coatings, photo-resists, sensors (fiber optic sensors for measuring fluid parameters especially blood, optical sensors, pollution), displays (electroluminescent displays (EL), liquid crystal displays (LCD), plasma display panels (PDP), super twisted nematic (STN) displays, thin film transistors (TFT)), nanotechnology, NLO (nonlinear optical films), photonics, plastics, photography (erasable image forming material for electrophotography), chromatography, auto (fluid indicator), general use (mugs/cups, candles), military purposes (temporary mine markers) and pH indicators.

Disinfectants

In one aspect, a disinfecting composition is manufactured as a liquid which can be packaged in a number of ways depending on the desired size of container and method of delivery to the surface to be disinfected. An aliphatic alcohol with high volatility is used as the primary component by volume. The alcohol has bacteriacidal characteristics and allows for the rapid drying of the layer of disinfectant on the surface. For use in public restrooms a rapidly drying composition would be most desirable for use. Due to cost and availability, isopropanol is utilized in the examples although other quick-drying alcohols could be substituted. The isopropanol can be mixed with an amount of water and the examples show a 70% isopropanol mixture with 30% water.

Disinfecting surfactant-detergent compounds are also used in the liquid composition. Surfactants are effective germicides and attack the membranes of the organisms. Also, the surfactants are surface active reducing surface tension. This phenomena causes the spreading over the surface of the disinfecting composition providing a more effective distribution of the germicide on the surface. It is thought that the surfactant has two characteristics which contribute to this invention. Those being germicidal activity including effectiveness over a wide range of organisms including bacteria, virus and yeast and providing a reduction of the surface tension of the composition to achieve effective spread and distribution if the germicide on the surface to be disinfected. Two different types of surfactants were tested separately and in combination for efficacy. It was found that both sodium dodecyl sulfate and octyl phenoxy polyethoxyethanol are effective germicide-surfactants. There are other compounds which have the properties of germicide-surfactants, and this invention is not limited to those compounds shown in the examples.

Other exemplary germicides suitable for use in the compositions of the invention include triclosan, triclocarbon, hydrogen peroxide and other oxygen bleaches, para-chloro-meta-xylenol, iodine/iodophors, selected alcohols, chlorohexidine, phenols, phospholipids, thymol, eugeniol, geraniol, oil of lemon grass, and limonene. Additionally, certain quaternary surfactants included herein may also show antimicrobial action.

Germicides are well known in the art. See, for instance, the section on “Quaternary Ammonium and Related Compounds” in the article on Antiseptics and Disinfectants“in Kirk-Othmer Encyclopedia of Chemical Technology 2nd Edition (vol. 2, pp. 632-635), hereby incorporated by reference in its entirety. Preferably, the germicide has a broad spectrum of antimicrobial and antifungal activity. Among the most common germicides are quaternary ammonium compounds such as benzethonium chloride. Others of this class (and generic formulas and descriptions thereof) are those mentioned, for instance in U.S. Pat. Nos. 2,984,639, 3,325,402, 3,703,583 and 3,431,208 and British Patent No. 1,319,396, all of which are incorporated by reference in their entirety. Usually one of the substituents on the quaternary nitrogen has a chain length of about 8 to 18 carbon atoms, for example, quaternary ammonium compounds of alkyl dimethyl ethyl benzyl ammonium chloride, sold under the trade name BARQUAT, manufactured by Lonza Chemicals.

Other types of germicides suitable for use in the present invention are omadines. Examples of omadines are substituted guanidines, e.g., chlorhexidene and the corresponding compounds having 2-ethylhexyl groups instead of chlorophenyl groups, and other bisguanidines such as those described in German Patent Application No. P2,332,382 published Jan. 10, 1974, incorporated by reference in its entirety. Zinc pyrithione sold under the trade name ZINC OMADINE and manufactured by the Arch Chemical Company.

The disinfecting composition (a biocide) contains an acid-base indicator, described infra, which is dissolved and dispersed in the composition.

The acid-base indicators used in the present invention are generally colored under basic condition and change color or fade to clear in non-basic condition. Acid-base indicators which are colored on alkaline pH side (pH >7) and turn clear on acidic pH (pH <7) are most useful. Typically, the acid-base indicators are colored at pH between about 9 and 10, and turn clear at pH between about 6 and 8.

In compositions where color is not desired (clear to color), a base is not included in the composition, but is provided, for example) by the surface of the substrate acted upon, i.e., skin, the oral cavity, mucous, urine, etc.

Alternatively, the composition can be basic and highly colored by use of a fugative base or a base that is not fugitive in nature, such as a metal hydroxide. The pH of the substrate will then determine whether the color of the composition is unchanged upon application, disappears or changes color. Therefore, by choice of dye and pH of the composition and pH of the surface of the substrate, compositions are provided that can be colored and remain so, can change from color to clear, or color to color, or uncolored to a color. It is the combination of the acid-base dye and the substrate surface that determines how the color change, or maintenance, is effected.

The color change of the acid-base indicator is probably due to the neutralization of the composition from interaction with the air and the surface on which it is sprayed. The alkalinity of the material is adjusted carefully so that the neutralization of the composition can produce a visual change from color to clear, clear to colored, or from one color to another color within a short period of time. During the neutralization of the composition and visible change of color, the alcohol surfactant germicide is producing an effective kill on organisms present. The disappearance of the color, the killing of the organisms, and the drying of the germicide occur in rapid sequence leaving a dry, germ-free surface for personal use.

It is also found that this composition does not leave a film after drying so that the surface is not tacky and undesirable for personal use. Also, the composition does not have an objectionable odor as found in phenolic type germicides. Perfume additives may be used to provide a fragrance if desired but are not necessary to mask the odor of the germicidal composition.

The delivery and method of use of the germicide can be in various forms. There is a factor of the necessity of an airtight container for a pH sensitive acid-base indicator. If ambient air is allowed to penetrate into the container, the liquid may be neutralized and the color will disappear. Also, the highly volatile alcohol will escape if the container is not sealed. The disappearance of the color will not affect the strength of the germicide detergent which have a long shelf life.

For personal use a small aerosol container which delivers a fine spray is a practical packaging for the composition. For commercial packaging a hydrocarbon propellant is preferable to meet environmental quality standards. For testing a fluorcarbon propellant of the Freon type was used. A propellant system to deliver a fine spray is preferably because it will deliver a thin, rapidly spreading layer which will dry quickly. Atomizers or other devices which deliver a denser spray may necessitate the wiping of the composition with toilet paper or other wipe before use because of a longer evaporation time for a dense spray. Another preparation of the invention can be the saturation of a woven wipe which is sealed in a foil or other airtight packaging. The packet would be torn open for a one-time usage of the wipe delivering the acid-base indicator colored germicide to the surface. The rubbing of the wipe on the surface will promote evaporation of the composition.

Disposable Surface Wipes

The present invention is directed to a disposable surface wipe article having an acid-base indicator, described herein below, which detects bodily waste contamination on a surface contacted by the article and which provides a color change indicating the presence of such contamination. The term “disposable” is used herein to describe articles which generally are not intended to be laundered or otherwise restored or reused as an absorbent article (i.e., they are intended to be discarded after a single use and, preferably, to be recycled, composted, flushed, or otherwise disposed of in an environmentally compatible manner). The term “surface wipe article” is used herein to describe articles which are intended to be used for wiping either an animate surface such as the human skin, or an inanimate surface such as a floor, wall, furniture, faucet, doorknob or toy surface. For example, disposable surface wipe articles include facial tissues, toilet tissues, paper towels, dry wipes, and wet wipes such as hand wipes or baby wipes.

The disposable surface wipes of the invention preferably include a substrate and a bodily waste contamination acid-base indicator or sensing system incorporated into or onto the substrate. A wide variety of substrates can be used in the disposable surface wipe of the present invention. The substrate may be a nonwoven or woven fibrous material, or a nonfibrous material. The material, form, and design will depend upon the type of article and its intended use. By way of example, materials which can be used include fibers, sponges, closed cell foams, open cell foams, latex, rubber, polymeric materials (such as plastics, especially biodegradable plastics). The substrates can be non-absorbent or absorbent, and can contain optional materials such as superabsorbent polymeric gelling materials.

A suitable article may be, for example a baby wipe for wiping feces and urine from an animate surface such as a baby's skin, or a paper towel or tissue suitable for wiping spills or bodily waste from an inanimate surface such as a wall or furniture. The substrate can be any woven or nonwoven fibrous material, or a non-fibrous material. In one aspect, the substrate is a fibrous material such as a cellusosic or synthetic polymeric material such as polyethylene or polypropylene, or a combination thereof. The substrate has thickness, which can vary depending upon intended use and materials of construction, but generally will be between about 0.05 cm and about 2 cm, more generally between about 0.1 cm and about 1 cm. The substrate can be of any width and length, and can also be a continuous roll. The acid-base indicator is intimately applied into, onto, or within to the substrate

Fibrous substrates for use in the invention can include natural fibers, synthetic fibers, or mixtures of natural and synthetic fibers. Suitable natural fibers include but are not limited to cellulosic fibers, such as wood pulp fibers, cotton, hemp, wool, and rayon. Suitable synthetic fibers include fibers commonly used in textiles, including but not limited to polyester and polypropylene fibers.

Various forming methods can be used to form a suitable fibrous substrate, sometimes referred to as a web. For instance, the substrate or web can be made by nonwoven dry forming techniques, such as air-laying, or alternatively by wet laying, such as on a papermaking machine. Other nonwoven manufacturing techniques, including but not limited to techniques such as melt blowing, spunbonding, needle punching, and hydroentanglement methods may also be used.

In one embodiment, the fibrous substrate can be a dry fibrous airlaid nonwoven web comprising a combination of natural fibers, staple length synthetic fibers and a latex binder. The dry fibrous web can, for example, be about 20-80 percent by weight wood pulp fibers, 10-60 percent by weight staple length polyester fibers, and about 10-25 percent by weight binder. The dry fibrous web can, without limitation, have a basis weight of between about 40 and about 80 grams per square meter. The density of the dry fibrous web can be, for example, less than about 0.12 grams per cubic centimeter. As used herein, “density” is the basis weight of the dry fibrous web divided by the thickness of the dry web, measured in consistent units, where the thickness of the dry web is measured using a circular load foot having an area of about 2 square inches and which provides a confining pressure of about 95 grams per square inch. In one embodiment, the dry fibrous web can have a basis weight of about 64 grams per square meter, a thickness of about 0.06 cm, and a density of about 0.11 grams per cubic centimeter.

The dry fibrous web can comprise at least 50 percent by weight wood pulp fibers, and more preferably at least about 70 percent by weight wood pulp fibers. One particular airlaid nonwoven web which is suitable for use in the present invention comprises about 73.5 percent by weight cellulosic fibers (Southern softwood Kraft having an average fiber length of about 2.6 mm); about 10.5 percent by weight polyester fibers having a denier of about 1.35 gram/9000 meter of fiber length and a staple length of about 0.85 inch; and about 16 percent by weight of a binder composition comprising a styrene butadiene copolymer. The binder composition can be made using a latex adhesive commercially available as Rovene 5550 (49 percent solids styrene butadiene) available from Mallard Creek Polymers of Charlotte, N.C.

Another suitable airlaid nonwoven web for use in the present invention is the airlaid nonwoven web employed in PAMPERS BABY FRESH baby wipes marketed by The Procter & Gamble Company of Cincinnati, Ohio. Such a web is disclosed generally in U.S. application Ser. No. 08/915,349 entitled “Disposable Premoistened Wipe Having Opacity Agent”, filed Aug. 22, 1997 in the name of Gorely, which application is incorporated herein by reference, and includes about 76.4 percent cellulosic fibers, 12.9 percent polyester fibers, and 10.7 percent adhesive binder.

The following patents are also incorporated herein by reference for their disclosure related to suitable fibrous webs: U.S. Pat. No. 3,862,472 issued Jan. 28, 1975; U.S. Pat. No. 3,982,302 issued Sep. 28, 1976; U.S. Pat. No. 4,004,323 issued Jan. 25, 1977; U.S. Pat. No. 4,057,669 issued Nov. 8, 1977; U.S. Pat. No. 4,097,965 issued Jul. 4, 1978; U.S. Pat. No. 4,176,427 issued Dec. 4, 1979; U.S. Pat. No. 4,130,915 issued Dec. 26, 1978; U.S. Pat. No. 4,135,024 issued Jan. 16, 1979; U.S. Pat. No. 4,189,896 issued Feb. 26, 1980; U.S. Pat. No. 4,207,367 issued Jun. 10, 1980; U.S. Pat. No. 4,296,161 issued Oct. 20, 1981; U.S. Pat. No. 4,309,469 issued Jan. 25, 1982; U.S. Pat. No. 4,682,942 issued Jul. 28, 1987; U.S. Pat. No. 4,637,859 issued Jan. 20, 1987; U.S. Pat. No. 5,223,096 issued Jun. 29, 1993; U.S. Pat. No. 5,240,562 issued Aug. 31, 1993; U.S. Pat. No. 5,556,509 issued Sep. 17, 1996; U.S. Pat. No. 5,580,423 issued Dec. 3, 1996; and U.S. Pat. No. 5,840,403 issued Nov. 24, 1998.

The substrate can be single ply or multi-ply, single density or multi-density, and single basis weight or multi-basis weight. Multi-density webs may be made by processes well known in the art. The following patents disclose processes for making webs that can be used in the present invention: U.S. Pat. No. 4,529,480, issued Jul. 16, 1985 to Trokhan; U.S. Pat. No. 4,637,859, issued Jan. 20, 1987 to Trokhan; U.S. Pat. No. 5,364,504, issued Nov. 15, 1994 to Smurkoski et al.; U.S. Pat. No. 5,529,664, issued Jun. 25, 1996 to Trokhan et al.; U.S. Pat. No. 5,679,222 issued Oct. 21, 1997 to Rasch et al.; U.S. Pat. No. 5,714,041 issued Feb. 3, 1998 to Ayers et al.; U.S. Pat. No. 5,906,710, issued May 25, 1999 to Trokhan, all commonly assigned to The Procter & Gamble Co., Cincinnati, Ohio, USA, the disclosures of which are incorporated herein by reference. Multi-basis weight webs and methods for making them are disclosed in U.S. Pat. No. 5,503,715, issued Apr. 2, 1996 to Trokhan et al.; U.S. Pat. No. 5,614,061, issued Mar. 25, 1997 to Phan et al.; U.S. Pat. No. 5,804,281 issued Sep. 8, 1998 to Phan et al.; and U.S. Pat. No. 5,900,122 issued May 4, 1999 to Huston, the disclosures of which are incorporated herein by reference.

The substrate can comprise a hydroentangled web having a basis weight of about 62 grams per square meter and comprising about 50 percent by weight rayon fibers and about 50 percent by weight polyester fibers, polypropylene fibers, or a combination thereof. In still another embodiment, the substrate can comprise a laminate of two outer hydroentangled webs, such as nonwoven webs of polyester fibers having a basis weight of about 30 grams per square meter, joined to an inner constraining layer, which can be in the form of net-like scrim material which contracts upon heating to provide surface texture in the outer layers.

In a number of applications, for example, in situations wherein a liquid-removal function is the primary function to be performed by the surface wipe article, it is preferred that the substrate be substantially free of water or other liquid. Examples of surface wipe articles for these applications include paper towels and facial tissues. In other applications, for example, where removal of non-liquids (such a pasty, semi-solid or solid substances) is also to be performed, it may be preferable to incorporate water or other liquids into the substrate. Examples of surface wipe articles for these applications include baby wipes, hand wipes, hard surface cleansing wipes, and other so-called “wet wipes”. In these cases, the substrate can be premoistened, for example, with an emollient, lotion, tonic, disinfecting liquid, sanitizing liquid, cleansing liquid, or other liquid suitable for application to an object intended to be wiped. The liquid can be water, another aqueous fluid, or hydrophilic liquids (such as ethanol), or lipdphilic liquids (such as silicones, hydrocarbons, or oils), and combinations thereof. Premoistened wipes can be made by wetting the dry substrate with, preferably, at least 1 gram of premoistening liquid per gram of dry fibrous web. Preferably, the dry substrate is wetted with at least about 2.0, and more preferably at least about 2.5 grams of liquid per gram of the dry fibrous web.

The liquid used for premoistening the wipe substrate can be a lotion comprising a water soluble silicon based surfactant, for example, an anionic silicon based sulfosuccinate surfactant. Suitable counter ions include those derived from the alkaline metals (e.g. sodium, potassium); the alkaline earth metals (e.g. magnesium, calcium); ammonia, and alkanol amines (e.g. mono, di, and tri ethanol amines). The lotion can comprise water and a silicon copolyol sulfosuccinate selected from the group consisting, of disodium dimethicone copolyol sulfosuccinate and diammonium dimethicone copolyol sulfosuccinate. Preferably, the lotion comprises less than about 1.00 percent by weight of the silicone based sulfosuccinate. In particular, the lotion can comprise less than about 0.20 percent by weight of the silicone based sulfosuccinate, and in one embodiment comprises between about 0.08 and about 0.10 percent by weight of the silicone based sulfosuccinate. Preferably, the lotion comprises no more than about 1.00 percent by weight total surfactant solids, including the silicone based sulfosuccinate. A suitable disodium dimethicone copolyol sulfosuccinate is commercially available as MACKANATE DC-30 and MACKANATE DC-50 brand sulfosuccinate surfactants available from the McIntyre Group, LTD, University Park, Ill. A suitable diammonium dimethicone copolyol sulfosuccinate is commercially available as MACKANATE DC-30A from the same supplier. U.S. Pat. No. 4,849,127 issued Jul. 18, 1989 to Maxon is incorporated herein by reference for its disclosure related to dimethicone copolyol sulfosuccinates.

The liquid used to premoisten the wipe substrate, and to deliver the acid-base indicator, can also comprise one or more of the following: an effective amount of a preservative, an effective amount of a humectant, an effective amount of an emollient; an effective amount of a fragrance, and an effective amount of a fragrance solubilizer. As used herein, an emollient is a material that softens, soothes, supples, coats, lubricates, or moisturizes the skin. The term emollient includes, but is not limited to, conventional lipid materials (e.g. fats, waxes), polar lipids (lipids that have been hydrophilically modified to render them more water soluble), silicones, aloe extracts such as aloe vera, hydrocarbons, and other solvent materials. Emollients useful in the present invention can be petroleum based, fatty acid ester type, alkyl ethoxylate type, fatty acid ester ethoxylates, fatty alcohol type, polysiloxane type, mucopolysaccharides, or mixtures thereof. Humectants are hygroscopic materials that function to draw water into the stratum comeum to hydrate the skin. The water may come from the dermis or from the atmosphere. Examples of humectants include glycerin, propylene glycol, and phospholipids. Fragrance components, such as perfumes, include, but are not limited to water insoluble oils, including essential oils. Fragrance solubilizers are components which reduce the tendency of the water insoluble fragrance component to precipitate from the lotion. Examples of fragrance solubilizers include alcohols such as ethanol, isopropanol, benzyl alcohol, and phenoxyethanol; any high HLB (HLB greater than 13) emulsifier, including but not limited to polysorbate; and highly ethoxylated acids and alcohols. Preservatives prevent the growth of micro-organisms in the liquid lotion and/or the substrate. Generally, such preservatives are hydrophobic or hydrophillic organic molecules. Suitable preservatives include, but are not limited to parabens, such as methyl parabens, propyl parabens, and combinations thereof.

The liquid used to premoisten the wipe substrate can also comprise an effective amount of a kerotolytic for providing the function of encouraging healing of the skin. An especially preferred kerotolytic is Allantoin ((2,5-Dioxo-4-Imidazolidinyl)Urea), a heterocyclic organic compound having an empirical formula C.sub.4 H.sub.6 N.sub.4 O.sub.3. Allantoin is commercially available from Tri-K Industries of Emerson, New Jersey.

U.S. Pat. No. 5,534,265 issued Jul. 9, 1996; U.S. Pat. No. 5,043,155 issued Aug. 27, 1991; and U.S. Pat. No. 5,648,083 issued Jul. 15, 1997 are incorporated herein by reference for the purpose of disclosing additional ingredients for use in suitable premoistened wipe substrates. U.S. Pat. No. 4,904,524 (Yoh), issued Feb. 27, 1990 and incorporated herein by reference, discloses a baby wipe comprising a suitable substrate impregnated with an aqueous lotion and a hydrophobic functional ingredient (e.g., dimethicone) entrapped in polymeric beads (e.g. microsponges, microcapsules) concentrated near the surface of the substrate. Suitable premoistened wipe substrates can also be made as described in U.S. Pat. No. 4,300,981 (Carstens, issued Nov. 17, 1981); U.S. Pat. No. 4,112,167 (Dake et al., issued Sep. 5, 1978); U.S. Pat. No. 4,481,243 (Allen, issued Nov. 6, 1984); U.S. Pat. No. 4,513,051 (Lavash, issued Apr. 23, 1985); and U.S. application Ser. No. 09/132,883 (Hanser et al., filed Aug. 12, 1998), all hereby incorporated by reference.

A disposable wet wipe having a premoistened substrate suitable for use in the present invention is also available as PAMPERS BABY FRESH from the Procter & Gamble Co. of Cincinnati, Ohio. Such a wipe is described, modified as noted below, in the Example set forth in U.S. application Ser. No. 08/915,349 entitled “Disposable Premoistened Wipe Having Opacity Agent”, filed Aug. 22, 1997 in the name of Gorely, which application was earlier incorporated herein by reference. The Example in the aforesaid application is modified to make the PAMPERS BABY FRESH wipe by including about 76.4 percent cellulosic fibers, 12.9 percent polyester fibers, and 10.7 percent adhesive binder (the binder contains no titanium dioxide) in the substrate web. The web is embossed using the pattern described below, with an embossing roll having a land area of about 18 percent. The amount of binder adhesive sprayed on the web is sufficient to provide a dry web having about 10.7 percent by dry weight binder adhesive solids (this dry substrate or web is hereinafter referred to as the PAMPERS BABY FRESH dry substrate). As indicated in the aforesaid Example, a “wet wipe” having premoistened substrate is obtained by moistening the PAMPERS BABY FRESH dry substrate with a liquid composition comprising about 97% water, with the remaining 3% being the other listed minor constituents. The embossing pattern for the PAMPERS BABY FRESH wipe is depicted in U.S. Design Patent No. 400,716, issued Nov. 10, 1998, which is also incorporated herein by reference, the wipe having an embossing pattern repeat of 16.0 cm (6.3 inches), the character line thickness being 0.081 cm (0.032 inches), and the elipses having a major diameter of 0.28 cm (0.11 inches) and minor diameter of 0.14 cm (0.055 inches).

As described above, the disposable surface wipe articles of the present invention may comprise wet or dry substrates. In certain preferred embodiments, the substrate is a wet substrate, containing free liquid water or other aqueous fluid on its surface or held within pores, capillaries, voids, etc. within or on the body of the substrate. Many of the acid-base indicators described herein, especially those dependent on chemical or biological reactions, require the presence of water or another aqueous fluid to function properly. The water, or other aqueous fluid, is liberatable from the substrate under normal usage conditions, such as upon contact with a surface or upon application of wiping pressure. The liberated water or other aqueous fluid is then available to enable or facilitate the acid-base indicator reaction (such as a chemical reaction to detect the waste contamination or a component thereof) to proceed in the cases where the contamination is substantially anhydrous and contains insufficient “free” or unbound water or to enable the reaction, for example as in the case of dried fecal contamination on a baby's skin or on inanimate environmental surfaces. Without the water or other aqueous fluid available from the wet substrate of the article, the acid-base indicator could fail to detect waste contamination on the surface of interest. Dry substrates, however, may be appropriate for applications wherein the waste contamination is reasonably expected to contain sufficient water to allow the acid-base indicator to function properly, such as in the case of detecting “fresh” faces on baby's skin. In certain embodiments, a wipe substrate may be tactilely dry, but carry its own supply of water, or other aqueous fluid, sufficient to enable the detection reaction. For example, a “dry” wipe may comprise a high internal phase emulsion disposed on a substrate, wherein the emulsion ruptures to release water (alone or with additives such as a disinfectant) when subjected to shear or pressure during the wiping of skin or another surface. Such dry wiping substrates are described more fully in U.S. Pat. Nos. 5,756,112; 5,763,332; 5,863,663; 5,914,177 and 5,948,540 (Mackey et al.), all of which are incorporated herein by reference.

The disposable surface wipe or cover article includes at least one acid-base indicator, adapted to detect one or more markers of bodily waste contamination on a surface contacted by the article, and having the capability to provide a color change of such detection to the user or caretaker. The acid-base indicator is incorporated into or onto a surface-contacting substrate. The acid-base indicators of the present invention may also be associated with a carrier structure. The carrier structure may hold, stabilize, and/or at least partially encapsulate the acid-base indicator. Examples of carrier structures include one or more layers of woven and nonwoven webs, films, foams, scrims, hydrogels, sponges, and the like. The acid-base indicator may be attached to the carrier structure, held between two or more components, layers, or folds of the carrier structure, or may be sealed within the carrier structure. The carrier structure may be attached to the substrate of the disposable surface wipe article. The acid-base indicator, and/or carrier if a carrier is utilized, may additionally comprise an element adapted to retaining the acid-base indicator and/or controlling the access of the contamination, or component thereof, to the acid-base indicator. For example, a semi-permeable or selectively permeable membrane may be employed to restrict the rate of access of the contaminant to the acid-base indicator or to restrict access to the acid-base indicator to specific elements, molecules, or organisms (such as specific pH, size, bio-specificity, and so forth). The access control element may additionally comprise a semi-permeable film, as known in the drug delivery and electrodialysis art, for example, or a soluble (such as a water soluble) coating.

As used herein, the term “acid-base indicator” refers to the compounds described herein that are generally colored under basic condition and change color or fade to clear in non-basic condition. Acid-base indicators which are colored on alkaline pH side (pH >7) and turn clear on acidic pH (pH <7) are most useful. Typically, the acid-base indicators are colored at pH between about 9 and 10, and turn clear at pH between about 6 and 8.

In compositions where color is not desired (clear to color), a base is not included in the composition, but is provided, for example) by the surface of the substrate acted upon, i.e., skin, the oral cavity, mucous, urine, etc.

Alternatively, the composition can be basic and highly colored by use of a fugative base or a base that is not fugitive in nature, such as a metal hydroxide. The pH of the substrate will then determine whether the color of the composition is unchanged upon application, disappears or changes color. Therefore, by choice of dye and pH of the composition and pH of the surface of the substrate, compositions are provided that can be colored and remain so, can change from color to clear, or color to color, or uncolored to a color. It is the combination of the acid-base dye and the substrate surface that determines how the color change, or maintenance, is effected.

The articles of the present invention specifically comprise acid-base indicators that provide a color change to a user or caretaker indicating the detection of bodily waste of interest, such as feces, urine, mucous, saliva, sebum, sweat, ejaculates such as semen, or menses, on a surface.

Preferably, the detection color change provided by the acid-base indicator is an optical color change which is visible to the unaided eye of a user of the surface wipe article (as used herein, the term “user” includes, for example, a caretaker of an individual, such as a baby, on which the wipe article may used). The color change provided by acid-base indicator is a chemical color change (such as a change in pH, enzyme activity, or concentration of any other chemical species. The color change may be qualitative (for example, indicating the presence of waste contamination) or quantitative (for example, a measurement of the amount or concentration of the waste contamination).

In certain embodiments, the color change from acid-base indicator is available to the user prior to the completion of any detection reaction process. The time between the beginning of use by a user and the time at which the disposable wipe article is discarded is typically less than about 30 seconds and may be considerably shorter. For any color change of contamination to be useful, the color change must be detectable by a user during the useful life of the article. It is therefore evident that, considering the relatively short useful life of articles of the present invention (compared, for example, with disposable diapers), response speed is critical. Typically, the color change is provided within less than about 30 seconds of the time the article contacts the, target waste contamination. More typically, the color change is provided within less than about 15 seconds of the time of contacting the target contamination. Even more typically, the color change is provided within less than about 10 seconds of the time of contacting the target contamination. Most desirable the color change is provided within less than about 5 seconds of the time of contacting the target contamination.

In any case, the color change provided by acid-base indicator may be durable (stable and readable over a length of time typically at least of the same magnitude as the usage life of the article) or transient (registering a real-time measurement). Since the useful life of the disposable wipe articles of the present invention is typically short, however, there is no need for a stable visual endpoint or indication. Once the article is discarded, loss of the color change is irrelevant. Further, the acid-base indicator, or any of its components, may be adapted to detect and/or color change only concentrations of the waste contamination above a predefined threshold level (such as in cases wherein the contamination level is below typical background levels). Regardless of the type of disposable surface wipe article, the color change is preferably generated and/or displayed on the article or another operatively connected component as described herein, and not on the contaminated surface itself.

Significantly, the present invention is primarily directed to the detection of any waste contamination by detecting a component of the waste normally present in the waste excreted by healthy individuals (in other words, the component is something expected in all typical waste samples) and not a component infrequently present in the waste due to special circumstances related to the health or other transient condition of the excreter. It is important, for instance, in the case of feces remaining on an animate surface such as a baby's skin, to be able to detect such a condition and remediate it in order to prevent skin irritation and/or accidental spread of the contamination, which may contain pathogens or other potentially harmful substances, to inanimate surfaces such as toys, changing tables, and the like. It is also important, for example, in the case of feces which may have contaminated an inanimate surface, to be able to detect such a condition and remediate it in order to prevent accidental spread of the; contamination from the surface to humans.

The presence of bodily waste contamination on a surface may be observed by detecting a normally occurring component of the waste as a marker. For example, the marker may comprise any elemental, chemical, or biological components that may be normally found in the contaminating waste of interest. The markers may comprise, for example, enzymes from endogenous or microbial origin such as trypsin, chymotrypsin, amylase, elastase, lipase, leucine aminopeptidase, and acid or alkaline phosphatase, among others. The marker may also comprise one or more bacteria such as Bifidobacteria and Lactobacillus. These enzymes and bacteria are, for example, commonly found in the feces of healthy babies. Other suitable markers may include mucous and other endogenous secretions (e.g., bile acids and salts thereof), proteinaceous material, fats (e.g., free fatty acids such as myristic, linoleic, palmitic, stearic, and oleic acids), soaps (e.g., palmitic and stearic acid soaps), electrolytes (e.g., aluminum, calcium, chlorine, copper, tin, zinc, sodium, iron, magnesium, manganese, phosphorous, sulphur, bicarbonate, and potassium), vitamins and related compounds (e.g., thiamine, riboflavin, niacin, biotin, pantothenic acid, folic acid,: ascorbic acid, and vitamin E), amino acids and other nitrogenous compounds (e.g., histidine, arginine, isoleucine, leucine, lysine, threonine, valine, etc.), carbohydrates, and other organic materials (e.g., long chain alcohols, long chain esters, triglycerides, hydrocarbons).

An exemplary acid-base indicator (sensing system) is based on the detection of alkaline phosphatase (ALP) in fecal contamination, ALP has been found to be present in the feces of babies from shortly after birth to at least the onset of toilet training. This exemplary acid-base indicator can be prepared as follows. A buffer solution is prepared by mixing 3.14 grams of sodium carbonate (anhydrous) in 500 ml deionized water, followed by the addition of 9.5 grams of Borax, available as catalog #22133-3 from Sigma-Aldrich of St. Louis, Miss. The buffer solution is then stirred until the solids are dissolved. A cofactor solution is also prepared by dissolving 0.203 grams of magnesium chloride in 500 ml of deionized water. An indicator solution can be prepared by dissolving 1.00 grams of one of the acid-base indicators as a (di)phospate as described throughout the specification in 200 ml of the buffer solution, and subsequently adding 1.0 ml of the cofactor solution to this mixture. A 0.133% (wNV) Nile Blue Chloride solution can be prepared by dissolving 34.4 micrograms of solid chloride, in 25 ml of isopropanol. A detecting solution (i.e., acid-base indicator system) can prepared by adding 1.0 ml of the 0.133% (wNV) Nile Blue chloride solution to 25 ml of the indicating solution. The detecting solution can be applied by spraying the detecting solution using a 50 ml tube-type sprayer available as Z12-629-2, available from Sigma-Aldrich, onto the previously mentioned PAMPERS BABY FRESH dry substrate and allowing the web to dry. The detecting solution can be applied to the substrate at a basis weight of 0.038 g/cm.sup.2 (6 ml of the detecting solution sprayed evenly over a 8.9 cm by 17.8 cm substrate) and allowed to dry. Upon contact with residual fecal contamination, ALP in the feces would cleave the phosphate groups from the derivatized acid-base indicator, resulting in a visual color change from the acid-base indicator within 5 seconds or less.

In certain embodiments of the foregoing example, the range of concentration of ALP in the detecting solution is from about 0.1% to about 10% (wNV). However, concentrations outside this range are contemplated, including the application of neat acid-base indicator (di)phosphate to the substrate. In addition, in preferred embodiments of the foregoing the example, the color of the PAMPERS BABY FRESH dry substrate used is white. However, the substrate color may be varied to moderate or change the color of the color change (such as a blue substrate to turn the color change into more of a purple color). Further, the substrate may alternatively be any fibrous web, such as the fibrous webs typically found in toilet tissue, facial tissue, paper towels, and other cleaning wipes. Such substrates, in combination with the above-described acid-base indicator, can be used to form a disposable wipe article of the present invention.

A surface wipe article of the present invention, similar to the foregoing example but having a wet substrate, could be prepared by spraying 10 ml of an acid-base indicator in a solution at approximately pH=7 evenly on the PAMPERS BABY FRESH premoistened wipe previously described herein. Additionally, an acid-base indicator, an aqueous solution thereof, or an alternate acid-base indicator, could be microencapsulated via the approach described in U.S. Pat. Nos. 5,756,112; 5,763,332; 5,863,663; 5,914,177 and 5,948,540 (Mackey et al.), all of which were earlier incorporated herein by reference.

In instances where the article includes a substrate which comprises its own supply of water or other aqueous fluid, the acid-base indicator may detect abnormal health and/or nutritional markers in bodily waste excreted by an individual, and to color change the presence of the abnormality to a user of the article. Suitable color changes, and preferred attributes of such color changes, are discussed above and further below in connection with the acid-base indicators of the invention. In this case, since the substrate provides the water required for the detection reaction, the reaction conditions may be :better controlled so as to enable more reliable detection of small variations in waste components indicative of abnormal conditions. “Health markers” and “nutritional markers” (for example, in human feces or mucous), as used herein, refer to any elemental, chemical, or biological components that may be found in the waste, and any combinations of, or relationships (such as ratios) between the components, having a defined relationship with the human health (such as disease, infection, poisoning) and nutritional status, respectively. The nutritional status of an individual includes, for example, metabolic efficiency, nutrient deficiencies, nutrient absorption or malabsorption, food and drink intake, food allergies (e.g., to peanuts), food intolerance (e.g., lactose intolerance), colonic bacteria ecology (e.g., beneficial bacteria such as bifidobacteria and lactobacillus), and total energy balance. Health markers may include heavy metals (e.g., lead, mercury, etc.), radioactive substances (e.g., cesium, strontium, uranium, etc.), fats, enzymes, endogenous secretions, proteinaceous matter (e.g., casts), mucous, and microorganisms (described in more detail hereinafter in the bioacid-base indicator section) that may be related to various health issues such as skin irritation, infection, diarrhea, gastrointestinal distress or disease, or poisoning. Proteinaceous masses, such as casts (e.g., in urine) may be sensed by targeting Tamm-Horsfall protein.

Surface wipe articles which perform an efficacious waste contamination “cleaning” (for example, removal) function, in addition to the waste contamination detection and color changing functions described above, are one preferred embodiment of the present invention. As used herein “efficacious” cleaning means that the article is capable of substantially, if not entirely, removing or otherwise mitigating the target waste contamination from the surface of interest. Surface wipe articles which can perform such a waste contamination cleaning function include cleaning articles such as facial tissues, is toilet tissues, paper towels, wet or dry wipes and the like. Both wet and dry cleaning devices and articles are included, the former of which are suitable for cleaning objects without need for aqueous cleaning liquids, or if they do use aqueous cleaning liquids relatively small amounts are used. Surface wipe articles of this embodiment can comprise the wet (for example, premoistened) or dry substrates, and a waste contamination acid-base indicator, as described previously. As is apparent, by performing a waste removal function, such surface wipe.articles can advantageously be used to decontaminate a contaminated surface after contamination is detected and color changeed to a user of the article.

In another embodiment, a disposable mop includes a waste contamination acid-base indicator of the invention. The mop comprises an elongated handle and a mop head substrate connected to one end of the elongated handle via a bracket. In this embodiment the mop head substrate is disposable, and the substrate can be made of a material or materials (ideally biodegradable) preferably suitable for performing a waste contamination removal function. Suitable substrates are described below and previously herein.

Waste contamination acid-base indicator, such as an acid-base indicator described herein, is incorporated into or onto at least part of the bottom surface of the mop substrate. Coloration of the mop would indicate waste that was basic in nature.

Substrates which are suitable for use with the present invention, and especially for cleaning devices such as a dry mop, are more fully described in U.S. patent application Ser. No. 09/082,349 entitled “Novel Structures Useful As Cleaning Sheets”, filed May 20, 1998; and U.S. patent application Ser. No. 09/082,396 entitled “Novel Three Dimensional Structures Useful As Cleaning Sheets”, filed May 20, 1998, both of which are hereby incorporated herein by reference. While the above-described sheets are preferred, it will be understood that other substrates, including non-fibrous substrates such as a closed cell or open cell foam, described above may be equally suitable for use with the present invention.

In an alternative embodiment, the present invention may comprise a surface wipe article in the form of a hand covering which can detect and alert the user to specific waste contamination conditions. The hand cover can partially or wholly cover the hand. Preferably, a acid-base indicator is generally located on at least a portion of an exterior palm-side surface of the hand covering. Example forms of handcovers include but are not limited to finger cots, gloves, mittens and hand wraps. Preferably, such body coverings are disposable. Such coverings may be used, for example, by caregivers for babies or incontinent individuals, in a medical care environment, and so forth.

The present invention can also be employed in connection with disposable covers for surfaces including disposable bibs, disposable baby diaper changing pads or “mats”, disposable bed pads, and disposable cutting surfaces, among others, which may become contaminated with bodily waste incidental to their primary uses.

Diapers and/or Sanitary napkins

The present invention also provide absorbent articles, such as diapers, disposable diapers and the like that have an absorbent material that is treated with an acid-base indicator. The acid-base indicator, when subjected to a change in the environment, such as a pH change (i.e., urine or fecal matter) will have a change in appearance (from clear to colored, colored to clear or from one color to another color).

The acid-base indicators used in the present invention are generally colored under basic condition and change color or fade to clear in non-basic condition. Acid-base indicators which are colored on alkaline pH side (pH >7) and turn clear on acidic pH (pH <7) are most useful. Typically, the acid-base indicators are colored at pH between about 9 and 10, and turn clear at pH between about 6 and 8.

Absorbent articles suitable for use with the present invention include diapers, training pants, incontinence products, diaper pants, disposable underwear, or the like. Suitable training pants and diaper pants can have seamed side portions or refastenable side portions. The present invention is particularly suited for use with training pants or diaper pants to aid in toilet training.

To enhance containment and/or absorption of body exudates, a diaper or training pant, for example, can include a front waist elastic member, a rear waist elastic member, and leg elastic members (not shown), as are known to those skilled in the art. Waist elastic members and leg elastic members can be operatively joined to an outer cover and/or bodyside liner of the training pant. Elastic members for the containment flaps, waist elastics and leg elastics can be formed of any suitable elastic material. As is well known to those skilled in the art, suitable elastic materials include sheets, strands or ribbons of natural rubber, synthetic rubber, or thermoplastic elastomeric polymers. The elastic materials can be stretched and adhered to a substrate, adhered to a gathered substrate, or adhered to a substrate and then elasticized or shrunk, for example with the application of heat, such that elastic constrictive forces are imparted to the substrate. In one particular embodiment, for example, the leg elastic members comprise a plurality of dry-spun coalesced multifilament spandex elastomeric threads sold under the trade name LYCRA® and available from E. I. Du Pont de Nemours and Company, Wilmington, Del.

The outer cover of the article has an exterior surface and an opposite interior surface. The outer cover desirably comprises a material that is substantially liquid impermeable. The outer cover can be a single layer of liquid impermeable material, but desirably comprises a multi-layered laminate structure in which at least one of the layers is liquid impermeable. For instance, the outer cover can include a liquid permeable outer layer and a liquid impermeable inner layer that are suitably joined together by a laminate adhesive. Suitable laminate adhesives, which can be applied continuously or intermittently as beads, a spray, parallel swirls, or the like, can be obtained from Findley Adhesives, Inc., of Wauwatosa, Wis., or from National Starch and Chemical Company, Bridgewater, N.J. The liquid permeable outer layer can be any suitable material and desirably one that provides a generally cloth-like texture. One example of such a material is a 20 gsm (grams per square meter) spunbond polypropylene nonwoven web. The outer layer can also be made of those materials of which liquid permeable bodyside liner is made. While it is not a necessity for outer layer to be liquid permeable, it is desired that it provides a relatively cloth-like texture to the wearer.

The inner layer of the outer cover can be both liquid and vapor impermeable, or can be liquid impermeable and vapor permeable. The inner layer is desirably manufactured from a thin plastic film although other flexible liquid impermeable materials can also be used. The inner layer, or the liquid impermeable outer cover when a single layer, prevents waste material from wetting articles, such as bedsheets and clothing, as well as the wearer and caregiver. A suitable liquid impermeable film for use as liquid impermeable inner layer, or a single layer liquid impermeable outer cover, is a 0.025 millimeter (1.0 mil) polyethylene film commercially available from Edison Plastics Company of South Plainfield, N.J. If the outer cover is a single layer of material, it can be embossed and/or matte finished to provide a more cloth-like appearance. As earlier mentioned, the liquid impermeable material can permit vapors to escape from the interior of the disposable absorbent article, while still preventing liquids from passing through the outer cover. A suitable “breathable” material is composed of a microporous polymer film or a nonwoven fabric that has been coated or otherwise treated to impart a desired level of liquid impermeability. A suitable microporous film is a PMP-1 film material commercially available from Mitsui Toatsu Chemicals, Inc., Tokyo,Japan, or an XKO-8044 polyolefin film commercially available from 3M Company, Minneapolis, Minn.

The outer cover desirably comprises one or more appearance-related components. Examples of appearance-related components include, but are not limited to, graphics; highlighting or emphasizing leg and waist openings in order to make product shaping more evident or visible to the user; highlighting or emphasizing areas of the product to simulate functional components such as elastic leg bands, elastic waistbands, simulated “fly openings” for boys, ruffles for girls; highlighting areas of the product to change the appearance of the size of the product; registering wetness indicators, temperature indicators, and the like in the product; registering a back label, or a front label, in the product; and registering written instructions at a desired location in the product.

When the child wets the absorbent article, liquid is communicated to the acid-base indicator, whereupon the there is a change in color, appearance, or the like.

The liquid permeable bodyside liner generally overlies the outer cover and absorbent assembly, and can but need not have the same dimensions as the outer cover. The bodyside liner is desirably compliant, soft feeling, and non-irritating to the child's skin. Further, the bodyside liner can be less hydrophilic than the absorbent assembly, to present a relatively dry surface to the wearer and permit liquid to readily penetrate through its thickness.

The bodyside liner can be manufactured from a wide selection of web materials, such as synthetic fibers (for example, polyester or polypropylene fibers), natural fibers (for example, wood or cotton fibers), a combination of natural and synthetic fibers, porous foams, reticulated foams, apertured plastic films, or the like. Various woven and nonwoven fabrics can be used for the bodyside liner. For example, the bodyside liner can be composed of a meltblown or spunbonded web of polyolefin fibers. The bodyside liner can also be a bonded-carded web composed of natural and/or synthetic fibers. The bodyside liner can be composed of a substantially hydrophobic material, and the hydrophobic material may, optionally, be treated with a surfactant or otherwise processed to impart a desired level of wettability and hydrophilicity. For example, the material can be surface treated with about 0.28 weight percent of a surfactant commercially available from the Rohm and Haas Co. under the trade designation Triton X-102. The surfactant can be applied by any conventional means, such as spraying, printing, brush coating or the like. The surfactant can be applied to the entire bodyside liner 42 or can be selectively applied to particular sections of the bodyside liner, such as the medial section along the longitudinal centerline.

A suitable liquid permeable bodyside liner is a nonwoven bicomponent web having a basis weight of about 27 gsm. The nonwoven bicomponent can be a spunbond bicomponent web, or a bonded carded bicomponent web. Suitable bicomponent staple fibers include a polyethylene/polypropylene bicomponent fiber available from CHISSO Corporation, Osaka, Japan. In this particular bicomponent fiber, the polypropylene forms the core and the polyethylene forms the sheath of the fiber. Other fiber orientations are possible, such as multi-lobe, side-by-side, end-to-end, or the like.

The absorbent assembly is positioned between the outer cover and the bodyside liner, which components can be joined together by any suitable means such as adhesives as is well known in the art. The absorbent assembly can be any structure which is generally compressible, conformable, non-irritating to the child's skin, and capable of absorbing and retaining liquids and certain body wastes. The absorbent assembly can be manufactured in a wide variety of sizes and shapes, and from a wide variety of liquid absorbent materials commonly used in the art. For example, the absorbent assembly can suitably comprise a matrix of hydrophilic fibers, such as a web of cellulosic fluff, mixed with particles of a high-absorbency material commonly known as superabsorbent material. In a particular embodiment, the absorbent assembly comprises a matrix of cellulosic fluff, such as wood pulp fluff, and superabsorbent hydrogel-forming particles. The wood pulp fluff can be exchanged with synthetic, polymeric, meltblown fibers or with a combination of meltblown fibers and natural fibers. The superabsorbent particles can be substantially homogeneously mixed with the hydrophilic fibers or can be nonuniformly mixed. The fluff and superabsorbent particles can also be selectively placed into desired zones of the absorbent assembly 44 to better contain and absorb body exudates. The concentration of the superabsorbent particles can also vary through the thickness of the absorbent assembly. Alternatively, the absorbent assembly can comprise a laminate of fibrous webs and superabsorbent material or other suitable means of maintaining a superabsorbent material in a localized area.

Suitable superabsorbent materials can be selected from natural, synthetic, and modified natural polymers and materials. The superabsorbent materials can be inorganic materials, such as silica gels, or organic compounds, such as crosslinked polymers. Suitable superabsorbent materials are available from various commercial vendors, such as Dow Chemical Company located in Midland, Mich. and Hoechst-Celanese Corporation located in Portsmouth, Va. Typically, a superabsorbent material is capable of absorbing at least about 15 times its weight in water, and desirably is capable of absorbing more than about 25 times its weight in water.

In one embodiment, the absorbent assembly is generally rectangular in shape, and comprises a blend of wood pulp fluff and superabsorbent material. One preferred type of fluff is identified with the trade designation CR1654, available from Kimberly-Clark Corporation, Neenah, Wis., and is a bleached, highly absorbent sulfate wood pulp containing primarily soft wood fibers. As a general rule, the superabsorbent material is present in the absorbent assembly in an amount of from about 5 to about 90 weight percent based on total weight of the absorbent assembly. The absorbent assembly suitably has a density within the range of about 0.10 to about 0.35 grams per cubic centimeter. The absorbent assembly may or may not be wrapped or encompassed by a suitable tissue wrap that maintains the integrity and/or shape of absorbent assembly.

The absorbent chassis can also incorporate other materials that are designed primarily to receive, temporarily store, and/or transport liquid along the mutually facing surface with absorbent assembly, thereby maximizing the absorbent capacity of absorbent assembly. One suitable material is referred to as a surge layer and comprises a material having a basis weight of about 50 grams per square meter, and comprising a through-air-bonded-carded web of a homogenous blend of 60 percent 3 denier bicomponent fiber comprising a polyester core/polyethylene sheath, commercially available from BASF Corporation, and 40 percent 6 denier polyester fiber, commercially available from Hoechst Celanese.

An outer cover can comprise a translucent material that has sufficient opacity, or a transparent or translucent material that is otherwise treated, to mask a urine soluble ink after it has dissolved. Such an outer cover should not be so opaque that the graphics printed on the interior surface of the outer cover or adjacent to the interior surface are obscured. Polymer films used to form the outer cover can be treated with titanium dioxide to make the film appear white and to develop sufficient opacity to mask urine, BM and dissolved inks. Examples of suitable outer cover materials include films formed of polyethylene, polypropylene, cataloy, bi-component, any polymer based extruded film, or the like. One such film is a polyethylene film having a thickness of about 0.2 millimeter (0.75 mil).

It should be understood that the acid-base indicator(s) can be applied to any of the materials used to make the articles herein. For example, the acid-base indicator can be sprayed onto the inner surface of an outer cover layer to show that urine has soaked through the other layers of the article. Similarly, the acid-base indicator can be admixed, sprayed, coated onto, etc. the absorbent layer.

Skin Lotions

The present invention provides compositions for application to the skin, including an acid-base indicator and methods of their preparation, as well as apparatus for temporarily colorizing the epidermis. The lotions may be moisturizers, sunscreens and the like.

The acid-base indicators suitable for use in the invention are those acid-base indicators which are physiologically compatible with the skin, and which readily dissolve in creams and lotions. The acid-base indicators may be used individually or in combination. Suitable acid-base indicators are also those physiologically acceptable substances which appear clear at a pH of between approximately 6.5 and 8.0, and which appear colored at a pH outside this range. Suitable acid-base indicators also include those substances described throughout the specification.

The invention utilizes the fact that the pH of normal human skin is between approximately 7.0 and 7.5 at any given time. Therefore, one acid-base indicator according to the invention has (i) clear appearance at a pH in the normal skin range of 7.0 to 7.5 and (ii) a colored appearance at a pH outside this range. Typical sunscreen creams and sun lotions have a pH of 7.5 or above. Thus, if a acid-base indicator is chosen which is red at pH 8.0, and that acid-base indicator is added to a lotion with a pH of 8.0, then the lotion will appear colored. When applied to the skin, however, the skin's pH will shift the overall lotion pH from 8.0 to 7.0-7.2, and will thus change the acid-base indicator from colored to colorless.

Alternatively, a sunscreen or lotion according to the invention is one which (i) has a pH of approximately 6.5 (or less) and (ii) utilizes a acid-base indicator which is colored at pH 6.5 (or less) and colorless at pH 7.0 to 7.5. Consequently, upon application to human skin, the initially colored sunscreen or lotion pH will shift upwards, due to the skin's pH, to approximately pH 7.0 to 7.5, and will thus become colorless at that time.

Indicators according to the invention can be added during the manufacture or the formulation of the lotion, such as described below. Alternatively, by controlling the pH of the lotion, the acid-base indicators can also be added after formulation.

As described above, suitable indicators according to the invention are those which undergo a color change from colored to clear (i.e., substantially colorless) at a pH range of 6.5-8.0, and which are suitable for application to the human skin. Suitable indicators, for example, include those described throughout the specification.

In accord with one embodiment of the invention, acid-base indicators are employed topically. For topcial use, it is desirable that an acid-base indicator is dispersed in an emulsion of sunscreen or lotion and applied to the skin. For this purpose, the acid-base indicators are intended to be admixed in a pharmacologically acceptable topical carrier such as a gel, an ointment, a lotion, or a cream. Such carriers include, but are not limited to, water, glycerol, alcohol, propylene glycol, fatty alcohols, triglycerides, fatty acid esters, and mineral oils

Sunscreening agents according to the invention include the UVA-type (typical UVA-type sunscreening agents include certain benzophenones and dibenzoyl methanes), the UVB type (typical UVB type sunscreening agents include substituted para-aminobenzoates, alkyl esters of para-methoxycinnamate and certain esters of salicylic acid), or a combination of the two. Generally, the sunscreening agents are used in amounts effective to provide the desired level of protection against UVA and/or UVB radiation. For example, the sunscreening agents are generally used in the amounts of about 2% to about 20% by weight of the total composition, with about 5% to about 18% being preferred, and about 2% to about 15% being most preferred.

Representative UVB-type sunscreening agents suitable for use with the invention include, without limitation, the following:

DEA methoxyinnamate (diethanolamine salt of p-methoxy hydro cinnamate), e.g. tradename BERNEL HYDRO from Bernel Chemical Co., Inc.

ethyl dihydroxypropl PABA (ethyl dihydroxypropyl p-aminobenzoate), e.g., tradename AMERSCREEN R from Amerchol Corp.;

glycerol PABA (glyceryl-p-aminobenzoate), e.g., tradename NIPA G.M.P.A from NIPA Laboratories Inc.;

homosalate (Homomenthyl salicylate), e.g., tradename KEMESTER HMS from Humko Chemical;

octocrylene (2-ethylhexyl-2-cyano-3,3-diphenylacrylate), e.g., tradename UVINUL N-539 from BASF Chemical Co.;

octyl dimethyl PABA (OCtyl dimethyl p-aminobenzoate, 2-ethylhexyl p-dimethylaminobenzoate, Padimate 0), e.g., tradenames AMERSCOL, ARLATONE UVB, and ESCALOL 507 from Amerchol Corp., ICI Americas, Inc., and Van Dyk, respectively;

octyl methoxycinnamate (2-ethylhexyl-p-methoxycinnamate), e.g., tradename PARSO.sub.—MCS from Bernel Chemical Co., Inc., or Givauden Corp.;

octyl salicylate (2-ethylhexy salicylate), e.g., tradename SUNAROME WMO from Felton Worldwide, Inc.;

PABA (p-amino benzoic add), e.g., tradename PABA from EM Industries, Inc. and National Starch & Chemical Corp., and tradename NIPA PABA from NIPA Laboratories Inc.;

2-phenyl-benzimidazole-5-sulphonic acid (Novantisol), e.g., tradename EUSOLEX 232 and NEO-HELIOPAN HYDRO from EM Industries, Inc. and Haarmann & Reimer Corp., respectively;

TEA salicylate (triethanolamine salicylate), e.g., tradenames SUNADROME W and SUNDROME G from Felton Worldwide, Inc.;

3-(4-methylbenzlidene)camphor or 3-(4-methylbenzylidene)boran-2-one, e.g., tradename EUSOLEX 6300 from EM Industries, Inc.; and

etocrylene (2-ethyl-2-cyano-3,3″-diphenylacrylate), e.g., tradename UVINUL N-35 from BASF Chemical Co.

Representative UVA type suncreening agents suitable for use with the invention include, without limitation, the following:

benzophenone-3 (2-hydroxzy-4-methoxy-benzophenone), e.g., tradename SPECTRA-SORB UV-9 and UVINUL M40 from American Cyanamid Co. and BASF Chemical Co., respectively;

benzophenone-4 (sulisobenzone), e.g., tradename UVINUL MS40 from BASF Chemical Co.;

benzophenone-8 (dioybenzone), e.g., tradename SPECTRA-SORB UV-24 from American Cyanamid Co.;

methyl anthranilate (methyl-O-aminobenzoate), e.g., tradename SUNAROME UVA from Felton Worldwide, Inc.;

benzophenone-1 (2,4,-dihydroxybenzophenone), e.g., tradename UVINUL 400 and UVASORB 20H from BASF Chemical Co. and TRI-K Industries, Inc., respectively;

benzophenone-2 (2,2′,4,4′-tetrahydroxy-benzohpenone), e.g., tradename UVINUL D-50 from BASF Chemical Co.;

benzophenone-6 (2,2′-dihydroxy-4,4′-dimethoxybenzophenoneO, e.g., tradename UVINUL D-49 from BASF Chemical Co.;

benzophenone-12 (octabenzone), e.g., tradename UVINOL 408 from BASF Chemical Co.;

4-isopropyl dibenzoyl methane (1-p-cumenyl-3-phenylpropane-1,3-dione), e.g. tradename EUSOLEX 8020 from EM Industries Inc.; and

butyl methyl dibenzoyl methane (4-t-butyl-4′-methoxydibenzoyl methane), e.g. tradename PARSOL 1789 from Givaudan Corporation.

Physical sunscreening agents may also be added to the composition according to the invention. For example, red petrolatum in amounts of about 30% to about 99% by weight of the total composition, or titanium dioxide in amounts of about 2% to about 25% by weight of the total composition can be used. Talc, kaolin, chalk, and precipitated silica can also be used in effective amounts, e.g., about 1% to about 10% by weight of the total composition.

Additional sunscreening agents according to the invention include lawsone hydroxynaphthoquinone, C10H603 (the coloring matter of henna leaves) with dihydroxy acetone.

In accord with preferred embodiments of the invention, at least one UVA-type or UVB-type sunscreening agent is preferably used in compositions designed to inhibit UV radiation. For example, the following UVB-type sunscreening agents can be used according to the invention: from about 1.5% to about 8.0% by weight of the total composition of octyl dimethyl PABA; octyl para-methoxycinnamate in amounts of about 1.5% to about 7.5% by weight of the total composition; homomethyl salicylate in amounts of about 4.0% to about 15% by weight of the total composition; and octyl salicylate in amounts of about 3% to about 5% by weight of the total composition.

In another embodiment, at least one of the following UVA type sunscreening agents can be added: benzophenone-3 in amounts of about 0.5% to about 6% by weight of the total composition; benzophenone-8 in amounts of about 0.5% to about 3% by weight of the total composition; and menthyl anthanilate in amounts of about 3.5% to about 5.0% by weight of the total composition.

The color indicator compositions according to the invention can be incorporated into formulations such as lotions, creams, gels, mousses, waxed based sticks, aerosols, alcohol sticks and the like. These formulations are well known in the art. For example, information regarding such formulations may be found in (i) Balsam, M. S., and Sagrin, E. (Editors) Cosmetics Science and Technology, Second Edition, Volumes I and 2, Wiley-Interscience, a division of John Wiley & Sons, Inc., New York, copyright 1972; and (ii) Flick, E. W., Cosmetic and Toiletry Formulations, Noyes Publications, 1984, each of which is incorporated herein by reference.

In addition to the UV-blocking additives described above, lotions and/or sunscreens according to the invention can include other compounds, including any of the following: (i) emollients, (ii) emulsifiers, (iii) surfactants, (iv) waxes, (v) thickeners, (vi) film formers, (vii) preservatives, and (viii) perfumes.

Emollients

Emollients may be used according to the invention in amounts which are effective to prevent or relieve dryness. Useful emollients include, without limitation: hydrocarbon oils and waxes; silicone oils; triglyceride esters; acetoglyceride esters; ethoxylated glyceride; alkyl esters; alkenyl esters; fatty acids; fatty alcohols; fatty alcohol ethers; etheresters; lanolin and derivatives; polyhydric alcohols (polyols) and polyether derivatives; polyhydric alcohol (polyol) esters; wax esters; beeswax derivatives; vegetable waxes; phospholipids; sterols; and amides.

Thus, for example, typical emollients include mineral oil, especially mineral oils having a viscosity in the range of 50 to 500 SUS, lanolin oil, mink oil, coconut oil, cocoa butter, olive oil, almond oil, macadamia nut oil, aloa extract, jojoba oil, safflower oil, corn oil, liquid lanolin, cottonseed oil, peanut oil, purcellin oil, perhydrosqualene (squalene), caster oil, polybutene, odorless mineral spirits, sweet almond oil, avocado oil, calophyllum oil, ricin oil, vitamin E acetate, olive oil, mineral spirits, cetearyl alcohol (mixture of fatty alcohols consisting predominantly of cetyl and stearyl alcohols), linolenic alcohol, oleyl alcohol, octyl dodecanol, the oil of cereal germs such as the oil of wheat germ cetearyl octanoate (ester of cetearyl alcohol and 2-ethylhexanoic acid), cetyl palmitate, diisopropyl adipate, isopropyl palmitate, octyl palmitate, isopropyl myristate, butyl myristate, glyceryl stearate, hexadecyl stearate, isocetyl stearate, octyl stearate, octylhydroxy stearate, propylene glycol stearate, butyl stearate, decyl oleate, glyceryl oleate, acetyl glycerides, the octanoates and benzoates of (C12-C5) alcohols, the octanoates and decanoates of alcohols and polyalcohols such as those of glycol and glycerol, and ricin-oleates of alcohols and poly alcohols such as those of isopropyl adipate, hexyl laurate, octyl dodecanoate, dimethicone copolyol, dimethiconol, lanolin, lanolin alcohol, lanolin wax, hydrogenated lanolin, hydroxylated lanolin, acetylated lanolin, petrolatum, isopropyl lanolate, cetyl myristate, glyceryl myristate, myristyl myristate, myristyl lactate, cetyl alcohol, isostearyl alcohol stearyl alcohol, and isocetyl lanolate, and the like.

Emulsifiers

Emulsifiers (i.e., emulsifying agents) are also used in certain aspects of the invention in amounts effective to provide uniform blending of ingredients of the composition. Useful emulsifiers include (i) anionics such as fatty acid soaps, e.g., potassium stearate, sodium stearate, ammonium stearate, and triethanoiamine stearate; polyol fatty acid monoesters containing fatty acid soaps, e.g., glycerol monostearate containing either potassium or sodium salt; sulfuric esters (sodium salts), e.g., sodium lauryl 5 sulfate, and sodium cetyl sulfate; and polyol fatty add monoesters containing sulfuric esters, e.g., glyceryl monostearate containing sodium lauryl sulfate; (ii) cationics chloride such as N(stearoyl colamino formylmethyl) pyridium; N-soya-N-ethyl morpholinium ethosulfate; alkyl dimethyl benzyl ammonium chloride; diisobutylphenoxytheoxyethyl dimethyl benzyl ammonium chloride; and cetyl pyridium chloride; and (iii) nonionics such as polyoxyethylene fatty alcohol ethers, e.g., monostearate; polyoxyethylene lauryl alcohol; polyoxypropylene fatty alcohol ethers, e.g., propoxylated oleyl alcohol; polyoxyethylene fatty acid esters, e.g., polyoxyethylene stearate; polyoxyethylene sorbitan fatty acid esters, e.g., polyoxyethylene sorbitan monostearate; sorbitan fatty acid esters, e.g., sorbitan; polyoxyethylene glycol fatty acid esters, e.g., polyoxyethylene glycol monostearate; and polyol fatty acid esters, e.g., glyceryl monostearate and propylene glycol monostearate; and ethoxylated lanolin derivatives, e.g., ethoxylated lanolins, ethoxylated lanolin alcohols and ethoxylated cholesterol.

Surfactants

Surfactants are also used in certain compositions of the invention. Suitable surfactants may include, for example, those surfactants generally grouped as cleansing agents, emulsifying agents, foam boosters, hydrotropes, solubilizing agents, suspending agents and nonsurfactants (facilitates the dispersion of solids in liquids).

The surfactants are usually classified as amphoteric, anionic, cationic and nonionic surfactants. Amphoteric surfactants include acylamino acids and derivatives and N-alkylamino acids. Anionic surfactants include: acylamino acids and salts, such as, acylglutamates, acylpeptides, acylsarcosinates, and acyltaurates; carboxylic acids and salts, such as, alkanoic adds, ester carboxylic adds, and ether carboxylic acids; sulfonic acids and salts, such as, acyl isethionates, alkylaryl sulfonates, alkyl sulfonates, and sulfosuccinates; sulfuric acid esters, such as, alkyl ether sulfates and alkyl sulfates. Cationic surfactants include: alkylamines, alkyl imidazolines, ethoxylated amines, and quaternaries (such as, alkylbenzyldimethylammonium salts, alkyl betaines, heterocyclic ammonium salts, and tetra alkylammonium salts). And nonionic surfactants include: alcohols, such as primary alcohols containing 8 to 18 carbon atoms; alkanolamides such as alkanolamine derived amides and ethoxylated amides; amine oxides; esters such as ethoxylated carboxylic acids, ethoxylated glycerides, glycol esters and derivatives, monoglycerides, polyglyceryl. esters, polyhydric alcohol esters and ethers, sorbitan/sorbitol esters, and triesters of phosphoric acid; and ethers such as ethoxylated alcohols, ethoxylated lanolin, ethoxylated polysiloxanes, and propoxylated polyoxyethylene ethers.

Waxes

Suitable waxes which are useful in accord with the invention include: animal waxes, such as beeswax, spermaceti, or wool wax (lanolin); plant waxes, such as carnauba or candelilla; mineral waxes, such as montan wax or ozokerite; and petroleum waxes, such as paraffin wax and microcrystalline wax (a high molecular weight petroleum wax). Animal, plant, and some mineral waxes are primarily esters of a high molecular weight fatty alcohol with a high molecular weight fatty acid. For example, the hexadecanoic acid ester of tricontanol is commonly reported to be a major component of beeswax.

Other suitable waxes according to the invention include the synthetic waxes including polyethylene polyoxyethylene and hydrocarbon waxes derived from carbon monoxide and hydrogen.

Representative waxes also include: ceresin; cetyl esters; hydrogenated joioba oil; hydrogenated jojoba wax; hydrogenated rice bran wax; Japan wax; jojoba butter; jojoba oil; jojoba wax; munk wax; montan acid wax; ouricury wax; rice bran wax; shellac wax; sufurized jojoba oil; synthetic beeswax; synthetic jojoba oils; trihydroxystearin; cetyl alcohol; stearyl alcohol; cocoa butter; fatty acids of lanolin; mono-, di- and 25 triglycerides which are solid at 25.degree. C., e.g., glyceyl tribehenate (a triester of behenic acid and glycerine) and C1g-C36 acid triglyceride (a mixture of triesters of C1g-C36 carboxylic acids and glycerine) available from Croda, Inc., New York, N.Y. under the tradenames Syncrowax HRC and Syncrowax HGL-C, respectively; fatty esters which are solid at 25.degree. C.; silicone waxes such as methyloctadecaneoxypolysiloxane and poly (dimethylsiloxy) stearoxysiloxane; stearyl mono- and diethanolarnide; rosin and its derivatives such as the abietates of glycol and glycerol; hydrogenated oils solid at 25.degree. C.; and sucroglycerides. Thickeners (viscosity control agents) which may be used in effective amounts in aqueous systems include: algin; carbomers such as carbomer 934, 934P, 940 and 941; cellulose gum; cetearyl alcohol, cocamide DEA, dsxtrin; gelatin; hydroxyethylcellulose; hydroxypropylcellulose; hydroxypropyl methylcellulose; magnesium aluminum silicate; myristyl alcohol; oat flour; oleamide DEA; oleyl alcohol; PEG-7M; PEG-14M; PEG-90M; stearamide DEA; Stearamide MEA; stearyl alcohol; tragacanth gum; wheat starch; xanthan gum; and the like in the above list of thickeners, DEA is diethanolamine, and MEA is monoethanolamine. Thickeners (viscosity control agents) which may be used in effective amounts in nonaqueous systems include, aluminum stearates; beeswax; candelilla wax; carnauba; ceresin; cetearyl alcohol; cetyl alcohol; cholesterol; hydrated silica; hydrogenated castor oil; hydrogenated cottonseed oil; hydrogenated soybean oil; hydrogenated tallow glyceride; hydrogenated vegetable oil; hydroxypropyl cellulose; lanolin alcohol; myristyl alcohol; octytdodecyl stearoyl sulfate; oleyl alcohol; ozokerite; microcystalline wax; paraffin; pentaerythrityl tetraoctanoate; polyacrylamide; polybutene; polyethylene; propylene glycol dicaprylate; propylene glycol dipelargonate; stearalkonium hectorite; stearyl alcohol; stearyl stearate; synthetic beeswax; trihydroxystearin; trilinolein; tristearin; zinc stearate; and the like.

Film Formers

Suitable film formers which are used in accord with the invention keep the composition smooth and even and include, without limitation: acrylamide/sodium acrylate copolymer; ammonium acrylates copolymer; Balsam Peru; cellulose gum; ethylene/maleic anhydride copolymer; hydroxyethylcellulose; hydroxypropylcellulose; polyacrylamide; polyethylene; polyvinyl alcohol; pvm/MA copolymer (polyvinyl methylether/maleic anhydride); PVP (polyvinylpyrrolidone); maleic anhydride copolymer such as PA-18 available from Gulf Science and Technology; PVP/hexadecene copolymer such as Ganex V-216 available from GAF Corporation; acryliclacrylate copolymer; and the like.

Generally, film formers can be used in amounts of about 0.1% to about 10% by weight of the total composition with about 1% to about 8% being preferred and about 0.1.degree./O to about 5% being most preferred. Humectants can also be used in effective amounts, including: fructose; glucose; glulamic acid; glycerin; honey; maltitol; methyl gluceth-10; methyl gluceth-20; propylene glycol; sodium lactate; sucrose; and the like.

Preservatives

Preservatives according to certain compositions of the invention include, without limitation: butylparaben; ethylparaben; imidazolidinyl urea; methylparaben; O-phenylphenol; propylparaben; quatemium-14; quatemium-15; sodium dehydroacetate; zinc pyrithione; and the like.

The preservatives are used in amounts effective to prevent or retard microbial growth. Generally, the preservatives are used in amounts of about 0. 1% to about 1% by weight of the total composition with about 0.1% to about 0.8% being preferred and about 0.1% to about 0.5% being most preferred.

Perfumes

Perfumes (fragrance components) and colorants (coloring agents) well known to those skilled in the art may be used in effective amounts to impart. the desired fragrance and color to the compositions of the invention.

Other ingredients which can be added or used in amounts effective for their intended use, including: biological additives to enhance performance or consumer appeal such as amino adds, proteins, vanilla, aloe extract, bioflavinoids, and the like;: buffering agents, chelating agents such as EDTA; emulsion stabilizers; pH adjusters;. opacifying agents; and propellants such as butane carbon dioxide, ethane, hydrochlorofluorocarbons 22 and 142b, hydrofluorocarbon 152a, isobutane, isopentane, nitrogen, nitrous oxide, pentane, propane, and the like.

The ingredients described above—sunscreening agents, emollients, emulsifiers, surfactants, solvents for sunscreening agents, waxes, thickeners, film formers, humectants, preservatives, surfactants, perfumes, coloring agents, biological additives, buffering agents, chelating agents, emulsion stabilizers, opacifying agents, pH adjusters, and propellants—are well known to those skilled in the art. The determination of which ingredients to use to obtain the intended formulations, and the determination of the amounts which may be used to achieve the intended functions and effects of these ingredients are well within the capabilities of those skilled in the art without the need for undue experimentation. Further information may be obtained on these ingredients, for example, by reference to: Cosmetics & Toiletries, Vol. 102, No. 3, March 1987; Balsam, M. S., et al., editors, Cosmetics Science and Technology, 2nd edition, Vol. 1, pp 27-104 and 179-222 Wiley-Interscience, New York, 1972; Cosmetics & Toiletries, Vol. 104, pp 67-111, February 1989; Cosmetics & Toiletries, Vol. 103, No. 12, pp 100-129, December 1988; Nikitakis, J. M., editor, CTFA Cosmetic Ingredient Handbrook, First Edition, published by The Cosmetic, Toiletry and Fragrance Association, Inc., Washington, D.C., 1988; Mukhtar, H, editor, Pharmacology of the Skin, CRC Press 1992; and Green; F J, The Sigma-Aldrich Handbook of Stains, Dyes and Indicators., Aldrich Chemical Company, Milwaukee Wis., 1991.

Acid-Base Indicators

Representative examples of acid-base indicators useful in the compositions and articles of the present invention include, but are not limited to, picric acid, matius yellow, 2,6-dinitrophenol, 2,4-dinitrophenol, phenacetolin, 2,5-dinitrophenol, isopicramic acid, o-nitrophenol, m-nitrophenol, p-nitrophenol, 6,8-dinitro-2,4-(1H,3H)quinazolinedione, nitroamine, ethyl bis(2,4-dinitrophenyl)-acetate, 2,4,6-trinitrotoluene, 1,3,5-trinitrobenzene, 2,4,6-tribromobenzoic acid, 2-(p-dimethylaminophenyl)azopyridine, metanil yellow, p-methyl red, 4-phenylazodiphenylamine, benzopurpurin 4B, tropaeolin OO fast garnet GBC base, alizarin yellow R, benzyl orange, m-methyl red, 4-(m-tolyl)-azo-N,N-dimethyl-aniline, oil yellow II, methyl orange, ethyl orange, hessian purple N, congo red, N-pnehyl-1-naphthyl-aminoazobenzene-p-sulfonic acid, 4-(4′-dimethylamino-1′-naphthyl)-azo-3-methoxy-benzenesulfonic acid, p-ethoxychrysoidine, α-naphthyl red, chrysoidine, 1-naphthylaminoazobenzene-p-sulfonic acid, methyl red, 2-(p-dimethylaminophenyl)-azopyridine, ethyl red, propyl red, N-phenyl-1-naphthyl-aminoazo-o-carboxybenzene, nitrazol yellow, brilliant yellow, brilliant yellow S, orange II, propyl-o-naphthyl orange, orange I, orange IV, hessian, Bordeaux, diazo violet, α-naphthol violet, alizarin yellow GG, chrome orange GR, sulfone acid blue R, lanacyl violet BF, tropaeolin O, orange G, crystal violet, methyl violet B, malachite green, brilliant green, ethyl violet, methyl violet 6B, ethyl/methyl green, basic fuchsine, acid, fuchsine, patent blue V, alkali blue, aniline blue, o-naphthol benzein, pentamethoxy red, hexamethoxy red, tetrabromophenolphthalein ethyl ester K salt, tetraiodophenolsulfophthlein, bromochlorophenol blue, bromocresol green, chlorocresol green, chlorophenol red, bromocresol purple, sulfonaphthyl red, bromophenol red, dibromophenol-tetrabromophenol-sulfophthlein, bromothymol blue, aurin, phenol red, o-cresol benzein, o-cresol red, α-naphtholphthlein, m-cresol purple, p-xylenol blue, thymol blue, phenoltetrachlorophthlein, o-cresolphthalein, α-naphtholbenzein, phenoltetraiodophthlein, phenolphthalein, thymolphthlein, eosin Y, erythrosine B, erythrosine, galleon, brilliant cresyl blue, resazurin, lacmoid, litmus, azolitmus, azolitmin, neutral red, nile blue 2B, nile blue A, hematoxylin, quinaldine red, pinachrome, indo-oxine, quinoline blue, bis-5-bromovanillidenecyclohexanone, bis-(2′-hydroxystyryl)ketone, curcumin, bis-(4-hydroxy-3-ethoxy-benzylidene)-cyclohexanone, thiazole yellow G, alizarin blue B, alizarin red S, carminic acid, alizarin orange, alizarin, rufianic acid, rufianic blue, alizarin blue SWR, and indigocarmine.

With the suitable selection of acid-base indicators, it is possible to produce any color. The acid-base indicators are preferably in the form of a salt, such as a sodium salt generated by reacting the indicator with sodium hydroxide, so as to permit its solubilization into the present composition. Additionally, combinations of two or more indicators may be used.

Acid-base indicators are usually effective when present in small amounts in the compositions of the invention but generally are present in amounts from about 0.01% up to about 20% by weight, from about 0.5% to about 10% by weight and from about 0.8% to about 8% by weight of the total weight of the composition.

Selection of an appropriate basic material is important for color change of acidic dye indicators in the colored compositions of the present invention. Desirable basic reagents, which should readily volatilize at ambient temperatures for use in the present compositions, include, but are not limited to, aminoalcohols, such as alkylamines, such as methylamine, dimethylamine, ethylamine, diethylamine, triethylamine, ethyleneamine, diethyleneamine, morpholine, ammonia, triethanolamine.

The selection of the kind and the amount of basic reagent used enables control of fading time of the color after application. Suitable basic reagents which readily volatilize at ambient temperatures, typically have a vapor pressure higher than about 10 mm Hg at 20° C. The selection of the base also depends on solubility in water, toxicity and odor. Therefore, aminoalcohols useful in the compositions of the present invention include, but are not limited to triethanolamine (TEA) and/or diethylamine. TEA, for example, is clear, non-toxic and does not emit a noxious odor.

The basic reagent(s) is generally present in the composition of the invention in an amount from about 0.01% up to about 20% by weight, from about 0.2% to about I0% by weight and from about 0.5% to about 5% by weight.

It should be understood that the term “comprising” (or comprises) includes the more restrictive terms consisting of and consisting essentially of.

Particular phthaleins useful in the invention have the formula (I):

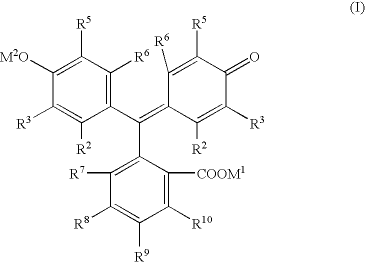

wherein R², R³, R⁵, R⁶, R⁷, R⁸, R⁹ and R¹⁰ are each, independently of one another, selected from the group consisting of hydrogen, —OH, —SH, —CN, —NO₂, halo, fluoro, chloro, bromo, iodo, lower alkyl, substituted lower alkyl, lower heteroalkyl, substituted lower heteroalkyl, cycloalkyl, substituted cycloalkyl, cycloheteroalkyl, substituted cycloheteroalkyl, lower haloalkyl, monohalomethyl, dihalomethyl, trihalomethyl, trifluoromethyl, lower alkylthio, substituted lower alkylthio, lower alkoxy, substituted lower alkoxy, methoxy, substituted methoxy, lower heteroalkoxy, substituted lower heteroalkoxy, cycloalkoxy, substituted cycloalkoxy, cycloheteroalkoxy, substituted cycloheteroalkoxy, lower haloalkoxy, monohalomethoxy, dihalomethoxy, trihalomethoxy, trifluoromethoxy, amino, lower di- or monoalkylamino, substituted lower di- or monoalkylamino, aryl, substituted aryl, aryloxy, substituted aryloxy, phenoxy, substituted phenoxy, arylalkyl, substituted arylalkyl, arylalkyloxy, substituted arylalkyloxy, benzyl, benzyloxy, heteroaryl, substituted heteroaryl, heteroaryloxy, substituted heteroaryloxy, heteroarylalkyl, substituted heteroarylalkyl, heteroarylalkyloxy, substituted heteroarylalkyloxy, carboxyl, lower alkoxycarbonyl, substituted lower alkoxycarbonyl, aryloxycarbonyl, substituted aryloxycarbonyl, arylalkyloxycarbonyl, substituted arylalkyloxycarbonyl, carbamate, substituted carbamate, carbamoyl, substituted carbamoyl, sulfamoyl or substituted sulfamoyl.

Alternatively, R² and R³, R⁵ and R⁶ or R² and R³, and R⁵ and R⁶ can form cyclic ring structures that are heterocyclic, heteroaromatic, aromatic or nonaromatic and can contain one or more heteroatoms to form, for example, a quinoline, napthalene, etc.

Additionally, R⁷ and R⁸, R⁸ and R⁹, R⁹ and R¹⁰ or combinations thereof can form cyclic ring structures that are heterocyclic, heteroaromatic, aromatic or nonaromatic and can contain one or more heteroatoms to form, for example, a quinoline, napthalene, etc.

Optionally, one of the carbons connected to R², R³, R⁵ or R⁶ can be substituted with a nitrogen atom.

M¹ and M² are each independently a hydrogen atom, a metal ion or an ammonium ion.

In certain aspects, compounds are excluded where R², R³, R⁵, R⁶, R⁷, R⁸, R⁹ and R¹⁰ are all hydrogen atoms, or where R² is hydrogen, R³is Me, and R⁵, R⁶, R⁷, R⁸, R⁹ and R¹⁰ are all hydrogen atoms, or where R² is Me, R³is a hydrogen atom, R⁵ is an iso-propyl group and R⁶, R⁷, R⁸, R⁹ and R¹⁰ are all hydrogen atoms.

In certain embodiments, R² is selected from the group consisting of hydrogen, nitro, amino and alkyl; R³ is selected from the group consisting of hydrogen, phenyl, alkyl, nitro, acetamido and alkoxy; R⁵ is selected from the group consisting of hydrogen, halo, and alkyl; and R⁶ is selected from the group consisting of hydrogen and alkyl.

In certain other embodiments, R² is selected from the group consisting of hydrogen and methyl; R³ is selected from the group consisting of hydrogen, phenyl, isopropyl, methyl, ethyl, sec-butyl, nitro and methoxy; R⁵ is selected from the group consisting of hydrogen, bromo, methoxy, isopropyl and methyl; and R⁶ is selected from the group consisting of hydrogen and methyl.

In other embodiments, R², R³, R⁵, R⁶, R⁷, R⁸, R⁹ and R¹⁰ are all hydrogen atoms, or R² is hydrogen, R³ is Me, and R⁵, R⁶, R⁷, R⁸, R⁹ and R¹⁰ are all hydrogen atoms, or R² is Me, R³ is a hydrogen atom, R⁵ is an iso-propyl group and R⁶, R⁷, R⁸, R⁹ and R¹⁰ are all hydrogen atoms, or R² is H, R³ is Me, R⁵ is Br and R⁶, R⁷, R⁸, R⁹ and R¹⁰ are all hydrogen atoms, or R² is Me, R³is Br, R⁵is an isopropyl and R⁶, R⁷, R⁸, R⁹ and R¹⁰ are all hydrogen atoms. In certain embodiments, one or more of these compounds may be excluded from certain aspects of the invention.

In still other embodiments, R² is H, R³ is phenyl and R⁵, R⁶, R⁷, R⁸, R⁹ and R¹⁰ are all hydrogen atoms, or R² is H, R³ and R⁵ are isopropyl and R⁶, R⁷, R⁸, R⁹ and R¹⁰ are all hydrogen atoms, or R² is H, R³is methyl, R⁵ is H, R⁶is methyl, R⁷, R⁸, R⁹ and R¹⁰ are all hydrogen atoms, or R² is H, R³ and R⁵ are methoxy and R⁶, R⁷, R⁸, R⁹ and R¹⁰ are all hydrogen atoms, or R² is H, R³ and R⁵ are methyl and R⁶, R⁷, R⁸, R⁹ and R¹⁰ are all hydrogen atoms, or R²is H, R³is ethyl and R⁵, R⁶, R⁷, R⁸, R⁹ and R¹⁰ are all hydrogen atoms, or R² is H, R³ is isopropyl and R⁵, R⁶, R⁷, R⁸, R⁹ and R¹⁰ are all hydrogen atoms, or R²is H, R³ is methoxide and R⁵, R⁶, R⁷, R⁸, R⁹ and R¹⁰ are all hydrogen atoms, or and R², R³ and R⁵ are all methyl and R⁶, R⁷, R⁸, R⁹ and R¹⁰ are all hydrogen atoms, or R², R³, R⁵, R⁶, R⁷, R⁸, R⁹, R¹⁰ are all hydrogen atoms and R³is sec-butyl, or R², R³, R⁵, R⁶, R⁷, R⁸, R⁹, R¹⁰ are all hydrogen atoms and R³ is nitro.

In particular, at least one of M¹ or M² is a metal or an ammonium ion.

It should be understood, that the salt form of the indicator can be isolated prior to use or prepared in situ. Ideally, the salt is formed as a mono-salt or a di-salt, meaning that excess base is not present and either 1 or 2 equivalents of base react with the acidic protons of the indicator.

In another particular aspect, especially where a color change from clear to colored is desired (wet wipes, mops and diapers for example), then M¹ and M² are hydrogen atoms.

The following table provides phthaleins of particular interest.

| R² | R³ | R⁵ | R⁶ | Color |
|---|---|---|---|---|
| H | phenyl | H | H | purple |
| H | i-propyl | i-propyl | H | violet |
| H | Me | H | Me | blue |
| H | OMe | OMe | H | teal |
| H | Me | Me | H | purple |
| H | Et | H | H | magenta |
| H | i-propyl | H | H | pink |
| H | OMe | H | H | blue |
| Me | Me | Me | H | teal |
| H | Me | H | H | magenta |
| H | i-propyl | H | Me | blue |
| H | Me | Br | H | purple |
| H | i-propyl | Br | Me | teal |
| H | sec-butyl | H | H | pink |
| H | NO₂ | H | H | yellow |

In another aspect, the acid-base indicator can be a substituted phenol of formula (II):

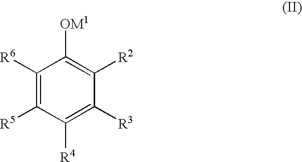

wherein R², R³, R⁵, R⁶ and M¹ are as defined above and R⁴ is selected from the same group as R², R³, R⁵ and R⁶.

Alternatively, R² and R³, R³ and R⁴, R⁴ and R⁵, or R⁵ and R⁶ can form cyclic ring structures that are heterocyclic, heteroaromatic, aromatic or nonaromatic and can contain one or more heteroatoms to form, for example, a quinoline, napthalene, etc.

In one aspect, one or more of R² through R⁶, independently, is a nitro (—NO₂) group and the remaining R groups are selected from those provided above.

Additionally, substituted hydrazides are useful in the compositions of the invention and can have one of two formulae:

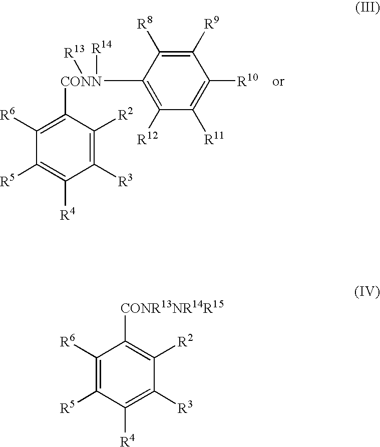

wherein R² through R⁶ are as defined above and R⁸ through R¹² are the same substituents as R² through R⁶. R¹³, R¹⁴ and R¹⁵ (if present) are each, independently of one another, a hydrogen atom, an alkyl group, a substituted alkyl group, any aryl group or a substituted aryl group.

In certain embodiments for compound formulae (II), R¹³ and R1¹⁴ are hydrogen atoms and for compound formulae (III), R¹³, R¹⁴ and R¹⁵ are all hydrogen atoms.

In certain aspects, compounds of formulae (III) can have one or more hydroxyl groups, which can be deprotonated to form a salt. For example, formulae (IIIa) provides one isomer where a hydroxyl is present at the R² position as a salt. M² is as defined above for M¹. It should be understood that one or more of R² through R¹² could have a hydroxyl at that given position, and that hydroxyl could be in a salt form.

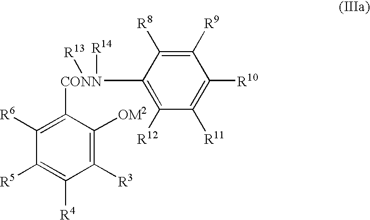

“Alkyl,” by itself or as part of another substituent, refers to a saturated or unsaturated, branched, straight-chain or cyclic monovalent hydrocarbon radical derived by the removal of one hydrogen atom from a single carbon atom of a parent alkane, alkene or alkyne. Typical alkyl groups include, but are not limited to, methyl; ethyls such as ethanyl, ethenyl, ethynyl; propyls such as propan-1-yl, propan-2-yl, cyclopropan-1-yl, prop-1-en-1-yl, prop-1-en-2-yl, prop-2-en-1-yl (allyl), cycloprop-1-en-1-yl; cycloprop-2-en-1-yl, prop-1-yn-1-yl , prop-2-yn-1-yl, etc.; butyls such as butan-1-yl, butan-2-yl, 2-methyl-propan-1-yl, 2-methyl-propan-2-yl, cyclobutan-1-yl, but-1-en-1-yl, but-1-en-2-yl, 2-methyl-prop-1-en-1-yl, but-2-en-1-yl , but-2-en-2-yl, buta-1,3-dien-1-yl, buta-1,3-dien-2-yl, cyclobut-1-en-1-yl, cyclobut-1-en-3-yl, cyclobuta-1,3-dien-1-yl, but-1-yn-1-yl, but-1-yn-3-yl, but-3-yn-1-yl, etc.; and the like.

The term “alkyl” is specifically intended to include groups having any degree or level of saturation, i.e., groups having exclusively single carbon-carbon bonds, groups having one or more double carbon-carbon bonds, groups having one or more triple carbon-carbon bonds and groups having mixtures of single, double and triple carbon-carbon bonds. Where a specific level of saturation is intended, the expressions “alkanyl,” “alkenyl,” and “alkynyl” are used. Preferably, an alkyl group comprises from 1 to 15 carbon atoms (C₁-C₁₅ alkyl), more preferably from 1 to 10 carbon atoms (C₁-C₁₀ alkyl) and even more preferably from 1 to 6 carbon atoms (C₁-C₆ alkyl or lower alkyl).

“Alkanyl,” by itself or as part of another substituent, refers to a saturated branched, straight-chain or cyclic alkyl radical derived by the removal of one hydrogen atom from a single carbon atom of a parent alkane. Typical alkanyl groups include, but are not limited to, methanyl; ethanyl; propanyls such as propan-1-yl, propan-2-yl(isopropyl), cyclopropan-1-yl, etc.; butanyls such as butan-1-yl, butan-2-yl(sec-butyl), 2-methyl-propan-1-yl (isobutyl), 2-methyl-propan-2-yl (t-butyl), cyclobutan-1-yl, etc.; and the like.

“Alkenyl,” by itself or as part of another substituent, refers to an unsaturated branched, straight-chain or cyclic alkyl radical having at least one carbon-carbon double bond derived by the removal of one hydrogen atom from a single carbon atom of a parent alkene. The group may be in either the cis or trans conformation about the double bond(s). Typical alkenyl groups include, but are not limited to, ethenyl; propenyls such as prop-1-en-1-yl , prop-1-en-2-yl, prop-2-en-1-yl(allyl), prop-2-en-2-yl, cycloprop-1-en-1-yl; cycloprop-2-en-1-yl; butenyls such as but-1-en-1-yl, but-1-en-2-yl, 2-methyl-prop-1-en-1-yl, but-2-en-1-yl , but-2-en-1-yl, but-2-en-2-yl, buta-l ,3-dien-1-yl, buta-1,3-dien-2-yl, cyclobut-1-en-1-yl, cyclobut-1-en-3-yl, cyclobuta-1,3-dien-1-yl, etc.; and the like.

“Alkynyl,” by itself or as part of another substituent refers to an unsaturated branched, straight-chain or cyclic alkyl radical having at least one carbon-carbon triple bond derived by the removal of one hydrogen atom from a single carbon atom of a parent alkyne. Typical alkynyl groups include, but are not limited to, ethynyl; propenyls such as prop-1-yn-1-yl, prop-2-yn-1-yl, etc.; butenyls such as but-1-yn-1-yl, but-1-yn-3-yl, but-3-yn-1-yl, etc.; and the like.

“Alkylnyl” by itself or as part of another substituent refers to a saturated or unsaturated, branched, straight-chain or cyclic divalent hydrocarbon group derived by the removal of one hydrogen atom from each of two different carbon atoms of a parent alkane, alkene or alkyne, or by the removal of two hydrogen atoms from a single carbon atom of a parent alkane, alkene or alkyne. The two monovalent radical centers or each valency of the divalent radical center can form bonds with the same or different atoms. Typical alkyldiyl groups include, but are not limited to, methandiyl; ethyldiyls such as ethan-1,1-diyl, ethan-1,2-diyl, ethen-1,1-diyl, ethen-1,2-diyl; propyldiyls such as propan-1,1-diyl, propan-1,2-diyl, propan-2,2-diyl, propan-1,3-diyl, cyclopropan-1,1-diyl, cyclopropan-1,2-diyl, prop-1-en-1,1-diyl, prop-1-en-1,2-diyl, prop-2-en-1,2-diyl, prop-1-en-1,3-diyl, cycloprop-1-en-1,2-diyl, cycloprop-2-en-1,2-diyl, cycloprop-2-en-1,1-diyl, prop-1-yn-1,3-diyl, etc.; butyldiyls such as, butan-1,1-diyl, butan-1,2-diyl, butan-1,3-diyl, butan-1,4-diyl, butan-2,2-diyl, 2-methyl-propan-1,1-diyl, 2-methyl-propan-1,2-diyl, cyclobutan-1,1-diyl; cyclobutan-1,2-diyl, cyclobutan-1,3-diyl, but-1-en-1,1-diyl, but-1-en-1,2-diyl, but-1-en-1,3-diyl, but-1-en-1,4-diyl, 2-methyl-prop-1-en-1,1-diyl, 2-methanylidene-propan-1,1-diyl, buta-1,3-dien-1,1-diyl, buta-1,3-dien-1,2-diyl, buta-1,3-dien-1,3-diyl, buta-1,3-dien-1,4-diyl, cyclobut-1-en-1,2-diyl, cyclobut-1-en-1,3-diyl, cyclobut-2-en-1,2-diyl, cyclobuta-1,3-dien-1,2-diyl, cyclobuta-1,3-dien-1,3-diyl, but-1-yn-1,3-diyl, but-1-yn-1,4-diyl, buta-1,3-diyn-1,4-diyl, etc.; and the like. Where specific levels of saturation are intended, the nomenclature alkanyldiyl, alkenyldiyl and/or alkynyldiyl is used. Where it is specifically intended that the two valencies are on the same carbon atom, the nomenclature “alkylidene” is used. In preferred embodiments, the alkyldiyl group comprises from 1 to 6 carbon atoms (C1-C6 alkyldiyl). Also preferred are saturated acyclic alkanyldiyl groups in which the radical centers are at the terminal carbons, e.g., methandiyl (methano); ethan-1,2-diyl (ethano); propan-1,3-diyl (propano); butan-1,4-diyl (butano); and the like (also referred to as alkylenos, defined infra).

“Alkyleno,” by itself or as part of another substituent, refers to a straight-chain saturated or unsaturated alkyldiyl group having two terminal monovalent radical centers derived by the removal of one hydrogen atom from each of the two terminal carbon atoms of straight-chain parent alkane, alkene or alkyne. The locant of a double bond or triple bond, if present, in a particular alkyleno is indicated in square brackets. Typical alkyleno groups include, but are not limited to, methano; ethylenos such as ethano, etheno, ethyno; propylenos such as propano, prop[1]eno, propa[1,2]dieno, prop[1]yno, etc.; butylenos such as butano, but[1]eno, but[2]eno, buta[1,3]dieno, but[1]yno, but[2]yno, buta[1,3]diyno, etc.; and the like. Where specific levels of saturation are intended, the nomenclature alkano, alkeno and/or alkyno is used. In preferred embodiments, the alkyleno group is (C1-C6) or (C1-C3) alkyleno. Also preferred are straight-chain saturated alkano groups, e.g., methano, ethano, propano, butano, and the like.

“Alkoxy,” by itself or as part of another substituent, refers to a radical of the formula —OR, where R is an alkyl or cycloalkyl group as defined herein. Representative examples alkoxy groups include, but are not limited to, methoxy, ethoxy, propoxy, isopropoxy, butoxy, tert-butoxy, cyclopropyloxy, cyclopentyloxy, cyclohexyloxy and the like.

“Alkoxycarbonyl,” by itself or as part of another substituent, refers to a radical of the formula —C(O)-alkoxy, where alkoxy is as defined herein.

“Alkylthio,” by itself or as part of another substituent, refers to a radical of the formula —SR, where R is an alkyl or cycloalkyl group as defined herein. Representative examples of Alkylthio groups include, but are not limited to, methylthio, ethylthio, propylthio, isopropylthio, butylthio tert-butylthio, cyclopropylthio, cyclopentylthio, cyclohexylthio, and the like.

“Aryl,” by itself or as part of another substituent, refers to a monovalent aromatic hydrocarbon group derived by the removal of one hydrogen atom from a single carbon atom of a parent aromatic ring system, as defined herein. Typical aryl groups include, but are not limited to, groups derived from aceanthrylene, acenaphthylene, acephenanthrylene, anthracene, azulene, benzene, chrysene, coronene, fluoranthene, fluorene, hexacene, hexaphene, hexalene, as-indacene, s-indacene, indane, indene, naphthalene, octacene, octaphene, octalene, ovalene, penta-2,4-diene, pentacene, pentalene, pentaphene, perylene, phenalene, phenanthrene, picene, pleiadene, pyrene, pyranthrene, rubicene, triphenylene, trinaphthalene and the like. Preferably, an aryl group comprises from 6 to 20 carbon atoms (C₆-C₂₀ aryl), more preferably from 6 to 15 carbon atoms (C₆-C₁₅ aryl) and even more preferably from 6 to 10 carbon atoms (C₆-C₁₀ aryl).

“Arylalkyl,” by itself or as part of another substituent, refers to an acyclic alkyl group in which one of the hydrogen atoms bonded to a carbon atom, typically a terminal or sp³ carbon atom, is replaced with an aryl group as, as defined herein. Typical arylalkyl groups include, but are not limited to, benzyl, 2-phenylethan-1-yl, 2-phenylethen-1-yl, naphthylmethyl, 2-naphthylethan-1-yl, 2-naphthylethen-1-yl, naphthobenzyl, 2-naphthophenylethan-1-yl and the like. Where specific alkyl moieties are intended, the nomenclature arylalkanyl, arylalkenyl and/or arylalkynyl is used. Preferably, an arylalkyl group is (C₆-C₃₀) arylalkyl, e.g., the alkanyl, alkenyl or alkynyl moiety of the arylalkyl group is (C₁-C₁₀) alkyl and the aryl moiety is (C₆-C₂₀) aryl, more preferably, an arylalkyl group is (C₆-C₂₀) arylalkyl, e.g., the alkanyl, alkenyl or alkynyl moiety of the arylalkyl group is (C₁-C₈) alkyl and the aryl moiety is (C₆-C₁₂) aryl, and even more preferably, an arylalkyl group is (C₆-C₁₅) arylalkyl, e.g., the alkanyl, alkenyl or alkynyl moiety of the arylalkyl group is (C₁-C₅) alkyl and the aryl moiety is (C₆-C₁₀) aryl.

“Aryloxy,” by itself or as part of another substituent, refers to a radical of the formula —O-aryl, where aryl is as defined herein.

“Arylalkyloxy by itself or as part of another substituent, refers to a radical of the formula —O-arylalkyl, where arylalkyl is as defined herein.

“Aryloxycarbonyl,” by itself or as part of another substituent, refers to a radical of the formula —C(O)—O-aryl, where aryl is as defined herein.

“Carbamoyl,” by itself or as part of another substituent, refers to a radical of the formula —C(O)NR′R″, where R′ and R″ are each, independently of one another, selected from the group consisting of hydrogen, alkyl and cycloalkyl as defined herein, or alternatively, R′ and R″, taken together with the nitrogen atom to which they are bonded, form a 5-, 6- or 7-membered cycloheteroalkyl ring as defined herein, which may optionally include from 1 to 4 of the same or different additional heteroatoms selected from the group consisting of O, S and N.

“Compounds of the invention” refers to compounds encompassed by the various descriptions and structural formulae disclosed herein. The compounds of the invention may be identified by either their chemical structure and/or chemical name. When the chemical structure and chemical name conflict, the chemical structure is determinative of the identity of the compound. The compounds of the invention may contain one or more chiral centers and/or double bonds and therefore may exist as stereoisomers, such as double-bond isomers (i.e., geometric isomers), rotamers, enantiomers or diastereomers. Accordingly, when stereochemistry at chiral centers is not specified, the chemical structures depicted herein encompass all possible configurations at those chiral centers including the stereoisomerically pure form (e.g., geometrically pure, enantiomerically pure or diastereomerically pure) and enantiomeric and stereoisomeric mixtures. Enantiomeric and stereoisomeric mixtures can be resolved into their component enantiomers or stereoisomers using separation techniques or chiral synthesis techniques well known to the skilled artisan. The compounds of the invention may also exist in several tautomeric forms including the enol form, the keto form and mixtures thereof. Accordingly, the chemical structures depicted herein encompass all possible tautomeric forms of the illustrated compounds. The compounds of the invention may also include isotopically labeled compounds where one or more atoms have an atomic mass different from the atomic mass conventionally found in nature. Examples of isotopes that may be incorporated into the compounds of the invention include, but are not limited to, ²H, ³H, ¹¹C, ¹³C, ¹⁴C, ¹⁵N, ¹⁸O, ¹⁷O, ³¹P, ³²P, ³⁵S, ¹⁸F and ³⁶Cl. Compounds of the invention may exist in unsolvated forms as well as solvated forms, including hydrated forms and as N-oxides. In general, the hydrated, solvated and N-oxide forms are within the scope of the present invention. Certain compounds of the present invention may exist in multiple crystalline or amorphous forms. In general, all physical forms are equivalent for the uses contemplated by the present invention and are intended to be within the scope of the present invention.

“Cycloalkyl,” by itself or as part of another substituent, refers to a saturated or unsaturated cyclic alkyl radical, as defined herein. Where a specific level of saturation is intended, the nomenclature “cycloalkanyl” or “cycloalkenyl” is used. Typical cycloalkyl groups include, but are not limited to, groups derived from cyclopropane, cyclobutane, cyclopentane, cyclohexane, and the like. Preferably, the cycloalkyl group comprises from 3 to 10 ring atoms (C₃-C₁₀ cycloalkyl) and more preferably from 3 to 7 ring atoms (C₃-C₇ cycloalkyl).

“Cycloheteroalkyl,” by itself or as part of another substituent, refers to a saturated or unsaturated cyclic alkyl radical in which one or more carbon atoms (and optionally any associated hydrogen atoms) are independently replaced with the same or different heteroatom. Typical heteroatoms to replace the carbon atom(s) include, but are not limited to, N, P, O, S, Si, etc. Where a specific level of saturation is intended, the nomenclature “cycloheteroalkanyl” or “cycloheteroalkenyl” is used. Typical cycloheteroalkyl groups include, but are not limited to, groups derived from epoxides, azirines, thiiranes, imidazolidine, morpholine, piperazine, piperidine, pyrazolidine, pyrrolidone, quinuclidine, and the like. Preferably, the cycloheteroalkyl group comprises from 3 to 10 ring atoms (3-10 membered cycloheteroalkyl) and more preferably from 5 to 7 ring atoms (5-7 membered cycloheteroalkyl).

A cycloheteroalkyl group may be substituted at a heteroatom, for example, a nitrogen atom, with a lower alkyl group. As specific examples, N-methyl-imidazolidinyl, N-methyl-morpholinyl, N-methyl-piperazinyl, N-methyl-piperidinyl, N-methyl-pyrazolidinyl and N-methyl-pyrrolidinyl are included within the definition of “cycloheteroalkyl.” A cycloheteralkyl group may be attached to the remainder of the molecule via a ring carbon atom or a ring heteroatom.

“Dialkylamino” or “Monoalkylamino,” by themselves or as part of other substituents, refer to radicals of the formula —NRR and —NHR, respectively, where each R is independently selected from the group consisting of alkyl and cycloalkyl, as defined herein. Representative examples of dialkylamino groups include, but are not limited to, dimethylamino, methylethylamino, di-(1-methylethyl)amino, (cyclohexyl)(methyl)amino, (cyclohexyl)(ethyl)amino, (cyclohexyl)(propyl)amino and the like. Representative examples of monalkylamino groups include, but are not limited to, methylamino, ethylamino, propylamino, isopropylamino, cyclohexylamino, and the like.

“Halogen” or “Halo,” by themselves or as part of another substituent, refer to a fluoro, chloro, bromo and/or iodo radical.

“Haloalkyl,” by itself or as part of another substituent, refers to an alkyl group as defined herein in which one or more of the hydrogen atoms is replaced with a halo group. The term “haloalkyl” is specifically meant to include monohaloalkyls, dihaloalkyls, trihaloalkyls, etc. up to perhaloalkyls. The halo groups substituting a haloalkyl can be the same, or they can be different. For example, the expression “(C₁-C₂) haloalkyl” includes 1-fluoromethyl, 1-fluoro-2-chloroethyl, difluoromethyl, trifluoromethyl, 1-fluoroethyl, 1,1-difluoroethyl, 1,2-difluoroethyl, 1,1,1-trifluoroethyl, perfluoroethyl, etc.“Haloalkyloxy,” by itself or as part of another substituent, refers to a group of the formula —O-haloalkyl, where haloalkyl is as defined herein.

“Heteroalkyl,” “Heteroalkanyl,” “Heteroalkenyl,” “Heteroalkynyl,” “Heteroalkyldiyl” and “Heteroalkyleno,” by themselves or as part of other substituents, refer to alkyl, alkanyl, alkenyl, alkynyl, alkyldiyl and alkyleno groups, respectively, in which one or more of the carbon atoms (and optionally any associated hydrogen atoms), are each, independently of one another, replaced with the same or different heteroatoms or heteroatomic groups. Typical heteroatoms or heteroatomic groups which can replace the carbon atoms include, but are not limited to, O, S, N, Si, —NH—, —S(O)—, —S(O)₂—, —S(O)NH—, —S(O)₂NH— and the like and combinations thereof. The heteroatoms or heteroatomic groups may be placed at any interior position of the alkyl, alkenyl or alkynyl groups. Examples of such heteroalkyl, heteroalkanyl, heteroalkenyl and/or heteroalkynyl groups include —CH₂—CH₂—O—CH₃, —CH₂—CH₂—NH—CH₃, —CH₂—CH₂—N(CH₃)—CH₃, —CH₂—S—CH₂,—CH₃, —CH₂—CH₂—S(O)—CH₃, —CH₂—CH₂—S(O)₂—CH₃, —CH═CH—O—CH₃, —CH₂—CH═N—O—CH₃, and —CH₂—CH₂—O—C═CH. For heteroalkyldiyl and heteroalkyleno groups, the heteratom or heteratomic group can also occupy either or both chain termini. For such groups, no orientation of the group is implied.

“Heteroaryl,” by itself or as part of another substituent, refers to a monovalent heteroaromatic radical derived by the removal of one hydrogen atom from a single atom of a parent heteroaromatic ring systems, as defined herein. Typical heteroaryl groups include, but are not limited to, groups derived from acridine, β-carboline, chromane, chromene, cinnoline, furan, imidazole, indazole, indole, indoline, indolizine, isobenzofuran, isochromene, isoindole, isoindoline, isoquinoline, isothiazole, isoxazole, naphthyridine, oxadiazole, oxazole, perimidine, phenanthridine, phenanthroline, phenazine, phthalazine, pteridine, purine, pyran, pyrazine, pyrazole, pyridazine, pyridine, pyrimidine, pyrrole, pyrrolizine, quinazoline, quinoline, quinolizine, quinoxaline, tetrazole, thiadiazole, thiazole, thiophene, triazole, xanthene, and the like. Preferably, the heteroaryl group comprises from 5 to 20 ring atoms (5-20 membered heteroaryl), more preferably from 5 to 10 ring atoms (5-10 membered heteroaryl). Preferred heteroaryl groups are those derived from furan, thiophene, pyrrole, benzothiophene, benzofuran, benzimidazole, indole, pyridine, pyrazole, quinoline, imidazole, oxazole, isoxazole and pyrazine.

“Heteroarylalkyl” by itself or as part of another substituent refers to an acyclic alkyl group in which one of the hydrogen atoms bonded to a carbon atom, typically a terminal or sp³ carbon atom, is replaced with a heteroaryl group. Where specific alkyl moieties are intended, the nomenclature heteroarylalkanyl, heteroarylakenyl and/or heteroarylalkynyl is used. In preferred embodiments, the heteroarylalkyl group is a 6-21 membered heteroarylalkyl, e.g., the alkanyl, alkenyl or alkynyl moiety of the heteroarylalkyl is (C1-C6) alkyl and the heteroaryl moiety is a 5-15-membered heteroaryl. In particularly preferred embodiments, the heteroarylalkyl is a 6-13 membered heteroarylalkyl, e.g., the alkanyl, alkenyl or alkynyl moiety is (C1-C3) alkyl and the heteroaryl moiety is a 5-10 membered heteroaryl.

“Parent Aromatic Ring System” refers to an unsaturated cyclic or polycyclic ring system having a conjugated π electron system. Specifically included within the definition of “parent aromatic ring system” are fused ring systems in which one or more of the rings are aromatic and one or more of the rings are saturated or unsaturated, such as, for example, fluorene, indane, indene, phenalene, etc. Typical parent aromatic ring systems include, but are not limited to, aceanthrylene, acenaphthylene, acephenanthrylene, anthracene, azulene, benzene, chrysene, coronene, fluoranthene, fluorene, hexacene, hexaphene, hexalene, as-indacene, s-indacene, indane, indene, naphthalene, octacene, octaphene, octalene, ovalene, penta-2,4-diene, pentacene, pentalene, pentaphene, perylene, phenalene, phenanthrene, picene, pleiadene, pyrene, pyranthrene, rubicene, triphenylene, trinaphthalene and the like.

“Parent Heteroaromatic Ring System” refers to a parent aromatic ring system in which one or more carbon atoms (and optionally any associated hydrogen atoms) are each independently replaced with the same or different heteroatom. Typical heteroatoms to replace the carbon atoms include, but are not limited to, N, P, O, S, Si, etc. Specifically included within the definition of “parent heteroaromatic ring system” are fused ring systems in which one or more of the rings are aromatic and one or more of the rings are saturated or unsaturated, such as, for example, benzodioxan, benzofuran, chromane, chromene, indole, indoline, xanthene, etc. Typical parent heteroaromatic ring systems include, but are not limited to, arsindole, carbazole, β-carboline, chromane, chromene, cinnoline, furan, imidazole, indazole, indole, indoline, indolizine, isobenzofuran, isochromene, isoindole, isoindoline, isoquinoline, isothiazole, isoxazole, naphthyridine, oxadiazole, oxazole, perimidine, phenanthridine, phenanthroline, phenazine, phthalazine, pteridine, purine, pyran, pyrazine, pyrazole, pyridazine, pyridine, pyrimidine, pyrrole, pyrrolizine, quinazoline, quinoline, quinolizine, quinoxaline, tetrazole, thiadiazole, thiazole, thiophene, triazole, xanthene and the like.

“Metal ion” or “Metal Salt” refers to a salt of a compound of the invention which is made with counterions understood in the art to be generally acceptable for pharmaceutical uses and which possesses the desired pharmacological activity of the parent compound. Such salts include: (1) acid addition salts, formed with inorganic acids such as hydrochloric acid, hydrobromic acid, sulfuric acid, nitric acid, phosphoric acid, and the like; or formed with organic acids such as acetic acid, propionic acid, hexanoic acid, cyclopentanepropionic acid, glycolic acid, pyruvic acid, lactic acid, malonic acid, succinic acid, malic acid, maleic acid, fumaric acid, tartaric acid, citric acid, benzoic acid, 3-(4-hydroxybenzoyl) benzoic acid, cinnamic acid, mandelic acid, methanesulfonic acid, ethanesulfonic acid, 1,2-ethane-disulfonic acid, 2-hydroxyethanesulfonic acid, benzenesulfonic acid, 4-chlorobenzenesulfonic acid, 2-naphthalenesulfonic acid, 4-toluenesulfonic acid, camphorsulfonic acid, 4-methylbicyclo[2.2.2]-oct-2-ene-1-carboxylic acid, glucoheptonic acid, 3-phenylpropionic acid, trimethylacetic acid, tertiary butylacetic acid, lauryl sulfuric acid, gluconic acid, glutamic acid, hydroxynaphthoic acid, salicylic acid, stearic acid, muconic acid and the like; or (2) salts formed when an acidic proton present in the parent compound is replaced by a metal ion, e.g., an alkali metal ion, an alkaline earth ion, or an aluminum ion; or coordinates with an organic base such as ethanolamine, diethanolamine, triethanolamine, N-methylglucamine, morpholine, piperidine, dimethylamine, diethylamine and the like. Also included are salts of amino acids such as arginates and the like, and salts of organic acids like glucurmic or galactunoric acids and the like (see, e.g., Berge et al., 1977, J. Pharm. Sci. 66:1-19).

“Pharmaceutically acceptable vehicle” refers to a diluent, adjuvant, excipient or carrier with which a compound of the invention is administered.

“Substituted,” when used to modify a specified group or radical, means that one or more hydrogen atoms of the specified group or radical are each, independently of one another, replaced with the same or different substituent(s). Substituent groups useful for substituting saturated carbon atoms in the specified group or radical include, but are not limited to —R^{a}, halo, —O⁻, ═O, —OR^{b}, —SR^{b}, —S⁻, ═S, —NR^{c}R^{c}, ═NR^{b}, ═N—OR^{b}, trihalomethyl, —CF₃, —CN, —OCN, —SCN, —NO, —NO₂, ═N₂, —N₃, —S(O)₂R^{b}, —S(O)₂O⁻, —S(O)₂OR^{b}, —OS(O)₂R^{b}, —OS(O)₂O⁻, —OS(O)₂OR^{b}, —P(O)(O⁻)₂, —P(O)(OR^{b})(O⁻), —P(O)(OR^{b})(OR^{b}), —C(O)R^{b}, —C(S)R^{b}, —C(NR^{b})R^{b}, —C(O)O⁻, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)O⁻, —OC(O)OR^{b}, —OC(S)OR^{b}, —NR^{b}C(O)R^{b}, —NR^{c}C(S)R^{b}, —NR^{b}C(O)O³¹ , —NR^{b}C(O)OR^{b}, —NR^{b}C(S)OR^{b}, —NR^{b}C(O)NR^{c}R^{c}, —NR^{b}C(NR^{b})R^{b} and —NR^{b}C(NR^{b})NR^{c}R^{c}, where R^{a} is selected from the group consisting of alkyl, cycloalkyl, heteroalkyl, cycloheteroalkyl, aryl, arylalkyl, heteroaryl and heteroarylalkyl; each R^{b} is independently hydrogen or R^{a}; and each R^{c} is independently R^{b} or alternatively, the two R^{c}s are taken together with the nitrogen atom to which they are bonded form a 5-, 6- or 7-membered cycloheteroalkyl which may optionally include from 1 to 4 of the same or different additional heteroatoms selected from the group consisting of O, N and S. As specific examples, —NR^{c}R^{c} is meant to include —NH₂, —NH-alkyl, N-pyrrolidinyl and N-morpholinyl.

Similarly, substituent groups useful for substituting unsaturated carbon atoms in the specified group or radical include, but are not limited to, —R^{a}, halo, —O⁻, —OR^{b}, —SR^{b}, —S—, —NR^{c}R^{c}, trihalomethyl, —CF₃, —CN, —OCN, —SCN, —NO, —NO₂, —N₃, —S(O)₂R^{b}, —S(O)₂O⁻, —S(O)₂OR^{b}, —OS(O)₂R^{b}, —OS(O)₂O⁻, —OS(O)₂OR^{b}, —P(O)(O⁻)₂, —P(O)(OR^{b})(O⁻), —P(O)(OR^{b})(OR^{b}), —C(O)R^{b}, —C(S)R^{b}, —C(NR^{b})R^{b}, —C(O)O⁻, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)O⁻, —OC(O)OR^{b}, —OC(S)OR^{b}, —NR^{b}C(O)R^{b}, —NR^{b}C(S)R^{b}, —NR^{b}C(O)O⁻, —NR^{b}C(O)OR^{b}, —NR^{b}C(S)OR^{b}, —NR^{b}C(O)NR^{c}R^{c}, —NR^{b}C(NR^{b})R^{b} and —NR^{b}C(NR^{b})NR^{c}R^{c}, where R^{a}, R^{b} and R^{c} are as previously defined.

Substituent groups useful for substituting nitrogen atoms in heteroalkyl and cycloheteroalkyl groups include, but are not limited to, —R^{a}, —O⁻, —OR^{b}, —SR^{b}, —S⁻, —NR^{c}R^{c}, trihalomethyl, —CF₃, —CN, —NO, —NO₂, —S(O)₂R^{b}, —S(O)₂O⁻, —S(O)₂OR^{b}, —OS(O)₂R^{b}, —OS(O)₂O⁻, —OS(O)₂OR^{b}, —P(O)(O⁻)₂, —P(O)(OR^{b})(O⁻), —P(O)(OR^{b})(OR^{b}), —C(O)R^{b}, —C(S)R^{b}, —C(NR^{b})R^{b}, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)OR^{b}, —OC(S)OR^{b}, —NR^{b}C(O)R^{b}, —NR^{b}C(S)R^{b}, —NR^{b}C(O)OR^{b}, —NR^{b}C(S)OR^{b}, —NR^{b}C(O)NR^{c}R^{c}, —NR^{b}C(NR^{b})R^{b} and —NR^{b}C(NR^{b})NR^{c}R^{c}, where R^{a}, R^{b} and R^{c} are as previously defined.

Substituent groups from the above lists useful for substituting other specified groups or atoms will be apparent to those of skill in the art.

The substituents used to substitute a specified group can be further substituted, typically with one or more of the same or different groups selected from the various groups specified above.

“Sulfamoyl,” by itself or as part of another substituent, refers to a radical of the formula —S(O)₂NR′R″, where R′ and R″ are each, independently of one another, selected from the group consisting of hydrogen, alkyl and cycloalkyl as defined herein, or alternatively, R′ and R″, taken together with the nitrogen atom to which they are bonded, form a 5-, 6- or 7-membered cycloheteroalkyl ring as defined herein, which may optionally include from 1 to 4 of the same or different additional heteroatoms selected from the group consisting of O, S and N.

Methods of Synthesis

The particular phthaleins described above can be obtained via synthetic methods illustrated below. It should be understood that in R², R³, R⁵, R⁶, R⁷, R⁸, R⁹ and R¹⁰, are as previously defined for structural formula (I).

Starting materials useful for preparing compounds of the invention and intermediates thereof are commercially available or can be prepared by well-known synthetic methods (see, e.g., Harrison et al., “Compendium of Synthetic Organic Methods”, Vols. 1-8 (John Wiley and Sons, 1971-1996); “Beilstein Handbook of Organic Chemistry,” Beilstein Institute of Organic Chemistry, Frankfurt, Germany; Feiser et al., “Reagents for Organic Synthesis,” Volumes 1-21, Wiley Interscience; Trost et al., “Comprehensive Organic Synthesis,” Pergamon Press, 1991; “Theilheimer's Synthetic Methods of Organic Chemistry,” Volumes 1-45, Karger, 1991; March, “Advanced Organic Chemistry,” Wiley Interscience, 1991; Larock “Comprehensive Organic Transformations,” VCH Publishers, 1989; Paquette, “Encyclopedia of Reagents for Organic Synthesis,” 3d Edition, John Wiley & Sons, 1995). Other methods for synthesis of the compounds described herein and/or starting materials are either described in the art or will be readily apparent to the skilled artisan.

A typical synthesis is depicted in Scheme I, wherein 2 equivalents of a phenol or phenol equivalent are condensed with 1 equivalent of a phthalic anhydride or equivalent under essentially acid anhydrous conditions.

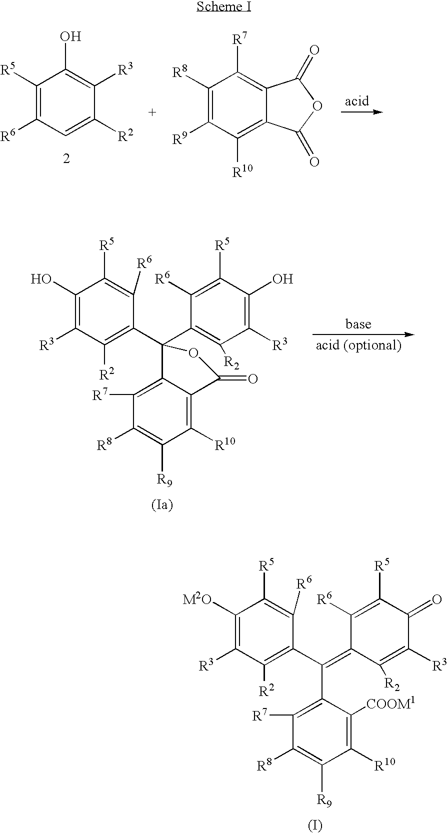

Generally, the phenol and anhydride are condensed in the presence of an acid under anhydrous conditions. For example, polyphosphoric acid and zinc chloride can be utilized. The carbon atom at 4-position -position with respect to the aromatic hydroxyl group must not be substituted as it is necessary for reaction. Polyphosphoric acid acts as a condensing agent as well as reaction medium. The reaction with only polyphosphoric acid afforded tarry products but when very small amount of zinc chloride was added to polyphosphoric acid, clean product was isolated. Very small amount of zinc chloride was found to increase yield and purity of the product. Polyphosphoric acid can be replaced with orthophosphoric acid, chlorosulfonic acid, methane sulfonic acid, trifluoroacetic acid or other acids under anhydrous conditions. Suitable solvents include non-protic solvents known in the art such as tetrahydrofuran, dioxane, methylene chloride, ether, etc.

The reaction proceeds with the formation of an isobenzofuranone (Ia), which is then treated with a base under aqueous conditions. The salt can be isolated or the solution can be acidified to produce the protonated phenol/carboxylic acid. For example, one molar equivalent of Ia was condensed with either two molar equivalent of sodium hydroxide in 85% ethanol or two molar equivalent of sodium ethoxide in ethanol. The products are generally solids and can be easily purified via filtration, crystallization, and other methods known in the art.

Suitable phenols include, but are not limited to 2-nitrophenol, 3-nitrophenol, 2-chlorophenol, 3-chlorophenol, 2-bromophenol, 3-bromophenol, 2-iodophenol, 3-iodophenol, 2-fluorophenol, 3-fluorophenol, 2-aminophenol, 3-aminophenol, 2-acetamidophenol, 3-acetamidophenol, 2-cyanophenol, 3-cyanophenol, 2-methylphenol, 3-methylphenol, 2-ethylphenol, 3-ethylphenol, 2-proylphenol, 3-proylphenol, 2-isoproylphenol, 3-isoproylphenol, 2-butylphenol, 3-butylphenol, 2-isobutylphenol, 3-isobutylphenol, 2-pentylphenol, 3-pentylphenol 2-hexylphenol, 3-hexylphenol, 2-heptylphenol, 3-heptylphenol, 2-octylphenol, 3-octylphenol, 2-nonylphenol, 3-nonylphenol, 2-decylphenol, 3-decylphenol, 2-decylphenol, 2-methoxyphenol, 3-methoxyphenol, 2-ethoxyphenol, 3-ethoxyphenol, 2-propoxyphenol, 3-propoxyphenol, 2-isopropoxyphenol, 3-isopropoxyphenol, 2-butoxyphenol, 3-butoxyphenol, 2-isobutoxyphenol, 3-isobutoxylphenol, 2-allylphenol, 3-allylphenol, 2-vinylphenol, 3-vinylphenol, 2-phenylphenol, 3-phenylphenol, 2-phenoxyphenol, 3-phenoxyphenol, 2-cyclopropylphenol, 3-cyclopropylphenol, 2-cyclobutylphenol, 3-cyclobutylphenol, 2-cyclopentylphenol, 3-cyclopentylphenol, 2-cyclohexylphenol, 3-cyclohexylphenol, 2-cycloheptylphenol, 3-cycloheptylphenol, 2-cyclooctylphenol, 3-cyclooctylphenol, 2-cyclononylphenol, 3-cyclononylphenol, 2-cyclodecylphenol, 3-cyclodecylphenol, 2,3-dinitrophenol, 2,5-dinitrophenol, 2,6-dinitrophenol, 2,3-dimethylphenol, 2,5-dimethylphenol, 2,6-dimethylphenol, 2,3-diethylphenol, 2,5-diethylphenol, 2,6-diethylphenol, 2,3-diproplylphenol, 2,5-dipropylphenol, 2,6-dipropylphenol, 2,3-diisoproplylphenol, 2,5-diisopropylphenol, 2,6-diisopropylphenol, 2,3-dibutylphenol, 2,5-dibutylphenol, 2,6-dibutylphenol, 2,3-diisobutylphenol, 2,5-diisobutylphenol, 2,6-diisobutylphenol, 2,3-dipentylphenol, 2,5-dipentylphenol, 2,6-dipentylphenol, 2,3-dihexylphenol, 2,5-dihexylphenol, 2,6-dihexylphenol, 2,3-diheptylphenol, 2,5-diheptylphenol, 2,6-diheptylphenol, 2,3-dioctylphenol, 2,5-dioctylphenol, 2,6-dioctylphenol, 2,3-dinonylphenol, 2,5-dinonylphenol, 2,6-dinonylphenol, 2,3-didecylphenol, 2,5-didecylphenol, 2,6-didecylphenol, 2,3-dimethoxyphenol, 2,5-dimethoxyphenol, 2,6-dimethoxyphenol, 2,3-diethoxyphenol, 2,5-diethoxyphenol, 2,6-diethoxyphenol, 2,3-dipropoxyphenol, 2,5-dipropoxyphenol, 2,6-dipropoxyphenol, 2,3-diisopropoxyphenol, 2,5-diisopropoxyphenol, 2,6-diisopropoxyphenol, 2,3-dibutoxyphenol, 2,5-dibutoxyphenol, 2,6-dibutoxyphenol, 2,3-diisobutoxyphenol, 2,5-diisobutoxyphenol, 2,6-diisobutoxyphenol, 2,3-dipentoxyphenol, 2,5-dipentoxyphenol, 2,6-dipentoxyphenol, 2,3-dihexoxyphenol, 2,5-dihexoxyphenol, 2,6-dihexoxyphenol, 2,3-diheptoxyphenol, 2,5-diheptoxyphenol, 2,6-diheptoxyphenol, 2,3-dioctoxyphenol, 2,5-dioctoxyphenol, 2,6-dioctoxyphenol, 2,3-dinonoxyphenol, 2,5-dinonoxyphenol, 2,6-dinonoxyphenol, 2,3-didecyloxyphenol, 2,5-didecyloxyphenol, 2,6-didecyloxyphenol, 2,3-dichlorophenol, 2,5-dichlorophenol, 2,6-dichlorophenol, 2,3-dibromophenol, 2,5-dibromophenol, 2,6-dibromophenol, 2,3-diiodophenol, 2,5-diiodophenol, 2,6-diiodophenol, 2,3-difluorophenol, 2,5-difluorophenol, 2,6-difluorophenol, 2,3-diaminophenol, 2,5-diaminophenol, 2,6-diaminophenol, 2,3-diacetamidophenol, 2,5-diacetamidophenol, 2,6-diacetamidophenol, 2,3-dicyanophenol, 2,5-dicyanophenol, 2,6-dicyanophenol, 2,3-diallylphenol, 2,5-diallylphenol, 2,6-diallylphenol, 2,3-divinylphenol, 2,5-divinylphenol, 2,6-divinylphenol, 2,3-diphenylphenol, 2,5-diphenylphenol, 2,6-diphenylphenol, 2,3-diphenoxyphenol, 2,5-diphenoxyphenol, 2,6-diphenoxyphenol, 2,3-dicycloproylphenol, 2,5-dicyclopropylphenol, 2,6-dicyclopropylphenol, 2,3-dicyclobutylphenol, 2,5-dicyclobutylphenol, 2,6-dicyclobutylphenol, 2,3-dicyclopentylphenol, 2,5-dicyclopentylphenol, 2,6-dicyclopentylphenol, 2,3-dicyclohexylphenol, 2,5-dicyclohexylphenol, 2,6-dicyclohexylphenol, 2,3-dicycloheptylphenol, 2,5-dicycloheptylphenol, 2,6-dicycloheptylphenol, 2,3-dicyclooctylphenol, 2,5-dicyclooctylphenol, 2,6-dicyclooctylphenol, 2,3-dicyclononylphenol, 2,5-dicyclononylphenol, 2,6-dicyclononylphenol, 2,3-dicyclodecylphenol, 2,5-dicyclodecylphenol, 2,6-dicyclodecylphenol, 2,3,5-trimethylphenol, 2,3,6-trimethylphenol 2,3,5-triethylphenol, 2,3,6-triethylphenol, 2,3,5-tripropylphenol, 2,3,6-tripropylphenol, 2,3,5-tributylphenol, 2,3,6-tributylphenol, 2,3,5-trichlorophenol, 2,3,6-trichlorophenol, 2,3,5-tribromophenol, 2,3,6-tribromophenol, 2,3,5-triiodophenol, 2,3,6-triiodophenol, 2,3,5-trifluorophenol, 2,3,6-trifluorophenol, 2,3,5-trivinylphenol, 2,3,6-trivinylphenol, 2,3,5-triallylphenol, 2,3,6-triallylphenol, 2,3,5-triphenylphenol, 2,3,6-triphenylphenol, 2,3,5-triphenoxyphenol, 2,3,6-triphenoxyphenol, 2,3,5-trimethoxyphenol, 2,3,6-trimethoxyphenol, 2,3,5-triethoxyphenol, 2,3,6-triethoxyphenol, 2,3,5-tripropoxyphenol, 2,3,6-tripropoxyphenol, 2,3,5-tributoxyphenol, 2,3,6-tributoxyphenol, 2,3,5-trinotrophenol, 2,3,6-trinitrophenol, 2,3,5-triaminophenol, 2,3,6-triaminophenol, 2,3,5-triacetamidophenol, 2,3,6-triacetamidophenol, 2,3,5-tricyanophenol, 2,3,6-tricyanophenol, 3-(N,N-diethylamino)phenol, 2-tert-butyl-5-methylphenol, 2-tert-butyl-6-methylphenol, 3-methyl-2-nitrophenol, 5-methyl-2-nitrophenol, 6-methyl-2-nitrophenol, 3-ethyl-2-nitrophenol, 5-ethyl-2-nitrophenol, 6-ethyl-2-nitrophenol, 3-methoxyl-2-nitrophenol, 5-methoxy-2-nitrophenol, 6-methoxy-2-nitrophenol, 1-naphthaol, 2-naphthaol, 2-nitro-1-naphthol, 3-nitro-1-naphthol, 5-nitro-1-naphthol, 6-nitro-1-naphthol, 7-nitro-1-naphthol, 8-nitro-1-naphthol, 2-methyl-1-naphthol, 3-methyl-1-naphthol, 5-methyl-1-naphthol, 6-methyl-1-naphthol, 7-methyl-1-naphthol, 8-methyl-1-naphthol, 2-methoxy-1-naphthol, 3-methoxy-1-naphthol, 5-methoxy-1-naphthol, 6-methoxy-1-naphthol, 7-methoxy-1-naphthol, 8-methoxy-1-naphthol, 2-chloro-1-naphthol, 3-chloro-1-naphthol, 5-chloro-1-naphthol, 6-chloro-1-naphthol, 7-chloro-1-naphthol, 8-chloro-1-naphthol, 2-bromo-1-naphthol, 3-bromo-1-naphthol, 5-bromo-1-naphthol, 6-bromo-1-naphthol, 7-bromo-1-naphthol, 8-bromo-1-naphthol, 2-iodo-1-naphthol, 3-iodo-1-naphthol, 5-iodo-1-naphthol, 6-iodo-1-naphthol, 7-iodo-1-naphthol, 8-iodo-1-naphthol, 2-fluoro-1-naphthol, 3-fluoro-1-naphthol, 5-fluoro-1-naphthol, 6-fluoro-1-naphthol, 7-bromo-1-naphthol, 8-fluoro-1-naphthol, 2-cyano-1-naphthol, 3-cyano-1-naphthol, 5-cyano-1-naphthol, 6-cyano-1-naphthol, 7-cyano-1-naphthol, 8-cyano-1-naphthol, 8-hydroxyquinaldine and 2-quinoxalinol.

The term “phenol equivalent” is intended to include those compounds where, as described above, R² and R³, for example, form an aromatic, heterocyclic, or non-aromatic ring. Suitable compounds include naphthols for example.

Suitable phthalic anhydrides include but are not limited to phthalic anhydride, 3-nitrophthalic anhydride, 4-nitrophthalic anhydride, 5-nitrophthalic anhydride, 6-nitrophthalic anhydride, 3-chlorophthalic anhydride, 4-chlorophthalic anhydride, 5-chlorophthalic anhydride, 6-chlorophthalic anhydride, 3-bromophthalic anhydride, 4-bromophthalic anhydride, 5-bromophthalic anhydride, 6-bromophthalic anhydride, 3-iodophthalic anhydride, 4-iodophthalic anhydride, 5-iodophthalic anhydride, 6-iodophthalic anhydride, 3-fluorophthalic anhydride, 4-fluorophthalic anhydride, 5-fluorophthalic anhydride, 6-fluorophthalic anhydride, 3-methylphthalic anhydride, 4-methylphthalic anhydride, 5-methylphthalic anhydride, 6-methylphthalic anhydride, 3-ethylphthalic anhydride, 4-ethylphthalic anhydride, 5-ethylphthalic anhydride, 6-ethylphthalic anhydride, 3-methoxyphthalic anhydride, 4-methoxyphthalic anhydride, 5-methoxyphthalic anhydride, 6-methoxyphthalic anhydride, 3-cyanophthalic anhydride, 4-cyanophthalic anhydride, 5-cyanophthalic anhydride, 6-cyanophthalic anhydride, 3-aminophthalic anhydride, 4-aminophthalic anhydride, 5-aminophthalic anhydride, 6-aminophthalic anhydride, 3-acetamidophthalic anhydride, 4-acetamidophthalic anhydride, 5-acetamidophthalic anhydride, 6-acetamidophthalic anhydride, 3,4,5,6-tetrachlorophthalic anhydride, 3,4,5,6-tetrabromophthalic anhydride, 3,4,5,6-tetraiodophthalic anhydride, 3,4,5,6-tetrafluorophthalic anhydride, 3,4,5,6-tetranitrophthalic anhydride, 3,4,5,6-tetramethylphthalic anhydride, 3,4,5,6-tetraethylphthalic anhydride, 3,4,5,6-tetramethoxyphthalic anhydride, 3,4,5,6-tetracyanophthalic anhydride, 3,4,5,6-tetraaminophthalic anhydride, 3,4,5,6-tetraacetamidophthalic anhydride, naphthalic anhydride, 2-chloronaphthalic anhydride, 3-chloronaphthalic anhydride, 4-chloronaphthalic anhydride, 5-chloronaphthalic anhydride, 6-chloronaphthalic anhydride, 7-chloronaphthalic anhydride, 2-bromonaphthalic anhydride, 3-bromonaphthalic anhydride, 4-bromonaphthalic anhydride, 5-bromonaphthalic anhydride, 6-bromonaphthalic anhydride, 7-bromonaphthalic anhydride, 2-iodonaphthalic anhydride, 3-iodonaphthalic anhydride, 4-iodonaphthalic anhydride, 5-iodonaphthalic anhydride, 6-iodonaphthalic anhydride, 7-iodonaphthalic anhydride, 2-fluoronaphthalic anhydride, 3-fluoronaphthalic anhydride, 4-fluoronaphthalic anhydride, 5-fluoronaphthalic anhydride, 6-fluoronaphthalic anhydride, 7-fluoronaphthalic anhydride, 2-nitronaphthalic anhydride, 3-nitronaphthalic anhydride, 4-nitronaphthalic anhydride, 5-nitronaphthalic anhydride, 6-nitronaphthalic anhydride and 7-nitronaphthalic anhydride.

The term “phthalic anhydride equivalent” is intended to include those compounds where, as described above, R⁷ and R⁸, for example, form an aromatic, heterocyclic, or non-aromatic ring. Suitable compounds include naphthols for example.

Synthesis of Phenols and Hydrazides

The compounds of the invention may be obtained via synthetic methods illustrated below. It should be understood that in R², R³, R⁴, R⁵, R⁶, R⁷, R⁸, R⁹, R¹⁰, R¹¹, R¹², R¹³, R¹⁴ and R¹⁵ are as previously defined for structural formulae (II), (III), (IIIa) and (IV).

Starting materials useful for preparing compounds of the invention and intermediates thereof are commercially available or can be prepared by well-known synthetic methods (see, e.g., Harrison et al., “Compendium of Synthetic Organic Methods”, Vols. 1-8 (John Wiley and Sons, 1971-1996); “Beilstein Handbook of Organic Chemistry,” Beilstein Institute of Organic Chemistry, Frankfurt, Germany; Feiser et al., “Reagents for Organic Synthesis,” Volumes 1-21, Wiley Interscience; Trost et al., “Comprehensive Organic Synthesis,” Pergamon Press, 1991; “Theilheimer's Synthetic Methods of Organic Chemistry,” Volumes 1-45, Karger, 1991; March, “Advanced Organic Chemistry,” Wiley Interscience, 1991; Larock “Comprehensive Organic Transformations,” VCH Publishers, 1989; Paquette, “Encyclopedia of Reagents for Organic Synthesis,” 3d Edition, John Wiley & Sons, 1995). Other methods for synthesis of the compounds described herein and/or starting materials are either described in the art or will be readily apparent to the skilled artisan.

A typical synthesis for substituted phenols is depicted in Scheme II, wherein a phenol is treated with a base to form the phenolic salt. Advantageously, the phenolic salts are water soluble, which is useful in the applications detailed throughout the specification.

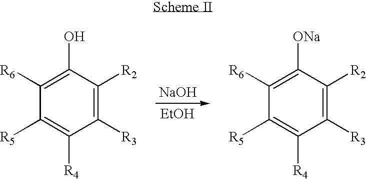

Generally, the phenol mixed with the base and the salt is formed. The solution may be heated to facilitate the rate of reaction.

Suitable phenols include, but are not limited to 2-nitrophenol, 3-nitrophenol, 4-nitrophenol, 2-chlorophenol, 3-chlorophenol, 4-chlorophenol, 2-bromophenol, 3-bromophenol, 4-bromophenol, 2-iodophenol, 3-iodophenol, 4-iodophenol, 2-aminophenol, 3-aminophenol, 4-aminophenol, 2-cyanophenol, 3-cyanophenol, 4-cyanophenol, 2-vinylphenol, 3-vinylphenol, 4-vinylphenol, 2,3-dichlorophenol, 2,4-dichlorophenol, 2,5-dichlorophenol, 2,6-dichlorophenol, 2,3-dibromophenol, 2,4-dibromophenol, 2,5-dibromophenol, 2,6-dibromophenol, 2,3-diiodophenol, 2,4-diiodophenol, 2,5-diiodophenol, 2,6-diiodophenol, 2,3-diaminophenol, 2,4-diaminophenol, 2,5-diaminophenol, 2,6-diaminophenol, 2,3-dicyanophenol, 2,4-dicyanophenol, 2,5-dicyanophenol, 2,6-dicyanophenol, 2,3-divinylphenol, 2,4-divinylphenol, 2,5-divinylphenol, 2,6-divinylphenol, 2,3-diphenylphenol, 2,3,4-trichlorophenol, 2,3,5-trichlorophenol, 2,3,6-trichlorophenol, 2,3,4-tribromophenol, 2,3,5-tribromophenol, 2,3,6-tribromophenol, 2,3,4-triiodophenol, 2,3,5-triiodophenol, 2,3,6-triiodophenol, 2,3,4-trivinylphenol, 2,3,5-trivinylphenol, 2,3,6-trivinylphenol, 2,3,4-trinitrophenol, 2,3,5-trinitrophenol, 2,3,6-trinitrophenol, 2,3,4-triaminophenol, 2,3,5-triaminophenol, 2,3,6-triaminophenol, 2,3,4-tricyanophenol, 2,3,5-tricyanophenol, 2,3,6-tricyanophenol, 3-(N,N-diethylamino)phenol, 3-methyl-2-nitrophenol, 5-methyl-2-nitrophenol, 6-methyl-2-nitrophenol, 3-ethyl-2-nitrophenol, 5-ethyl-2-nitrophenol, 6-ethyl-2-nitrophenol, 3-methoxyl-2-nitrophenol, 5-methoxy-2-nitrophenol, 6-methoxy-2-nitrophenol, 2-nitro-1-naphthol, 3-nitro-1-naphthol, 4-nitro-1-naphthol, 5-nitro-1-naphthol, 6-nitro-1-naphthol, 7-nitro-1-naphthol, 8-nitro-1-naphthol, 2-chloro-1-naphthol, 3-chloro-1-naphthol, 4-chloro-1-naphthol, 5-chloro-1-naphthol, 6-chloro-1-naphthol, 7-chloro-1-naphthol, 8-chloro-1-naphthol, 2-bromo-1-naphthol, 3-bromo-1-naphthol, 4-bromo-1-naphthol, 5-bromo-1-naphthol, 6-bromo-1-naphthol, 7-bromo-1-naphthol, 8-bromo-1-naphthol, 2-iodo-1-naphthol, 3-iodo-1-naphthol, 4-iodo-1-naphthol, 5-iodo-1-naphthol, 6-iodo-1-naphthol, 7-iodo-1-naphthol, 8-iodo-1-naphthol, 2-cyano-1-naphthol, 3-cyano-1-naphthol, 4-cyano-1-naphthol, 5-cyano-1-naphthol, 6-cyano-1-naphthol, 7-cyano-1-naphthol, 8-cyano-1-naphthol and 8-hydroxyquinaldine.

The term “phenol equivalent” is intended to include those compounds where, as described above, R² and R³, for example, form an aromatic, heterocyclic, or non-aromatic ring. Suitable compounds include naphthols for example.

A typical synthesis of hydrazines is depicted in Scheme III, where a hydrazine (NH₂NH—R¹⁵, wherein R¹⁵ can be a hydrogen atom or as described above) and an ester are condensed to form the hydrazide.

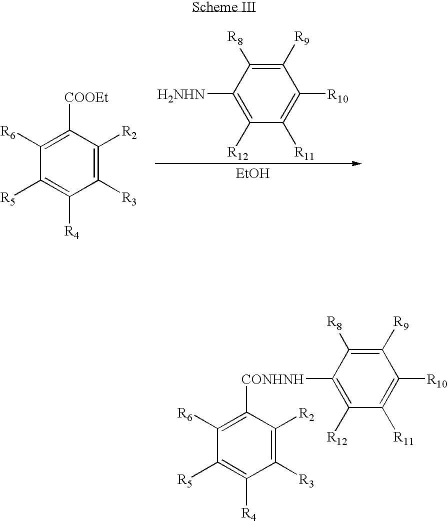

Typically the ester and the hydrazine are combined in a solvent, such as a protic solvent, e.g., an alcohol, such as ethanol, and heated, e.g., to reflux. Upon cooling, the hydrazide generally precipitates from solution and can be collected.

Suitable salicylic derivatives include, but not limited to salicylic acid, 3-methylsalicylic acid, 4-methylsalicylic acid, 5-methylsalicylic acid, 6-methylsalicylic acid, 3-ethylsalicylic acid, 4-ethylsalicylic acid, 5-ethylsalicylic acid, 6-ethylsalicylic acid, 3-propylsalicylic acid, 4-propylsalicylic acid, 5-propylsalicylic acid, 6-propylsalicylic acid, 3-isopropylsalicylic acid, 4-isopropylsalicylic acid, 5-isopropylsalicylic acid, 6-isopropylsalicylic acid, 3-butylsalicylic acid, 4-butylsalicylic acid, 5-butylsalicylic acid, 6-butylsalicylic acid, 3-isobutylsalicylic acid, 4-isobutylsalicylic acid, 5-isobutylsalicylic acid, 6-isobutylsalicylic acid, 3-methoxysalicylic acid, 4-methoxysalicylic acid, 5-methoxysalicylic acid, 6-methoxysalicylic acid, 3-ethoxysalicylic acid, 4-ethoxysalicylic acid, 5-ethoxysalicylic acid, 6-ethoxysalicylic acid, 3-propoxysalicylic acid, 4-propoxysalicylic acid, 5-propoxysalicylic acid, 6-propoxysalicylic acid, 3-butoxysalicylic acid, 4-butoxysalicylic acid, 5-butoxysalicylic acid, 6-butoxysalicylic acid, 3-nitrosalicylic acid, 4-nitrosalicylic acid, 5-nitrosalicylic acid, 6-nitrosalicylic acid, 3-chlorosalicylic acid, 4-chlorosalicylic acid, 5-chlorosalicylic acid, 6-chlorosalicylic acid, 3-bromosalicylic acid, 4-bromosalicylic acid, 5-bromosalicylic acid, 6-bromosalicylic acid, 3-iodosalicylic acid, 4-iodosalicylic acid, 5-iodosalicylic acid, 6-iodoosalicylic acid, 3-fluorosalicylic acid, 4-fluorosalicylic acid, 5-fluorosalicylic acid, 6-fluorosalicylic acid, 3-aminosalicylic acid, 4-aminosalicylic acid, 5-aminosalicylic acid, 6-aminosalicylic acid, 3-acetamidosalicylic acid, 4-acetamidosalicylic acid, 5-acetamidosalicylic acid, 6-acetamidosalicylic acid, 3-cyanosalicylic acid, 4-cyanosalicylic acid, 5-cyanosalicylic acid, 6-cyanosalicylic acid, 3-sulfosalicylic acid, 4-sulfosalicylic acid, 5-sulfosalicylic acid, 6-sulfosalicylic acid, 3,5-dimethylsalicylic acid, 3,5-diethylsalicylic acid, 3,5-dipropylsalicylic acid, 3,5-dibutylsalicylic acid, 3,5-dimethoxysalicylic acid, 3,5-diethoxysalicylic acid, 3,5-dipropoxysalicylic acid, 3,5-dibutoxysalicylic acid, 3,5-dichlorosalicylic acid, 3,5-dibromosalicylic acid, 3,5-diiodosalicylic acid, 3,5-difluorosalicylic acid, 3,5-dinitrosalicylic acid, 3,5-diaminosalicylic acid, 3,5-diacetamidosalicylic acid, 3,5-dicyanosalicylic acid, 3,5-disulfosalicylic acid, substituted/unsubstituted alkyl salicylic acid, substituted/unsubstituted alkoxy salicylic acid, substituted/unsubstituted aryl salicylic acid, substituted/unsubstituted cycloalkyl salicylic acid and substituted/unsubstituted hetaryl salicylic acid.

Suitable hydrazines include but not limited to hydrazine hydrate, 4-nitrophenylhydrazine, 3-nitrophenylhydrazine, 2-nitrophenylhydrazine, 4-nitrobenzoic hydrazide, 3-nitrobenzoic hydrazide, 2-nitrobenzoic hydrazide, p-toluenesulfonylhydrazide, m-toluenesulfonylhydrazide, o-toluenesulfonyl-hydrazide, 2,4-dinitrophenylhydrazine (2,4-DNP), 1-naphthoic hydrazide, 2-naphthoic hydrazide, nicotinic hydrazide, substituted/unsubstituted alkyl hydrazide, substituted/unsubstituted alkoxy hydrazide, substituted/unsubstituted aryl hydrazide, substituted/unsubstituted cycloalkyl hydrazide and substituted/unsubstituted hetaryl hydrazide.

Additional surfactants useful in cleansing compositions and lotions

Suitable surfactants include anionic, cationic, nonionic or zwitterionic compounds and combinations thereof. The surfactant can be either polymeric or non-polymeric.

The term “surfactant” is recognized in the relevant art to include those compounds which modify the nature of surfaces, e.g. reducing the surface tension of water. Surfactants are generally classified into four types: cationic (e.g. modified onium salts, where part of the molecule is hydrophilic and the other consists of straight or branches long hydrocarbon chains such as hexadecyltrimethyl bromide), anionic, also known as amphiphatic agents (e.g., alkyl or aryl or alkylarylsulfonates, carboxylates, phosphates), nonionic (e.g., polyethylene oxides, alcohols) and ampholytic or amphoteric (e.g. dodecyl-beta-alanine, such that the surfactant contains a zwitterionic group). One or more surfactants can be used in the present invention.

Cationic surfactants useful as surface tension reducing agents in the present invention include long chain hydrocarbons which contain quaternarized heteroatoms, such as nitrogen. Suitable cationic surfactants include quaternary ammonium compounds in which typically one of the groups linked to the nitrogen atom is a C12-C18 alkyl group and the other three groups are short chained alkyl groups.

Anionic surfactants (amphiphatic agents) are characterized by a single lipophilic chain and a polar head group which can include sulfate, sulfonate, phosphate, phosphonate and carboxylate. Exemplary compounds include linear sodium alkyl benzene sulfonate (LAS), linear alkyl sulfates and phosphates, such as sodium lauryl sulfate (SLS) and linear alkyl ethoxy sulfates. Additional examples of anionic surfactants include substituted ammonium (e.g., mono-, di-, and tri-ethanolammonium), alkali metal and alkaline earth metal salts of C6-C20 fatty acids and rosin acids, linear and branched alkyl benzene sulfonates, alkyl ether sulfates, alkane sulfonates, olefin sulfonates, hydroxyalkane sulfonates, fatty acid monoglyceride sulfates, alkyl glyceryl ether sulfates, acyl sarcosinates. acyl N-methyltaurides, and alkylaryl sulfonated surfactants, such as alkylbenezene sulfonates.

Nonionic surfactants do not dissociate but commonly derive their hydrophilic portion from polyhydroxy or polyalkyloxy structures. Suitable examples of polyhydroxy (polyhydric) compounds include ethylene glycol, butylene glycol,1,3-butylene glycol, propylene glycol, glycerine, 2-methyl-1,3-propane diol, glycerol, mannitol, corn syrup, beta-cyclodextrin, and amylodextrin. Suitable examples of polyalkyloxy compounds include diethylene glycol, dipropylene glycol, polyethylene glycols, polypropylene glycols and glycol derivatives.

Other suitable nonionic surfactants include other linear ethoxylated alcohols with an average length of 6 to 16 carbon atoms and averaging about 2 to 20 moles of ethylene oxide per mole of alcohol; linear and branched, primary and secondary ethoxylated, propoxylated alcohols with an average length of about 6 to 16 carbon atoms and averaging 0-10 moles of ethylene oxide and about 1 to 10 moles of propylene oxide per mole of alcohol; linear and branched alkylphenoxy (polyethoxy) alcohols, otherwise known as ethoxylated alkylphenols, with an average chain length of 8 to 16 carbon atoms and averaging 1.5 to 30 moles of ethylene oxide per mole of alcohol; and mixtures thereof.

Additionally, suitable nonionic surfactants include polyoxyethylene carboxylic acid esters, fatty acid glycerol esters, fatty acid and ethoxylated fatty acid alkanolamides. Block copolymers of propylene oxide and ethylene oxide, and block polymers of propylene oxide and ethylene oxide with propoxylated ethylene diamine are also included as acceptable nonionic surfactants. Semi-polar nonionic surfactants like amine oxides, phosphine oxides, sulfoxides, and their ethoxylated derivatives are included within the scope of the invention.

Suitable amphoteric and zwitterionic surfactants which contain an anionic water-solubilizing group, a cationic group and a hydrophobic organic group include amino carboxylic acids and their salts, amino dicarboxylic acids and their salts, alkylbetaines, alkyl aminopropylbetaines, sulfobetaines, alkyl imidazolinium derivatives, certain quaternary ammonium compounds, certain quaternary phosphonium compounds and certain tertiary sulfonium compounds

Examples of anionic, nonionic, cationic and amphoteric surfactants that are suitable for use in the present invention are described in Kirk-Othmer, Encyclopedia of Chemical Technology, Third Edition, Volume 22, pages 347-387, and McCutcheon's Detergents and Emulsifiers, North American Edition, 1983, both of which are incorporated herein by reference.

Typical concentration ranges of surfactant that are useful in the present compositions are from about 0.01 parts by weight to about 90 parts by weight, from about 0.5 part by weight to about 50 parts by weight, and from about 1 parts by weight to about 10 parts by weight.

In one aspect, surfactants useful in the compositions of the invention include, but are not limited to, cellulose ethers or mixtures with other surfactants, which are water soluble. Cellulose ether surfactants have unique foaming properties which make them ideal for foaming hand soap applications. Cellulose ethers used in the present invention include methyl cellulose, ethyl cellulose, propyl cellulose, butyl cellulose, higher alkyl, aryl, alkoxy, cycloalkyl celluloses, hydroxypropyl cellulose, hydroxybutyl cellulose or mixtures thereof.

Commercial cellulose ether surfactants include, but are not limited to, Methocel A4M, methyl cellulose, Methocel F4M, hydroxypropyl methylcellulose, Methocel K4M, hydroxypropyl methylcellulose, manufactured by Dow Chemical Co., Mildland, Mich.; Natrosol, hydroxyethyl cellulose, Klucel, hydroxypropyl cellulose, Aqualon Cellulose Gum, sodium carboxymethyl cellulose, Hercules Inc., Wilmington, Del.; Elfacos CD 481, ethyl 2-hydroxyethyl ether cellulose, manufactured by Akzo Nobel, Chicago, Ill.

Cellulose ether surfactants are generally present in amounts from about 1% up to about 40% by weight in the compositions of the invention. Suitable concentrations of cellulose ether surfactants are in the range of about 2% to about 30% by weight and from about 3% to about 8% by weight. A particularly useful cellulosic ether surfactant in the compositions is Methocel A4M.

In another aspect, alkanolamide or a mixture with other surfactants can be used in the compositions of the invention. Alkanolamides are commercially available and are the reaction products of one or more fatty acids having 12 or more carbon atoms and a lower alkanolamime. Typical alkanolamides are formed by reaction between stearic, mystiric, lauric acid or mixtures thereof with mono-, di-, and/or iso-propanolamine.

Alkanolainides can be present in the compositions of the invention in the ranges generally described throughout the application but generally are present in amounts from about 0% up to about 10% by weight. Suitable ranges include from about 1% to about 6% by weight and in particular from about 1.5% to about 4% by weight.

In one embodiment, the alkanolamide surfactants of the present invention include, but are not limited to, Ninol 55LL, diethanolamine, Ninol 40CO, cocamide DEA, Ninol 30LL, lauramide DEA, manufactured by Stepan Co., Northfield, Ill.; Colamid C, cocamide DEA, Colamid 0071-J, alkanolamide, manufactured by Colonial Chemical Inc., S. Pittsburgh, Tenn. In one aspect, the alkanolamides are Ninol 55LL, and Colamid C.

Exemplary sulfosuccinates that can be employed in the present compositions include, but are not limited to, Stepan-Mild SL3-BA, disodium laureth sulfosuccinate, Stepan-Mild LSB, sodium lauryl sulfosuccinate, manufactured by Stepan Co., Northfield, Ill., Lankropol 4161L, sodium fatty alkanolamide sulfosuccinate and Colamate-DSLS, disodium laureth sulfosuccinate, manufactured by Colonial Chemical Inc., S. Pittsburgh, Tenn.

Suitable betaines that can be employed in the present compositions include, but are not limited to, Miracare BC-27, cocamidopropyl betaine and Miranol Ultra C-37, sodium cocoampho acetate, manufactured by J & S Chemical Co., Weston, Fla.

Suitable sulfates that can be employed in the present compositions include Rhodapex ES-2, sodium laureth sulfate, J & S Chemical Co., Weston, Fla.; Witcolate WAQ, sodium alkyl sulfate, manufactured by Akzo Nobel, Chicago, I and Colonial-SLS, sodium lauryl sulfate, manufactured by Colonial Chemical Inc., S. Pittsburgh, Tenn. Colonial-SLS surfactant is a combination of lauryl sulfate, C10-C16 alkyl alcohols, sodium salts and C10-C16 alcohols.

A suitable nonionic surfactant that can be employed in the present compositions is Triton H-66, alkyl aryl alkoxy potassium salt, manufactured by Dow Chemical Co., Mildland, Mich.

Germicides

### EXAMPLE I

A sample of the germicidal composition can be prepared by adding 400 mg of sodium dodecyl sulfate (SDS) and 400 mg of octyl phenoxy polyethoxyethanol marketed as Triton X-100 a product of Sigma Chemical Company to 100 ml of 70% by volume isopropanol. 100 mg of acid-base indicator disodium salt of 3,3-Bis-(4-hydroxy-3-isopropylphenyl)-1-(3H)-isobenzofuranone would be added. The pH would be adjusted with a base to produce a deep purple-red colored liquid. When the composition would be allowed to stand exposed to air it would be colorless and the pH would drop.

This composition could be tested for germicide effectiveness against Herpes simplex virus type 2 (HSV2), Neisseria gonorrhoeae, Staphylococcus aureus, Escherichia coli 011K58, Shigella sonnei, Salmonella typhimurium, and Candida albicans. The composition could be sprayed and dropped on pathogen suspensions to test efficacy and acid-base indicator color disappearance.

In both the spray and drop tests 0.1 milliliters (ml) of test pathogenic organisms containing approximately 1×10⁷ organisms would be placed on the surface of a sterile plastic Petri dish. In the drop test 0.1 ml of the composition of Example I would be added by pipette to the pathogen suspension in the Petri dish. The pathogen suspension and drop of Example I would be mixed and allowed to stand for twenty seconds. The color would disappear before the twenty seconds elapsed. At the end of twenty seconds the Petri plate would be tilted and 0.1 ml of the test sample would be removed. In the spray test the composition of Example I would be placed in an aerosol spray with a fluorocarbon propellant. The 0.1 ml of the pathogenic organism suspension in the Petri plate would be sprayed for two seconds with Example I. The spray would be allowed to mix on the Petri plate for twenty seconds. After twenty seconds the Petri plate would be tilted and 0.1 ml of the sample would be removed for testing.

The test samples removed from the drop and spray tests would be diluted and plated on agar medium (casman media for S. typhimurium, S. sonnei and E. coli; chocolate agar supplemented with factor XV for N. gonorrhoeae, and sheep blood agar for S. aureus and C. albicans). HSV2 would be added to the first wells of a 96-well sterile microtiter tissue culture plate, serially diluted and cultured with VERO monkey kidney cells for five days. Phosphate buffered saline would be used as a diluent for all organisms except N. gonorrhoeae and HSV2; phosphate buffered saline (PBS) containing 0.5% gelatin would be used as a diluent for the N. gonnorhoeae and minimal essential medium supplemented with 5% fetal calf serum and antibiotics would be used for the HSV2. Each test would include a control (pathogenic organism+diluent) and a quantitative titration of the pathogen to determine the actual number of organisms in each test suspension. All Petri and tissue culture plates would be incubated in 37° C. (5% CO₂) incubators.

All Petri plates would be observed the morning after plating for colony forming units (CFU) and the number of organisms present in the test suspensions would be calculated. The tissue culture plates containing VERO cells would be observed daily for virus specific cytopathic effects (CPE). At the end of five days the last well in each series of dilutions showing CPE would be recorded and the titer of virus in the original test suspensions calculated. Each assay involving HSV2 would have a tissue culture control (VERO cells+media only) and a virus control (VERO cells+HSV2 and no germicide).

Example I could be compared to Lysol for strength of killing the organisms HSV2, S. aureaus, N. gonorrhoeae. E. coli 011K58, S. typhimurium, S. sonnei and C. albicans, the complete range of pathogens tested previously. The test would be conducted for spray delivery.

Cleanser

### EXAMPLE I

A detergent composition/solution containing the following ingredients could be applied to a floor surface and could be removed by an implement as disclosed above (containing an effective amount of sodium polyacrylate, in particular cross-linked sodium polyacrylate, a superabsorbent material) and as exemplified in the drawings. The result would be a clean floor.

| Ingredient | |
|---|---|
| Finished Product | Approximate wt. % In |
| C11E5 (Shell Neodol 1-5) | 0.09% |
| Sodium C8 alkyl sulfonate | 0.05% |
| Ethanol | 1% |
| Dowanol PNB Glycol Ether | 0.75% |
| 2-dimethylamino-2-methyl-1-propanol | 0.2% |
| Silicone Suds Suppressor | 0.00125% |
| Perfume | 0.055% |
| disodium salt of 3,3-Bis-(4-hydroxy-3- | 0.005% |
| isopropylphenyl)-1-(3H)-isobenzofuranone | |
| Deionized water | Balance |
| pH = | about. 11 |

The suds suppressor contains: Polyethylene glycol stearate (4% Wt, CAS # 9004993); Methylated silica (2% Wt, CAS # 67762907); Octamethylcyclotetrasiloxane (2% Wt, CAS # 556672).

For stability reasons it may be found the following as the best order of addition:

a) a pre-mix with a final concentration of 0.5% disodium salt of 3,3-Bis-(4-hydroxy-3-isopropylphenyl)-1-(3H)-isobenzofuranone in ethanol can be made;

b) in a separate beaker, the appropriate amount of de-ionized water would be weighed and adjusted to a pH=11.0 using a few drops of NaOH (NaOH not shown in the above formula);

c) the solvents, including the ethanolic thymolphthalein solution would be combined in a separate beaker, stirred, then poured into the rapidly stirring water of step b; and

d) the remaining ingredients are added.

The suds suppressor at an effective level, typically from about 0.0005 to about 0.02, from about 0.001 to about 0.01, more particularly from about 0.002 to about 0.003, provides a technical improvement in spotting and filming, particularly on ceramic surfaces. The reason for this is the grout lines on ceramic create low spots as the mop moves across, generating suds. If too high a level of suds is generated, it can dry down into streaks. Furthermore, consumer research shows that suds seen on floor during mopping is perceived by some consumers as leading to film/streaking.

Lowering suds on floor during mopping can provide varying degrees of technical and perceptual benefits for not leaving film/streaks. The degree of benefit depends on the level of suds created and to what degree the level of suds is controlled, particularly during mopping.

Known suds suppressors can be used, but it is highly desirable to use a silicone suds suppressor since they are effective at very low levels and therefore can minimize the total water insoluble material needed while having at least an effective amount of suds suppressor present.

Mopping of the floor with the above solution would provide a visual indication where the floor was wetted. As the liquid evaporates, the color would disappear.

Lotion Preparation

TABLE 1
TYPICAL LOTION FORMULA

| Part 1 | |
|---|---|
| lanolin | 0.2-1% |
| cocoa butter | 2.0-5% |
| emcol RHT (glycelyl slearate) | 2.0-4% |
| hystren 5016 (stearic acid) | 2.0-4% |
| vitamin E acetate | 0.1-0.5% |
| aloe vera lipo quinone extract | 0.1-1.0% |
| jojoba o | 0.1-1.0% |
| mineral oil | 1.0-7% |
| propylparaben | 0.1-1% |
| medical fluid 360 (dimethicone) | 0.1-1% |
| Part 2 | |
| water | 40-60% |
| carbopol 941 (1%) (polyacrylic acid polymer) | 10-35% |
| propylene glycol | 2.0-7% |
| triethanolamine 99% | 0.1-3% |
| lanogel 41 (PEG-75 lanolin) | 0.25-1% |
| methylparaben | 0.1-0.5% |
| sequestrene Na2 | 0.01-0.08% |
| Part 3 | |
| perfume | 0.01-.5% |

To make the formulation listed in Table 1, parts I and 2 would be heated separately to 180° F. Part 1 would then be added to Part 2. The resultant blend would be cooled to 120° F. and Part 3 would then be added. Between about 0.01% and about 5% of an acid-base indicator, such as the disodium salt of 3,3-Bis-(4-hydroxy-3-isopropylphenyl)-1-(3H)-isobenzofuranone, would be added to the lotion. This particular acid-base indicator would impart a purple-red color that would disappear as the lotion was rubbed thoroughly onto the skin.

Other examples of formulations which are useful according to the invention include oil-in-water creams, oil-in-water lotions, water-in-oil lotions, oil-in-water resistant creams and lotions, sticks, gels, oils and mousses. Such formulations are found, for example, in Cosmetics & Toiletries, Vol. 102, pp 117-130, March 1987, the disclosure of which is incorporated herein by reference.

Still other examples of formulations which are useful according to the invention include hand and body lotions, oil-in-water emollient creams, moisturizing lotions, after sun emollient stick, facial spray mist, skin mousse and moisturizing gel. Such formulations are found, for example, in Cosmetics & Toiletries, Vol. 102, pp 47-160, April 1987, the disclosure of which is incorporated herein by reference.

Those skilled in the art will appreciate that the formulations described in the above cited Cosmetics & Toiletries references (March and April 1987) represent types of formulations which may be suitably modified to allow for the addition of color indicators, and that such modifications may be accomplished without the need for undue experimentation.

Synthesis of Acid-Base Indicators:

### EXAMPLE 1

### Synthesis of 3,3-bis-(4-hydroxy-3-isopropylphenyl)-1-(3H)-isobenzofuranone

A mixture of 2-isopropylphenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-3-isopropylphenyl)-1-(3H)-isobenzofuranone in 96% yield.

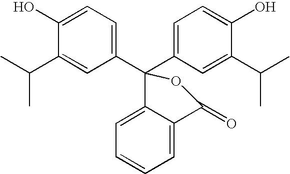

### EXAMPLE 2

### Synthesis of 3,3-bis-(4-hydroxy-3,5-diisopropylphenyl)-1-(3H)-isobenzofuranone

A mixture of 2,6-diisopropylphenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-3,5-diisopropylphenyl)-1-(3H)-isobenzofuranone in 98% yield.

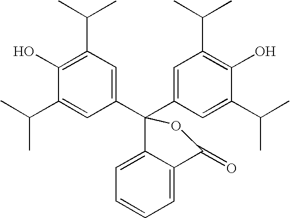

### EXAMPLE 3

### Synthesis of 3,3-bis-(4-hydroxy-2-nitrophenyl)-1-(3H)-isobenzofuranone

A mixture of 3-nitrophenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-2-nitrophenyl)-1-(3H)-isobenzofuranone in 81% yield.

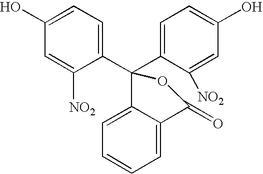

### EXAMPLE 4

### Synthesis of 3,3-bis-(4-hydroxy-3-nitrophenyl)-1-(3H)-isobenzofuranone

A mixture of 2-nitrophenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-3-nitrophenyl)-1-(3H)-isobenzofuranone in 89% yield.

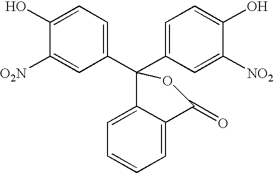

### EXAMPLE 5

### Synthesis of 3,3-bis-[4-hydroxy-2-(N,N-diethylamino)phenyl]-1-(3H)-isobenzofuranone

A mixture of 3-(N,N-diethylamino)phenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-[4-hydroxy-2-(N,N-diethylamino)phenyl]-1-(3H)-isobenzofuranone in 93% yield.

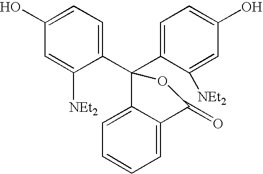

### EXAMPLE 6

### Synthesis of 3,3-bis-(4-hydroxy-3-ethylphenyl)-1-(3H)-isobenzofuranone

A mixture of 2-ethylphenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-3-ethylphenyl)-1-(3H)-isobenzofuranone in 92% yield.

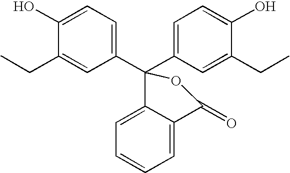

### EXAMPLE 7

### Synthesis of 3,3-bis-(4-hydroxy-3-ethoxyphenyl)-1-(3H)-isobenzofuranone

A mixture of 2-ethoxyphenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-3-ethoxyphenyl)-1-(3H)-isobenzofuranone in 85% yield.

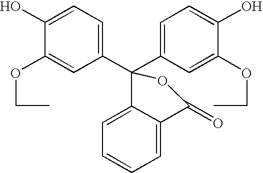

### EXAMPLE 8

### Synthesis of 3,3-bis-(4-hydroxy-3-acetamidophenyl)-1-(3H)-isobenzofuranone

A mixture of 2-acetamidophenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-3-acetamidophenyl)-1-(3H)-isobenzofuranone in 83% yield.

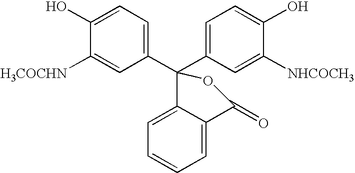

### EXAMPLE 9

### Synthesis of 3,3-bis-(4-hydroxy-6-methyl-3-nitrophenyl)-1-(3H)-isobenzofuranone

A mixture of 5-methyl-2-nitrophenol (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-6-methyl-3-nitrophenyl)-1-(3H)-isobenzofuranone in 81% yield.

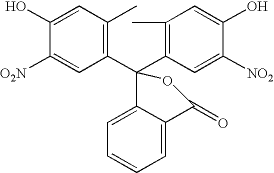

### EXAMPLE 10

### Synthesis of 3,3-bis-(4-hydroxy-6-methyl-5-quinolin-1-yl)-1-(3H)-isobenzofuranone

A mixture of 8-hydroxyquinaldine (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-6-methyl-5-quinolin-1-yl)-1-(3H)-isobenzofuranone in 88% yield.

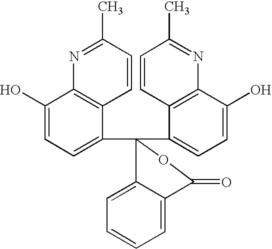

### EXAMPLE 11

### Synthesis of 3,3-bis-(4-hydroxy-3-pyridin-1-yl)-1-(3H)-isobenzofuranone

A mixture of 2-hydroxypyridine (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-3-pyridin-1-yl)-1-(3H)-isobenzofuranone in 80% yield.

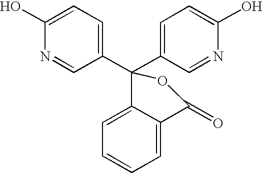

### EXAMPLE 12

### Synthesis of 3,3-bis-(4-hydroxy-2-pyridin-1-yl)-1-(3H)-isobenzofuranone

A mixture of 3-hydroxypyridine (0.2M), phthalic anhydride (0.1M), polyphosphoric acid (0.25M), and zinc chloride (0.01M), was stirred and heated at 100° C. for 3 hours. The reaction mixture was cooled to room temperature and added to ice-water mixture when the product precipitated. The product was filtered, thoroughly washed with water and dried. Recrystallization from ethanol with charcoal treatment furnished pure 3,3-bis-(4-hydroxy-2-pyridin-1-yl)-1-(3H)-isobenzofuranone in 82% yield.

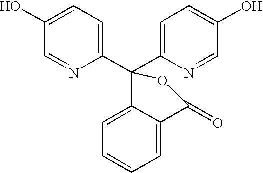

### EXAMPLE 13

### Synthesis of 3,3-bis-(4-hydroxy-3-phenylphenyl)-1-(3H)-isobenzofuranone

A mixture of 2-phenylphenol (0.133mol), phthalic anhydride (0.074mol), reaction medium (0.416mol), and Lewis acid (0.029mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-3-phenylphenyl)-1-(3H)-isobenzofuranone as white crystals in 94% yield. ¹H-NMR (DMSO-d₆, 300 MHz): δ 9.89 (s, 2H, 20H), 6.97-7.18 (m, 6H, aromatic), 7.26-7.47 (m, 10H, aromatic), 7.63-7.92 (m, 4H, aromatic) ppm. Mass spectra: m/z 470 (M⁺).

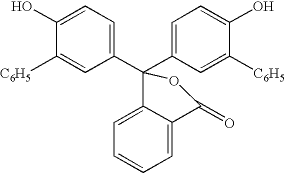

### EXAMPLE 14

### Synthesis of 3,3-bis-(4-hydroxy-3,5-diisopropylphenyl)-1-(3H)-isobenzofuranone

A mixture of 2,6-diisopropylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-3,5-diisopropylphenyl)-1-(3H)-isobenzofuranone as white crystals in 89% yield. IR (KBr): 3506, 1734, 1609 cm⁻¹. ¹H-NMR (DMSO-d₆): δ 9.56 (s, 2H, 20H), 1.02-1.05 (dd, 24H, 8CH₃), 3.22-3.31 (heptate, 4H, 4CH), 6.74-7.00 (m, 4H, aromatic), 7.59-7.92 (m, 4H, aromatic) ppm. Mass spectra: m/z 486 (M⁺).

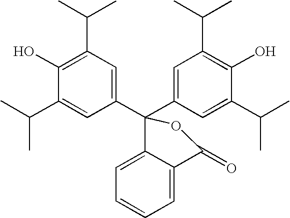

### EXAMPLE 15

### Synthesis of 3,3-bis-(4-hydroxy-3,5-dimethoxyphenyl)-1-(3H)-isobenzofuranone

A mixture of 2,6-dimethoxyphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-3,5-dimethoxyphenyl)-1-(3H)-isobenzofuranone as white crystals in 84% yield. IR (KBr): 3388, 1769, 1606, 1369 cm⁻¹. ¹H-NMR (DMSO-d₆): δ 8.71 (s, 2H, 2OH), 3.66 (s, 12H, 4OCH₃), 7.65-7.68 (m, 4H, aromatic), 7.83-7.96 (m, 4H, aromatic) ppm. Mass spectra: m/z 438 (M⁺).

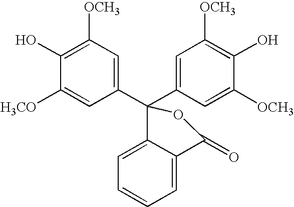

### EXAMPLE 16

### Synthesis of 3,3-bis-(4-hydroxy-3,5-dimethylphenyl)-1-(3H)-isobenzofuranone

A mixture of 2,6-dimethylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-3,5-dimethylphenyl)-1-(3H)-isobenzofuranone as white crystals in 91% yield. IR (KBr): 3582, 3386, 1746, 1605 cm⁻¹. ¹H-NMR (DMSO-d₆): δ 8.45 (s, 2H, 2OH), 2.10 (s, 12H, 4CH₃), 7.58-7.63 (m, 4H, aromatic), 7.78-7.87 (m, 4H, aromatic) ppm. Mass spectra: m/z 374 (M⁺).

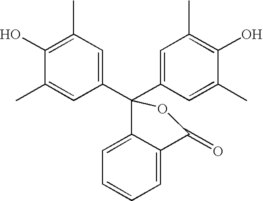

### EXAMPLE 17

### Synthesis of 3,3-bis-(4-hydroxy-3,6-diimethylphenyl)-1-(3H)-isobenzofuranone

A mixture of 2,5-dimethylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-3,6-diimethylphenyl)-1-(3H)-isobenzofuranone as pale yellow crystals in 85% yield. IR (KBr): 3393, 1729, 1611 cm⁻¹. ¹H-NMR (DMSO-d₆): δ 9.40 (s, 2H, 2OH), 1.95 (s, 12H, 4CH₃), 6.59-6.63 (m, 4H, aromatic), 7.46-7.91 (m, 4H, aromatic) ppm. Mass spectra: m/z 374 (M⁺).

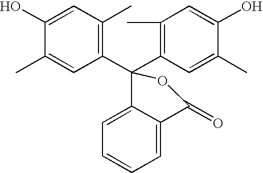

### EXAMPLE 18

### Synthesis of 3,3-bis-(4-hydroxy-3-ethylphenyl)-1-(3H)-isobenzofuranone

A mixture of 2-ethylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from ethyl acetate:petroleum ether (1:1) with charcoal treatment furnished pure 3,3-bis-(4-hydroxy-3-ethylphenyl)-1-(3H)-isobenzofuranone as white crystals in 81% yield. IR (KBr): 3389, 1783, 1718, 1605 cm⁻¹. ¹H-NMR (DMSO-d₆): δ 9.54 (s, 2H, 2OH), 2.43-2.50 (q, 4H, 2CH₂), 1.00-1.05 (t, 6H, 2CH₃), 6.74-6.96 (m, 6H, aromatic), 7.57-7.89 (m, 4H, aromatic) ppm. Mass spectra: m/z 374 (M⁺).

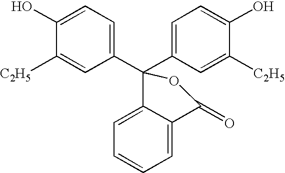

### EXAMPLE 19

### Synthesis of 3,3-bis-(4-hydroxy-3-isopropylphenyl)-1-(3H)-isobenzofuranone

A mixture of 2-isopropylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol:water (1:1) with charcoal treatment furnished pure 33,3-bis-(4-hydroxy-3-isopropylphenyl)-1-(3H)-isobenzofuranone as white crystals in 83% yield. IR (KBr): 3383, 1733, 1608 cm⁻¹. ¹H-NMR (DMSO-d₆): δ 9.57 (s, 2H, 2OH), 1.05-1.07 (dd, 12H, 4CH₃), 3.11-3.18 (heptate, 2H, 2CH), 6.75-7.01 (m, 6H, aromatic), 7.59-7.90 (m, 4H, aromatic) ppm. Mass spectra: m/z 402 (M⁺).

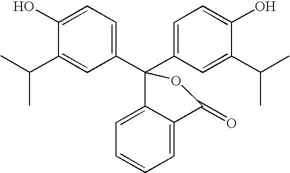

### EXAMPLE 20

### Synthesis of 3,3-bis-(4-hydroxy-3-methoxyphenyl)-1-(3H)-isobenzofuranone

A mixture of 2-methoxyphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-3-methoxyphenyl)-1-(3H)-isobenzofuranone as white crystals in 79% yield. IR (KBr): 3517, 1747, 1701, 1279 cm⁻¹. ¹H-NMR (DMSO-d₆): δ 9.27 (s, 2H, 2OH), 3.66 (s, 6H, 2OCH₃), 6.65-6.78 (m, 6H, aromatic), 7.61-7.90 (m, 4H, aromatic) ppm. Mass spectra: m/z 378 (M⁺).

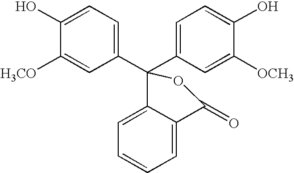

### EXAMPLE 21

### Synthesis of 3,3-bis-(4-hydroxy-2,3,5-trimethylphenyl)-1-(3H)-isobenzofuranone

A mixture of 2,3,6-trimethylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-2,3,5-trimethylphenyl)-1-(3H)-isobenzofuranone as white crystals in 73% yield. IR (KBr): 3510, 3390, 1746, 1609, cm⁻¹. ¹H-NMR (DMSO-d₆): δ 9.44 (s, 2H, 2OH), 2.05 (s, 18H, 6CH₃), 6.55 (s, 2H, aromatic), 7.46-7.90 (m, 4H, aromatic) ppm. Mass spectra: m/z 402 (M⁺).

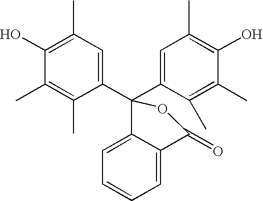

### EXAMPLE 22

Synthesis of 3,3-bis-(4-hydroxy-3-sec-butylphenyl)-1-(3H)-isobenzofuranone

A mixture of 2-sec-butylphenol (0.133 mol), phthalic anhydride (0.074 mol), reaction medium (0.416 mol), and Lewis acid (0.029 mol), was stirred and heated at 90° C. for 5 hours. The reaction mixture was cooled to room temperature and added to ice-water mixture when the product precipitated. The product was filtered, thoroughly washed with water and dried. Recrystallization from methanol with charcoal treatment furnished pure 3,3-bis-(4-hydroxy-3-sec-butylphenyl)-1-(3H)-isobenzofuranone as white crystals in 77% yield. IR (KBr): 3400, 1722, 1607 cm⁻¹. ¹H-NMR (DMSO-d₆): δ 9.50 (s, 2H, 2OH), 0.80 (t, 6H, 2CH₃), 1.35-1.39 (p, 4H, 2CH₂), 1.22 (d, 6H, 2CH₃), 2.89-2.97 (sextate, 2H, 2CH), 6.73-6.93 (m, 6H, aromatic), 7.59-7.90 (m, 4H, aromatic) ppm. Mass spectra: m/z 430 (M⁺).

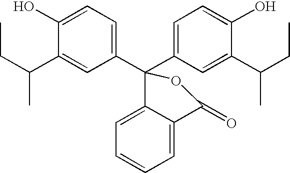

### EXAMPLE 23

### Synthesis of 3,3-bis-(4-hydroxy-3-nitrophenyl)-1-(3H)-isobenzofuranone

A mixture of phenolphthalein (0.062 mol) in acetic acid (290 mL) was stirred at 15° C. Concentrated nitric acid (0.136 mol, 65%) in acetic acid (10 mL) was slowly added to stirring mixture at 15° C. The reaction mixture was further stirred for 6 hours at room temperature and added to ice-water mixture when the yellow colored product precipitated. The product was filtered, thoroughly washed with water and dried. Recrystallization from ethanol with charcoal treatment furnished pure 3,3-bis-(4-hydroxy-3-nitrophenyl)-1-(3H)-isobenzofuranone as pale yellow crystals in 78% yield. IR (KBr): 3262, 1766, 1627, 1538, 1423 cm⁻¹. ¹H-NMR (DMSO-d₆): δ 9.67 (s, 2H, 20H), 6.71-7.16 (m, 6H, aromatic), 7.46-7.98 (m, 4H, aromatic) ppm. Mass spectra: m/z 408 (M⁺).

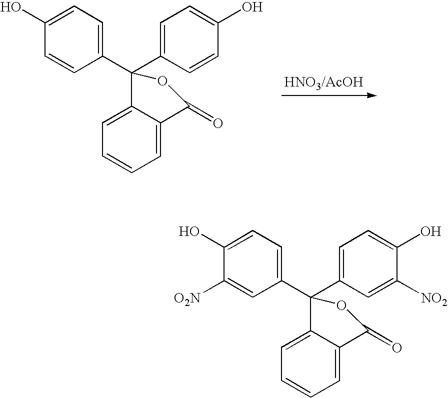

Synthesis of disodium salts of acid-base indicators for water based systems:

### EXAMPLE 1

### Synthesis of disodium salt of 3,3-bis-(4-hydroxy-3-isopropylphenyl)-1-(3H)-isobenzofuranone

A mixture of 3,3-bis-(4-hydroxy-3-isopropylphenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 98% yield.

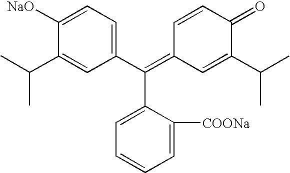

### EXAMPLE 2

### Synthesis of disodium salt of 3,3-bis-(4-hydroxy-3,5-diisopropylphenyl)-1-(3H)-isobenzofuranone

A mixture of 3,3-bis-(4-hydroxy-3,5-diisopropylphenyl)-1-(3H)-isobenzofuranone (0.01 M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 94% yield.

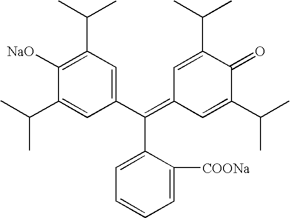

### EXAMPLE 3

### Synthesis of disodium salt of 3,3-bis-(4-hydroxy-2-nitrophenyl)-1-(3 H)-isobenzofuranone

A mixture of 3,3-bis-(4-hydroxy-2-nitrophenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 88% yield.

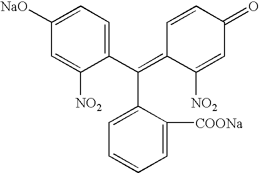

### EXAMPLE 4

### Synthesis of disodium salt of 3,3-bis-(4-hydroxy-3-nitrophenyl)-1-(3H)-isobenzofuranone

A mixture of 3,3-bis-(4-hydroxy-3-nitrophenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 91% yield.

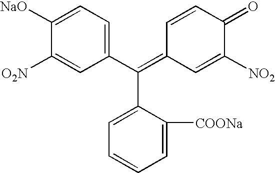

### EXAMPLE 5

### Synthesis of disodium salt of 3,3-bis-[4-hydroxy-2-(N,N-diethylamino)phenyl]-1-(3H)-isobenzofuranone

A mixture of 3,3-bis-[4-hydroxy-2-(N,N-diethylamino)phenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure, disodium salt in 89% yield.

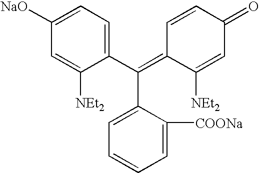

### EXAMPLE 6

### Synthesis of disodium salt of 3,3-bis-(4-hydroxy-3-ethylphenyl)-1-(3H)-isobenzofuranone

A mixture of 3,3-bis-(4-hydroxy-3-ethylphenyl)-1-(3H)-isobenzofuranone (0.01 M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 97% yield.

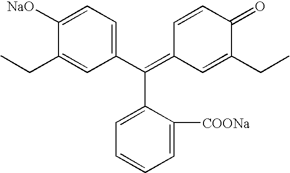

### EXAMPLE 7

### Synthesis of disodium salt of 3,3-bis-(4-hydroxy-3-ethoxyphenyl)-1-(3H)-isobenzofuranone

A mixture of 3,3-bis-(4-hydroxy-3-ethoxyphenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 94% yield.

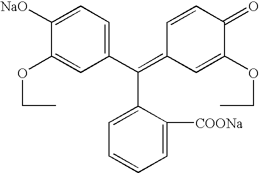

### EXAMPLE 8

### Synthesis of disodium salt of 3,3-bis-(4-hydroxy-3-acetamidophenyl)-1-(3H)-isobenzofuranone

A mixture of 3,3-bis-(4-hydroxy-3-acetamidophenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 92% yield.

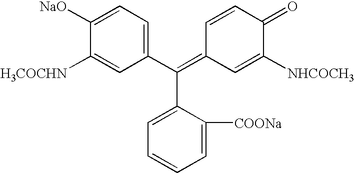

### EXAMPLE 9

### Synthesis of disodium salt of 3,3-bis-(4-hydroxy-6-methyl-3-nitrophenyl)-1-(3H)-isobenzofuranone

A mixture of 3,3-bis-(4-hydroxy-6-methyl-3-nitrophenyl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 97% yield.

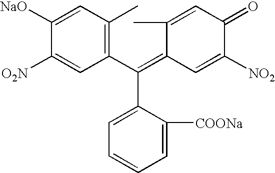

### EXAMPLE 10

### Synthesis of disodium salt of 3,3-bis-(4-hydroxy-6-methyl-5-quinolin-1-yl)-1-(3H)-isobenzofuranone

A mixture of 3,3-bis-(4-hydroxy-6-methyl-5-quinolin-1-yl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 94% yield.

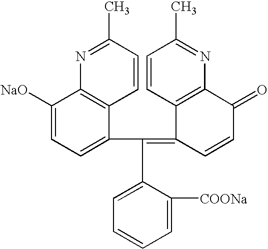

### EXAMPLE 11

### Synthesis of disodium salt of 3,3-bis-(4-hydroxy-3-pyridin-1-yl)-1-(3H)-isobenzofuranone

A mixture of 3,3-bis-(4-hydroxy-3-pyridin-1-yl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 81 % yield.

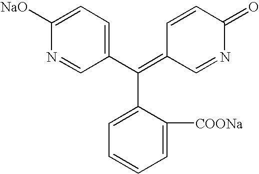

### EXAMPLE 12

### Synthesis of disodium salt of 3,3-bis-(4-hydroxy-2-pyridin-1-yl)-1-(3H)-isobenzofuranone

A mixture of 3,3-bis-(4-hydroxy-2-pyridin-1-yl)-1-(3H)-isobenzofuranone (0.01M) in ethanol (50 mL, 85%) was stirred followed by addition of sodium hydroxide (0.02M) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 84% yield.

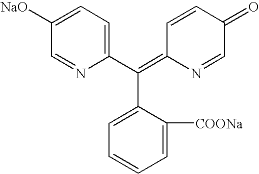

### EXAMPLE 13

### Synthesis of disodium salt of 3,3-bis-(4-hydroxy-3-phenylphenyl)-1-(3H)-isobenzofuranone

A mixture of 3,3-bis-(4-hydroxy-3-phenylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 96% yield. ¹H-NMR (DMSO-d₆, 300 MHz): δ 6.25-6.74 (m, 6H, aromatic), 6.88-7.45 (m, 10H, aromatic), 7.53-7.84 (m, 4H, aromatic) ppm. Mass spectra: m/z 514 (M⁺).

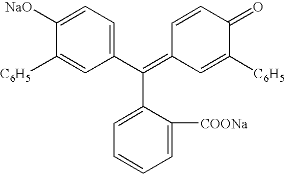

### EXAMPLE 14

### Synthesis of disodium salt of 3,3-bis-(4-hydroxy-3,5-diisopropylphenyl)-1-(3H)-isobenzofuranone

A mixture of 3,3-bis-(4-hydroxy-3,5-diisopropylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 92% yield. ¹H-NMR (DMSO-d₆): δ 1.00-1.21 (dd, 24H, 8CH₃), 3.06-3.36 (heptate, 4H, 4CH), 6.74-6.96 (m, 4H, aromatic), 7.05-7.83 (m, 4H, aromatic) ppm. Mass spectra: m/z 530 (M⁺).

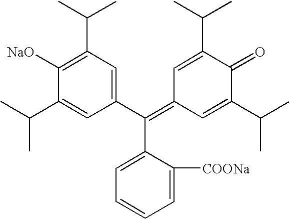

### EXAMPLE 15

### Synthesis of disodium salt of 3,3-bis-(4-hydroxy-3,5-dimethoxyphenyl)-1-(3H)-isobenzofuranone

A mixture of 3,3-bis-(4-hydroxy-3,5-dimethoxyphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 90% yield. ¹H-NMR (DMSO-d₆): δ 3.61 (s, 12H, 4OCH₃), 6.45-6.52 (m, 4H, aromatic), 7.04-7.78 (m, 4H, aromatic) ppm. Mass spectra: m/z 482 (M⁺).

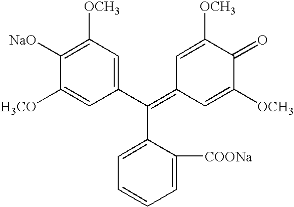

### EXAMPLE 16

### Synthesis of disodium salt of 3,3-bis-(4-hydroxy-3,5-dimethylphenyl)-1-(3H)-isobenzofuranone

A mixture of 3,3-bis-(4-hydroxy-3,5-dimethylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 95% yield. ¹H-NMR (DMSO-d₆): δ 2.11 (s, 12H, 4CH₃), 6.81-6.87 (m, 4H, aromatic), 7.23-7.84 (m, 4H, aromatic) ppm. Mass spectra: m/z 418 (M⁺).

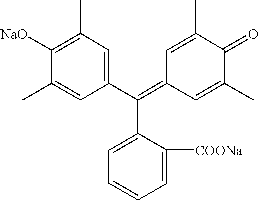

### EXAMPLE 17

### Synthesis of disodium salt of 3,3-bis-(4-hydroxy-3,6-diimethylphenyl)-1-(3H)-isobenzofuranone

A mixture of 3,3-bis-(4-hydroxy-3,6-diimethylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 88% yield. ¹H-NMR (DMSO-d₆): δ 2.01 (s, 12H, 4CH₃), 6.04-6.82 (m, 4H, aromatic), 7.10-7.72 (m, 4H, aromatic) ppm. Mass spectra: m/z 418 (M⁺).

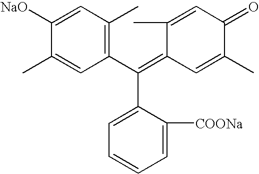

### EXAMPLE 18

### Synthesis of disodium salt of 3,3-bis-(4-hydroxy-3-ethylphenyl)-1-(3H)-isobenzofuranone

A mixture of 3,3-bis-(4-hydroxy-3-ethylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 86% yield. ¹H-NMR (DMSO-d₆): δ 2.30-2.51 (q, 4H, 2CH₂), 1.00-1.10 (t, 6H, 2CH₃), 6.20-6.75 (m, 6H, aromatic), 7.12-7.84 (m, 4H, aromatic) ppm. Mass spectra: m/z 418 (M⁺).

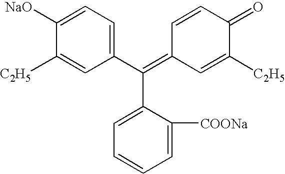

### EXAMPLE 19

### Synthesis of disodium salt of 3,3-bis-(4-hydroxy-3-isopropylphenyl)-1-(3H)-isobenzofuranone

A mixture of 3,3-bis-(4-hydroxy-3-isopropylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 81% yield. ¹H-NMR (DMSO-d₆): δ 1.02-1.14 (dd, 12H, 4CH₃), 3.12-3.45 (heptate, 2H, 2CH), 6.32-6.76 (m, 6H, aromatic), 7.30-7.83 (m, 4H, aromatic) ppm. Mass spectra: m/z 446 (M⁺).

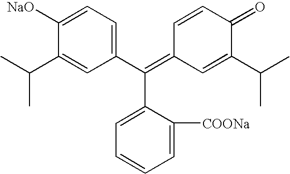

### EXAMPLE 20

### Synthesis of disodium salt of 3,3-bis-(4-hydroxy-3-methoxyphenyl)-1-(3H)-isobenzofuranone

A mixture of 3,3-bis-(4-hydroxy-3-methoxyphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 88% yield.

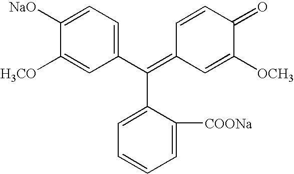

### EXAMPLE 21

### Synthesis of disodium salt of 3,3-bis-(4-hydroxy-2,3,5-trimethylphenyl)-1-(3H)-isobenzofuranone

A mixture of 3,3-bis-(4-hydroxy-2,3,5-trimethylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 80% yield.

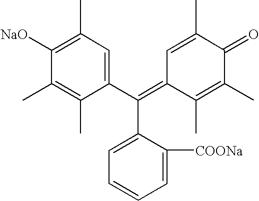

### EXAMPLE 22

### Synthesis of disodium salt of 3,3-bis-(4-hydroxy-3-sec-butylphenyl)-1-(3H)-isobenzofuranone

A mixture of 3,3-bis-(4-hydroxy-3-sec-butylphenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 82% yield. ¹H-NMR (DMSO-d₆): δ 0.80 (t, 6H, 2CH₃), 1.29-1.37 (p, 4H, 2CH₂), 1.20 (d, 6H, 2CH₃), 2.88-2.96 (sextate, 2H, 2CH), 6.08-6.75 (m, 6H, aromatic), 7.37-7.81 (m, 4H, aromatic) ppm.

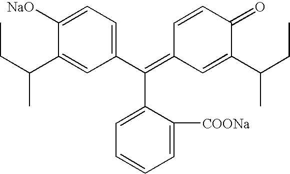

### EXAMPLE 23

### Synthesis of disodium salt of 3,3-bis-(4-hydroxy-3-nitrophenyl)-1-(3H)-isobenzofuranone

A mixture of 3,3-bis-(4-hydroxy-3-nitrophenyl)-1-(3H)-isobenzofuranone (0.01 mol) in ethanol (50 mL, 85%) was stirred followed by addition of sodium hydroxide (0.02 mol) in ethanol (50 mL, 85%). The reaction mixture was stirred and refluxed for 2 hours, cooled to room temperature. The solvent was evaporated on rotary evaporator, isolated the crude product and dried. Recrystallization from ethanol furnished pure disodium salt in 92% yield.

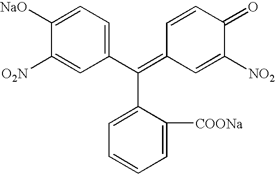

Synthesis of Phenol and Hydrazine Acid-Base Indicators

### EXAMPLE 1

### Synthesis of sodium salt of 5-methyl-2-nitrophenol

A mixture of 5-methyl-2-nitrophenol (0.1M) in ethanol (25 mL, 85%) was stirred followed by addition of sodium hydroxide (0.1M) in ethanol (25 mL, 85%). The reaction mixture was stirred at room temperature for 2 hours. The separated golden yellow solid was filtered, washed with ethanol and dried. Recrystallization from ethanol furnished pure sodium salt in 96% yield.

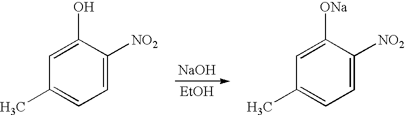

### EXAMPLE 2

### Synthesis of p-nitrobenzhydrazide

A mixture of ethyl p-nitrobenzoate (0.1M), hydrazine hydrate (0.11M) in ethanol (100 mL) was stirred at room temperature for 2 hours. The separated pale yellow solid was filtered, washed with ethanol and dried. Recrystallization from ethanol furnished pure hydrazide in 88% yield.

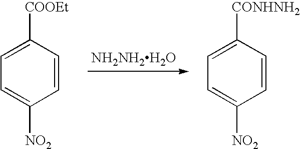

### EXAMPLE 3

### Synthesis of hydrazide

A mixture of ethyl salicylate (0.1M), 2,4-dinitrophenylhydrazine (0.1M) in ethanol (150 mL) was stirred at room temperature for 2 hours. The separated orange solid was filtered, washed with ethanol and dried. Recrystallization from ethanol furnished pure hydrazide in 94% yield.

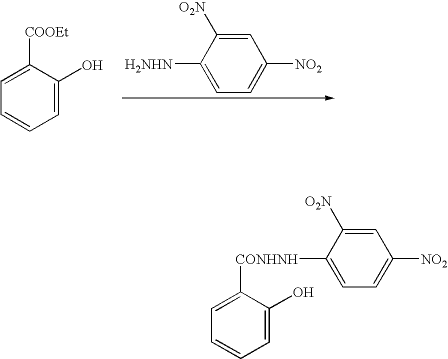

### EXAMPLE 4

### Synthesis of sodium salt of hydrazide

A mixture of hydrazide (0.1M) in ethanol (25 mL) was stirred followed by addition of sodium ethoxide (0.1M) in ethanol (25 mL). The reaction mixture was stirred and refluxed at for 4 hours, cooled to room temperature. The solvent was evaporated on rotary evaporator, isolated the crude yellow product and dried. Recrystallization from ethanol furnished pure sodium salt in 92% yield.

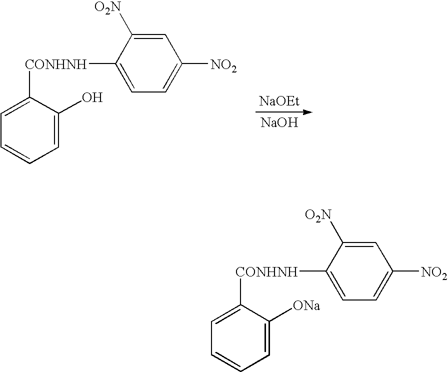

### EXAMPLE 5

### Synthesis of hydrazide

A mixture of ethyl salicylate (0.1M), 4-nitrophenylhydrazine (0.1M) in ethanol (150 mL) was stirred at room temperature for 2 hours. The separated yellow solid was filtered, washed with ethanol and dried. Recrystallization from ethanol furnished pure hydrazide in 89% yield.

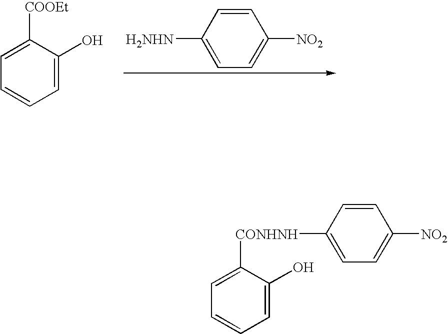

### EXAMPLE 6

### Synthesis of sodium salt of hydrazide

A mixture of hydrazide (0.1M) in ethanol (25 mL) was stirred followed by addition of sodium ethoxide (0.1M) in ethanol (25 mL). The reaction mixture was stirred and refluxed at for 4 hours, cooled to room temperature. The solvent was evaporated on rotary evaporator, isolated the crude yellow product and dried. Recrystallization from ethanol furnished pure sodium salt in 84% yield.

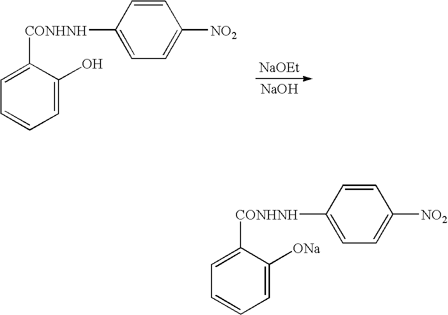

Although the present invention has been described with reference to preferred embodiments, persons skilled in the art will recognize that changes may be made in form and detail without departing from the spirit and scope of the invention.

Those skilled in the art will recognize, or be able to ascertain, using no more than routine experimentation, many equivalents to specific embodiments of the invention described specifically herein. Such equivalents are intended to be encompassed in the scope of the following claims.

We claim:

1. A biocide composition comprising:
a germicide;
a surfactant;
an acid-base indicator comprising: 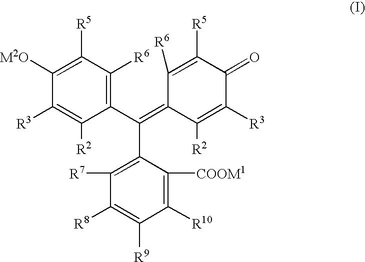
wherein
R² is selected from the group consisting of hydrogen, nitro, amino and alkyl;
R³ is selected from the group consisting of hydrogen, aryl, alkyl, nitro, acetamido and alkoxide;
R⁵ is selected from the group consisting of hydrogen, halo, alkoxide and alkyl;
R⁶ is selected from the group consisting of hydrogen and alkyl;
R⁷, R⁸, R⁹ and R¹⁰ are all hydrogen;
optionally, one of the carbons connected to R², R³, R⁵ or R⁶ can be substituted with a nitrogen atom; and
M¹ and M² are each independently a hydrogen atom, a metal ion or an ammonium ion, provided that at least one of M¹ or M² is a metal ion or an ammonium ion, and provided that R², R³, R⁵, R⁶, R⁷, R⁸, R⁹ and R¹⁰ are not all hydrogen atoms.

2. The biocide of claim 1, wherein R² is selected from the group consisting of hydrogen and methyl; R³ is selected from the group consisting of hydrogen, phenyl, isopropyl, methyl, ethyl, sec-butyl, nitro and methoxy; R⁵ is selected from the group consisting of hydrogen, bromo, methoxy, isopropyl and methyl; and R⁶ is selected from the group consisting of hydrogen and methyl.

3. The biocide of claim 1, wherein R² is hydrogen, R³ is Me, and R⁵, R⁶, R⁷, R⁸, R⁹ and R¹⁰ are hydrogen atoms, or R² is Me, R³is a hydrogen atom, R⁵ is an iso-propyl group, R⁶, R⁷, R⁸, R⁹ and R¹⁰ are hydrogen atoms or R² is H, R³is Me, R⁵is Br and R⁶, R⁷, R⁸, R⁹ and R¹⁰ are hydrogen atoms or R² is Me, R³ is Br, R⁵ is an isopropyl and R⁶, R⁷, R⁸, R⁹ and R¹⁰ are hydrogen atoms.

4. The biocide of claim 1, wherein R² is H, R³ is phenyl and R⁵, R⁶, R⁷, R⁸, R⁹ and R¹⁰ are all hydrogen atoms, or R² is H, R³ and R⁵ are isopropyl and R⁶, R⁷, R⁸, R⁹ and R¹⁰ are all hydrogen atoms, or R² is H, R³is methyl, R⁵ is H, R⁶ is methyl, R⁷, R⁸, R⁹ and R¹⁰ are all hydrogen atoms, or R² is H, R³ and R⁵ are methoxy and R⁶, R⁷, R⁸, R⁹ and R¹⁰ are all hydrogen atoms, or R² is H. R³and R⁵ are methyl and R⁶, R⁷, R⁸, R⁹ and R¹⁰ are all hydrogen atoms, or R² is H, R³ is ethyl and R⁵, R⁶, R⁷, R⁹, R¹⁰ and R² are all hydrogen atoms, or R2 is H, R³ is isopropyl and R⁵, R⁶, R⁷, R⁸, R⁹ and R¹⁰ are all hydrogen atoms, or R² is H, R³ is methoxide and R⁵, R⁶, R⁷, R⁸, R⁹ and R¹⁰ are all hydrogen atoms or R², R³ and R⁵ are all methyl and R⁶, R⁷, R⁸, R⁹ and R¹⁰ are all hydrogen atoms, or R², R³, R⁵, R⁶, R⁷, R⁸, R⁹ R¹⁰ are all hydrogen atoms and R³is sec-butyl, or R², R³, R⁵, R⁶, R⁷, R⁸, R⁹, R¹⁰ are all hydrogen atoms and R³ is nitro.

5. The biocide of claim 1, further comprising a base.

6. The biocide of claim 5, wherein the base is a metal hydroxide.

7. The biocide composition of claim I wherein said liquid germicide is a lower alkyl alcohol of 1 to 4 carbon atoms.

8. A disposable surface wipe article comprising:
a surfactant;
an aqueous solution;
an acid-base indicator comprising: 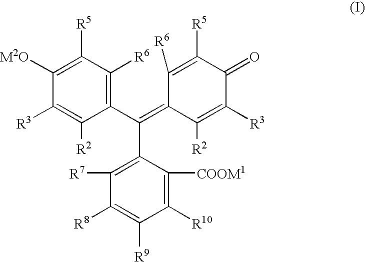
wherein
R² is selected from the group consisting of hydrogen, nitro, amino and alkyl;
R³ is selected from the group consisting of hydrogen, aryl, alkyl, nitro, acetamido and alkoxide;
R⁵ is selected from the group consisting of hydrogen, halo, alkoxide and alkyl;
R⁶ is selected from the group consisting of hydrogen and alkyl;
R⁷, R⁸, R⁹ and R¹⁰ are all hydrogen;
optionally, one of the carbons connected to R², R³, R⁵ or R⁶ can be substituted with a nitrogen atom;
M¹ and M² are each independently a hydrogen atom, a metal ion or an ammonium ion, provided that R², R³, R⁵, R⁶, R⁷, R⁸, R⁹ and R¹⁰ are not all hydrogen atoms; and
a disposable substrate carrier.

9. The disposable surface wipe article of claim 8, wherein wherein R² is selected from the group consisting of hydrogen and methyl; R³is selected from the group consisting of hydrogen, phenyl, isopropyl, methyl, ethyl, sec-butyl, nitro and methoxy; R⁵is selected from the group consisting of hydrogen, bromo, methoxy, isopropyl and methyl; and R⁶ is selected from the group consisting of hydrogen and methyl.

10. The disposable surface wipe article of claim 8, wherein R² is hydrogen, R³is Me, and R⁵, R⁶, R⁷, R⁸, R⁹ and R¹⁰ are hydrogen atoms, or R² is Me, R³is a hydrogen atom, R⁵ is an iso-propyl group, R⁶, R⁷, R⁸, R⁹ and R¹⁰ are hydrogen atoms or R² is H, R³is Me, R⁵ is Br and R⁶, R⁷, R⁸, R⁹ and R¹⁰ are hydrogen atoms or R² is Me, R³is Br, R⁵ is an isopropyl and R⁶, R⁷, R⁸, R⁹ and R¹⁰ are hydrogen atoms.

11. The disposable surface wipe article of claim 8, wherein R² is H, R³ is phenyl and R⁵, R⁶, R⁷, R⁸, R⁹ and R¹⁰ are all hydrogen atoms, or R² is H, R³ and R⁵ are isopropyl and R⁶, R⁷, R⁸, R⁹ and R¹⁰ are all hydrogen atoms, or R² is H, R³ is methyl, R⁵is H, R⁶is methyl, R⁷, R⁸, R⁹ and R¹⁰ are all hydrogen atoms, or R² is H, R³ and R⁵ are methoxy and R⁶, R⁷, R⁸, R⁹ and R¹⁰ are all hydrogen atoms, or R²is H, R³ and R⁵ are methyl and R⁶, R⁷, R⁸, R⁹ and R¹⁰ are all hydrogen atoms, or R² is H, R³ is ethyl and R⁵, R⁶, R⁷, R⁸, R⁹ and R¹⁰ are all hydrogen atoms, or R² is H, R³ is isopropyl and R⁵, R⁶, R⁷, R⁸, R⁹ and R¹⁰ are all hydrogen atoms, or R² is H, R³ is methoxide and R⁵, R⁶, R⁷, R⁸, R⁹ and R¹⁰ are all hydrogen atoms or R², R³ and R⁵ are all methyl and R⁶, R⁷, R⁸, R⁹ and R¹⁰ are all hydrogen atoms, or R², R³, R⁵, R⁶, R⁷, R⁸, R⁹, R¹⁰ are all hydrogen atoms and R³ is sec-butyl, or R², R³, R⁵, R⁶, R⁷, R⁸, R⁹, R¹⁰ are all hydrogen atoms and R³is nitro.

12. The disposable surface wipe article of claim 8, wherein M¹ and M² are both hydrogen.

13. The disposable surface wipe article of claim 8, wherein the disposable substrate carrier is a woven or nonwoven.

14. The disposable surface wipe article of claim 8, wherein the disposable substrate carrier is selected from the group consisting of a baby wipe, a hand wipe, a paper towel, a toilet tissue, and a facial tissue.

15. The disposable surface wipe article of claim 14, wherein the carrier is wet or dry.

16. An absorbent article comprising:
an outer cover having an interior surface and an opposite exterior surface;
an absorbent assembly disposed on the interior surface; and
an acid-base indicator embedded into or on the absorbent assembly, wherein the acid-base indicator comprises: 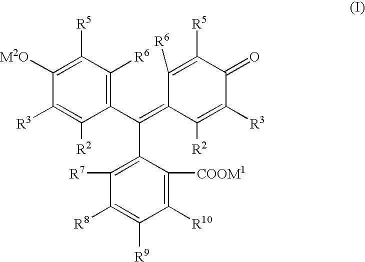
wherein
R² is selected from the group consisting of hydrogen, nitro, amino and alkyl;
R³ is selected from the group consisting of hydrogen, aryl, alkyl, nitro, acetamido and alkoxide;
R⁵ is selected from the group consisting of hydrogen, halo, alkoxide and alkyl;
R⁶ is selected from the group consisting of hydrogen and alkyl;
R⁷, R⁸, R⁹ and R¹⁰ are all hydrogen;
optionally, one of the carbons connected to R², R³, R⁵ or R⁶ can be substituted with a nitrogen atom;
M¹ and M² are each independently a hydrogen atom, a metal ion or an ammonium ion, provided that R², R³, R⁵, R⁶, R⁷, R⁸, R⁹ and R¹⁰ are not all hydrogen atoms; and
a disposable substrate carrier.

17. The absorbent article of claim 16, wherein wherein R² is selected from the group consisting of hydrogen and methyl; R³ is selected from the group consisting of hydrogen, phenyl, isopropyl, methyl, ethyl, sec-butyl, nitro and methoxy; R⁵ is selected from the group consisting of hydrogen, bromo, methoxy, isopropyl and methyl; and R⁶ is selected from the group consisting of hydrogen and methyl.

10. The disposable surface wipe article of claim 8, wherein R² is hydrogen, R³is Me, and R⁵, R⁶, R⁷, R⁸, R⁹ and R¹⁰ are hydrogen atoms, or R² is Me, R is a hydrogen atom, R⁵ is an iso-propyl group, R⁶, R⁷, R⁸, R⁹ and R¹⁰ are hydrogen atoms or R² is H, R³ is Me, R⁵ is Br and R⁶, R⁷, R⁸, R⁹ and R¹⁰ are hydrogen atoms or R² is Me, R³ is Br, R⁵ is an isopropyl and R⁶, R⁷, R⁸, R⁹ and R¹⁰ are hydrogen atoms.

18. The absorbent article of claim 16, wherein R²is H, R³is phenyl and R⁵, R⁶, R⁷, R⁸, R⁹ and R¹⁰ are all hydrogen atoms, or R² is H, R³and R⁵ are isopropyl and R⁶, R⁷, R⁸, R⁹ and R¹⁰ are all hydrogen atoms, or R² is H, R³is methyl, R⁵ is H, R⁶is methyl, R⁷, R⁸, R⁹ and R¹⁰ are all hydrogen atoms, or R² is H, R³ and R⁵ are methoxy and R⁶, R⁷, R⁸, R⁹ and R¹⁰ are all hydrogen atoms, or R² is H, R³ and R⁵ are methyl and R⁶, R⁷, R⁸, R⁹ and R¹⁰ are all hydrogen atoms, or R² is H, R³ is ethyl and R⁵, R⁶, R⁷, R⁸, R⁹ and R¹⁰ are all hydrogen atoms, or R² is H, R³is isopropyl and R⁵, R⁶, R⁷, R⁸, R⁹ and R¹⁰ are all hydrogen atoms, or R² is H, R³ is methoxide and R⁵, R⁶, R⁷, R⁸, R⁹ and R¹⁰ are all hydrogen atoms or R², R³ and R⁵ are all methyl and R⁶, R⁷, R⁸, R⁹ and R¹⁰ are all hydrogen atoms, or R², R³, R⁵, R⁶, R⁷, R⁸, R⁹, R¹⁰ are all hydrogen atoms and R³ is sec-butyl, or R², R³, R⁵, R⁶, R⁷, R⁸, R⁹, R¹⁰ are all hydrogen atoms and R³ is nitro.

19. The absorbent article of claim 16, wherein M¹ and M² are both hydrogen.

20. The absorbent article of claim 16, further comprising a protective layer surrounding the outer cover.

21. A lotion, comprising:
a thickener,
an emulsifier,
an emollient,
a surfactant,
optionally, a preservative,
a film former;
optionally, a sunscreen agent; and
an acid-base indicator comprising: 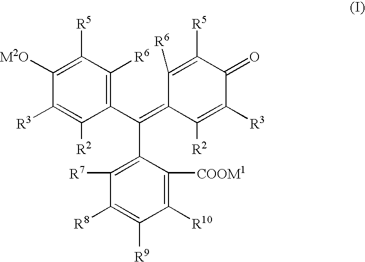
wherein
R² is selected from the group consisting of hydrogen, nitro, amino and alkyl;
R³ is selected from the group consisting of hydrogen, aryl, alkyl, nitro, acetamido and alkoxide;
R⁵ is selected from the group consisting of hydrogen, halo, alkoxide and alkyl;
R⁶ is selected from the group consisting of hydrogen and alkyl;
R⁷, R⁸, R⁹ and R¹⁰ are all hydrogen;
optionally, one of the carbons connected to R², R³, R⁵ or R⁶ can be substituted with a nitrogen atom; and
M¹ and M² are each independently a hydrogen atom, a metal ion or an ammonium ion, provided that at least one of M¹ or M² is a metal ion or an ammonium ion, and provided that R², R³, R⁵, R⁶, R⁷, R⁸, R⁹ and R¹⁰ are not all hydrogen atoms.

22. The lotion of claim 21, wherein R² is selected from the group consisting of hydrogen and methyl; R³ is selected from the group consisting of hydrogen, phenyl, isopropyl, methyl, ethyl, sec-butyl, nitro and methoxy; R⁵ is selected from the group consisting of hydrogen, bromo, methoxy, isopropyl and methyl; and R⁶ is selected from the group consisting of hydrogen and methyl.

23. The lotion of claim 21, wherein R² is hydrogen, R³ is Me, and R⁵, R⁶, R⁷, R⁸, R⁹ and R¹⁰ are hydrogen atoms, or R² is Me, R³ is a hydrogen atom, R⁵ is an iso-propyl group, R⁶, R⁷, R⁸, R⁹ and R¹⁰ are hydrogen atoms or R² is H, R³ is Me, R⁵ is Br and R⁶, R⁷, R⁸, R⁹ and R¹⁰ are hydrogen atoms or R² is Me, R³ is Br, R⁵is an isopropyl and R⁶, R⁷, R⁸, R⁹ and R¹⁰ are hydrogen atoms.

24. The lotion of claim 21, wherein R² is H, R³ is phenyl and R⁵, R⁶, R⁷, R⁸, R⁹ and R¹⁰ are all hydrogen atoms, or R² is H, R³ and R⁵ are isopropyl and R⁶, R⁷, R⁸, R⁹ and R¹⁰ are all hydrogen atoms, or R² is H, R³ is methyl, R⁵ is H, R⁶ is methyl, R⁷, R⁸, R⁹ and R¹⁰ are all hydrogen atoms, or R² is H, R³ and R⁵ are methoxy and R⁶, R⁷, R⁸, R⁹ and R¹⁰ are all hydrogen atoms, or R² is H, R³ and R⁵ are methyl and R⁶, R⁷, R⁸, R⁹ and R¹⁰ are all hydrogen atoms, or R² is H, R³ is ethyl and R⁵, R⁶, R⁷, R⁸, R⁹ and R¹⁰ are all hydrogen atoms, or R² is H, R³ is isopropyl and R⁵, R⁶, R⁷, R⁸, R⁹ and R¹⁰ are all hydrogen atoms, or R² is H, R³is methoxide and R⁵, R⁶, R⁷, R⁸, R⁹ and R¹⁰ are all hydrogen atoms, or R², R³ and R⁵ are all methyl and R⁶, R⁷, R⁸, R⁹ and R¹⁰ are all hydrogen atoms, or R², R³, R⁵, R⁶, R⁷, R⁸, R⁹, R¹⁰ are all hydrogen atoms and R³ is sec-butyl, or R², R³, R⁵, R⁶, R⁷, R⁸, R⁹, R¹⁰ are all hydrogen atoms and R³ is nitro.

25. The lotion of claim 21, further comprising abase.

26. The lotion of claim 25, wherein the base is a metal hydroxide.
